(19) United States
(12) Patent Application Publication
(10) Pub. No.: US 2025/0261660 A1
(43) Pub. Date: Aug. 21, 2025

(54) FORMULATIONS AND METHODS FOR USE IN OXIDATION TREATMENT APPLICATIONS

(71) Applicant: Clean Chemistry, Inc., Longmont, CO (US)

(72) Inventors: Wayne E. BUSCHMANN, Boulder, CO (US); Carl R. EVENSON, Erie, CO (US)

(21) Appl. No.: 19/200,902

(22) Filed: May 7, 2025

Related U.S. Application Data
(63) Continuation of application No. PCT/US2023/080217, filed on Nov. 17, 2023.
(60) Provisional application No. 63/468,729, filed on May 24, 2023.
(60) Provisional application No. 63/467,272, filed on May 17, 2023.
(60) Provisional application No. 63/467,270, filed on May 17, 2023.

(30) Foreign Application Priority Data
Nov. 17, 2022 (WO) PCT/US2022/050317

(51) Int. Cl. A23B 7/154; A01N 37/02; A01N 59/00; A01P 1/00; A23B 4/20; A23B 4/24; A23B 7/157; A23L 5/00

(52) U.S. Cl. CPC A23B 7/154; A01N 37/02; A01N 59/00; A01P 1/00; A23B 4/20; A23B 4/24; A23B 7/157; A23L 5/57

(57) ABSTRACT

A method for oxidation of substrates uses peracid salt compositions prepared from acyl donor, hydrogen peroxide and alkali metal hydroxide under controlled conditions to provide nonequilibrium compositions at high product yield from input feedstocks, and which are surprisingly stable prior to use. Substrates to be oxidized are contacted with a nonequilibrium treatment composition comprising such a nonequilibrium composition or a nonequilibrium adjusted composition prepared by adding one or more additives to the nonequilibrium composition prior to contacting the substrate.

### REFERENCE TO RELATED APPLICATIONS

This application is a continuation of international patent application no. PCT/US2023/080217, filed Nov. 17, 2023, which published as international publication no. WO 2024/018086 A1, and which claims a benefit of each of U.S. provisional patent application No. 63/468,729, filed May 24, 2023, U.S. provisional patent application No. 63/467,272, filed May 17, 2023, and U.S. provisional patent application No. 63/467,270, filed May 17, 2023, the entire contents of each and all of which are incorporated by reference herein for all purposes. This application claims priority pursuant to 35 U.S.C. §§ 119(a) and 365(b) to international patent application no. PCT/US2022/050317, filed Nov. 17, 2022, which published as international publication no. WO 2023/091610 A1 and which entered the PCT national phase in the U.S. as U.S. patent application Ser. No. 18/709,869, the entire contents of each and all of which are incorporated by reference herein for all purposes.

This application incorporates by reference, for all purposes, each and every portion of U.S. provisional patent application No. 63/280,479, filed Nov. 17, 2021.

### FIELD OF THE INVENTION

This invention relates to formulation improvements and methods of generating peracid salt-ROS formulations, including peracetate-ROS formulations. This invention relates to various processing, including to pulp fiber processing using improved peracid salt-ROS formulations, including peracetate-ROS formulations. The methods include delignifying, bleaching, brightening, and fluffing of pulp fibers involving the use of peracetate oxidant solutions. This invention relates to various processing, including food processing using improved peracid salt-ROS formulations, including peracetate-ROS formulations. The methods include cleaning and sanitization during food processing involving the use of peracetate oxidant solutions.

### BACKGROUND OF THE INVENTION

The use of reactive oxygen species (ROS) for oxidation, bleaching and microbial control applications are commercially useful as effective, safer and more environmentally friendly alternatives to halogen-based oxidants.

Reactive oxygen species (ROS) refers to multiple forms or energy states of oxygen with greater activity or reactivity than molecular oxygen, O₂, present in air. Several ROS are found naturally occurring in the environment, play critical roles in biological systems, and have been harnessed for commercial uses. Common examples of ROS include hydroxyl radical (HO^{•}), hydroperoxyl radical (HOO^{•}), superoxide radical anion (O₂^{•-}), singlet oxygen (¹O₂), and ozone (O₃). In general, ROS in water are short-lived and, for commercial uses, are generated at the point of use or in-situ.

Each ROS has a different oxidation potential and reactivity profile making them useful in different situations. The most powerful, but shortest-lived, ROS in water treatment conditions is the hydroxyl radical, which is useful for breaking down most chemical contaminants as non-selective oxidizer and is readily produced by in-situ chemical catalysis or photolysis methods. However, the hydroxyl radical reacts very rapidly with salts, carbonate, peroxide and itself which greatly reduces its efficiency, especially in saline water. At the other end of the oxidative strength spectrum is superoxide, which can selectively oxidize or reduce specific materials and is an important intermediate in catalytic cycles (e.g., Fenton) and cellular chemistry. Singlet oxygen is of interest for its selective oxidative reactivity and biocidal properties compared to other ROS, especially in the presence of salts, water treatment chemicals, cellulose and textiles. Oxygen in the earth's troposphere normally exists in its electronic “ground state,” technically referred to as triplet molecular oxygen, having two unpaired electrons (di-radical) in orthogonal, non-bonding orbitals and is commonly abbreviated as ³O₂. When the unpaired electrons are paired up in a higher energy, excited state known as singlet molecular oxygen, ¹O₂, it exhibits unique chemical reactivity compared to the ground state. Singlet oxygen has a brief lifetime of a few microseconds in water before it returns to the ground state.

Singlet oxygen has often been examined for its use in selective oxidation reactions, microbial control, and triggering tumor cell death by using dye-sensitized photooxidation methods to generate singlet oxygen in gas or liquid phases. However, practical methods of producing singlet oxygen for large scale applications without the need for color dyes and illumination in a process has limited its use to small-scale specialty applications such as photodynamic therapy.

A variety of chemical generation methods have been examined to produce singlet oxygen in the absence of illumination. These methods generally involve the combination of oxygen atoms associated with a “parent” molecular structure, which are released as molecular oxygen in the singlet electronic state as a byproduct of specific thermochemical reactions or transformations of the “parent” molecular structure. For example, the rapid reaction between hydrogen peroxide and sodium hypochlorite is a commonly known chemical approach to produce singlet oxygen in moderate yield at the expense of the ingredients. However, the reaction is too fast and too brief for practical use formulated as a liquid concentrate. This approach also introduces free chlorine into a process, which rapidly produces toxic chlorinated byproducts and elevates corrosivity. In fact, hydrogen peroxide is used commercially as an industrial chlorine quenching agent.

A controlled reaction of peroxides in liquid formulations is a preferred approach to produce singlet oxygen in high yield and on a time scale that allows it to be applied in a variety of use environments. This approach is now known to provide safety and environmental benefits over other approaches including the above examples while being practical for a wide variety of uses and use environments. Developing better methods of producing peroxide formulations and their reactive oxygen generating properties are essential to controlling chemical activity, technical performance, and working time in which to apply the chemistry. To be industrially useful the production of such a formulation must be done efficiently and cost-effectively on a large scale.

Methods to produce activated peracetate-ROS formulations on-demand that are suitable for generating ROS, especially singlet oxygen, were recently disclosed. These activated formulations provide enhanced oxidative power and microbial control performance relative to stabilized peracetic acid formulations containing significant concentrations of hydrogen peroxide, acetic acid, and peroxide stabilizers. The activated peracetate-ROS formulations are moderately alkaline, low odor and reduce chemical vapor exposure hazards in the workplace.

Previously disclosed peracetate-ROS formulations, such as those disclosed for example in WO 2014/039929 A1 or US 2016/0068417 A1, were produced by reaction of an alkaline hydrogen peroxide source with an acetyl donor material in a process that used a large molar excess of acetyl donor groups relative to hydrogen peroxide to ensure virtually all of the hydrogen peroxide was consumed rapidly such that the concentration of residual hydrogen peroxide would be at a low level, such as less than 3% the mass of the peracetic acid/peracetate concentration, and to minimize competing side-reactions that decrease the yield and concentration of peracetate in the product solution. The use of peroxide stabilizers must also be excluded to avoid blocking reactions that produce ROS.

The generating of peracetate-ROS formulations rapidly with little to no hydrogen peroxide residual are required conditions for efficient singlet oxygen production without the quenching of singlet oxygen activity by hydrogen peroxide and preventing side-reactions that reduced peracetate production efficiency and product concentration.

To achieve these conditions previously, a substantial excess of acetyl donor groups was used to accelerate a reaction at alkaline pH which consumed hydrogen peroxide and formed peracetate at a rate that minimized the extent that derogatory side reactions could occur. Formulations made by this method have been demonstrated to be commercially useful as practical, safer, less corrosive and less toxic alternatives to a variety of commercial products with examples including chlorine, hypohalites, chlorine dioxide and peracetic acid.

A specific challenge of the previous approach was the scale up of a production process that could operate efficiently with respect to feedstock utilization to make the preferred peracetate-ROS product composition. In previous work it was found that as the molar excess of acetyl donor groups were reduced relative to hydrogen peroxide, the desired reaction to produce peracetate would slow down relative to the rate of side reactions that reduce production efficiency, product concentration, and working time of peracetate-ROS formulations. At the same time, an increase in acetyl donor material in a production process or in the peracetate product generated in a production process can lead to other potential side reactions that result in reduced production efficiency, concentration, and working time of peracetate-ROS formulations.

In prior work, optimizing production process controls and production system design (i.e., engineering methods) could improve the accuracy of the process to generate a more consistent product. However, these engineering methods of optimization could not overcome inherent limitations of the chemistry during production of peracetate-ROS formulations at larger scales suitable for larger commercial uses.

It is desirable to develop improved peracetate-ROS formulations and methods of generating these formulations at a large scale.

One particular area of need is in pulp and paper processing. In the context of pulp and paper processing, a variety of methods have been developed for chemical treatment of wood and non-wood pulp fibers to achieve brighter unbleached grades and bleachable grades. Delignification is the removal of lignin which is the structural polymer found in plant tissue. Removal of lignin is conducted primarily during the pulping process and continued in the bleaching process for bleached grades of pulp. Common chemical delignification methods include alkaline caustic soda cooking, reductive methods (e.g., sulfite cooking, or alkaline sulfide digestion in the kraft pulping process), oxidative methods (e.g., oxygen delignification, alkaline hydrogen peroxide extraction and combinations), and enzymatic methods (e.g., xylanase).

Bleaching of pulp (wood and non-wood fibers) is commonly done by elemental chlorine free (ECF) processes and totally chlorine free (TCF) processes. The ECF processes are currently more economic and common than TCF in large pulp and paper mills for reaching white fiber grades of greater than about 80% ISO brightness. ECF bleaching commonly involves one or more chlorine dioxide stages with washing and extraction stages after a treatment with chlorine dioxide. TCF processes may incorporate extended delignification cooking or digestion stages and oxygen delignification during the pulping process and alternative bleaching chemicals in the bleaching process including multiple alkaline hydrogen peroxide stages, oxygen, oxygen with hydrogen peroxide, ozone and peracetic acid to achieve brighter fiber grades.

These traditional pulp and paper processes use large amounts of fresh water as a substrate for materials and chemicals used in the processing, resulting in the generation of large amounts of effluent. The industry continues to work to reduce water consumption by utilizing closed water circuits but that is limited by accumulation of contaminants and pollutants in the process water. Within the effluent significant pollutants are found having high concentrations of total suspended solids (TSS), total organic carbon (TOC), chemical oxygen demand (COD), biological oxygen demand (BOD), absorbable organic halogens (AOX), volatile organic compounds (VOC). During processing with chlorine-based oxidants polychlorinated phenols are one of the major absorbable organic halogens (AOX) that may be discharged in pulp bleaching effluents. Dioxins, furans and other halogenated organic materials are also formed during chlorine and chlorine dioxide bleaching and are included in the AOX category. AOX formation is highly dependent on the lignin content (proportional to kappa number) of the pulp prior to bleaching. The more reduction in kappa number prior to bleaching the less AOX formation potential.

Reductions in amounts of TOC, BOD and COD is also important for process improvements. TOC is the amount carbon atoms tied up in organic compounds in a water sample, and a non-specific indicator of water quality. BOD an analytical parameter representing the amount of dissolved oxygen consumed by aerobic bacteria growing on the organic material present in a water sample at a specific temperature over a specific time period. The BOD value is most commonly expressed in milligrams of oxygen consumed per liter of sample during 5 days of incubation at 20° C. and is often used as a surrogate of the degree of organic water pollution. COD is a measurement of the oxygen required to oxidize soluble and particulate organic matter in water. Reduction of pollutants and decreasing water usage continues to be a challenge in this processing.

Singlet oxygen is well suited for oxidation of phenols, chlorinated phenols and similar electron-rich phenolic materials including lignin. Lignin generally consists of crosslinked polyphenolic materials created by enzyme-mediated polymerization of coniferyl, sinapyl and p-coumaryl alcohols. Singlet oxygen (which is not a radical) is relatively selective towards phenol oxidation and has little direct impact on cellulose fibers. In contrast, ozone and radicals including elemental chlorine, chlorine dioxide, hydroxyl radical, hydroperoxyl radical, superoxide and even triplet oxygen are more reactive towards cellulose in conventional delignification and bleaching processes.

The selectivity of singlet oxygen towards the oxidation and break down of lignin and non-cellulose materials avoids non-selective reactions that break down cellulose by radical-based or radical-forming oxidants including gaseous chlorine, chlorine dioxide and ozone. Reactive oxygen radical species such as superoxide and hydroperoxyl radicals are known to form during high pH and high temperature hydrogen peroxide treatment and also during higher pressure and temperature oxygen delignification processes. These reactive oxygen radical species can cause significant damage to cellulose fibers. It is generally known in the art that cellulose fibers are susceptible to damage by radical species, which reduces fiber yield and fiber strength. The addition of alkali to oxygen delignification and hydrogen peroxide extraction is common practice to increase the oxidation and extraction rates of lignin from cellulose fiber. However, excessive alkali concentrations or exposure times will also cause damage to cellulose fiber. The rate of delignification also impacts the preservation of pulp fiber yield, strength and quality. Shorter exposure time of fiber to oxidizing and alkaline conditions may reduce the amount of non-selective breakdown of cellulose fiber. A ROS-generating peracetate formulation has the ability to reduce kappa number (lignin content) significantly.

Using a peracetate-ROS formulation is significantly safer than chlorine and chlorine dioxide. Water used in chlorine and chlorine dioxide bleaching stages is not compatible with recovery boilers and other process equipment outside of the bleaching circuit due to the highly corrosive chloride and chlorate content. Chlorides accumulate in closed loop processes in a pulp mill used upstream of the bleaching circuit causing corrosion damage to conventional process equipment. Therefore, the water from bleaching stages, must be segregated, treated and disposed of as waste water. The peracetate oxidant formulation contains no chloride content and its total organic carbon content can be combusted in the recovery boilers. Each chlorine or chlorine dioxide bleaching stage that is replaced or reduced by using the peracetate oxidant formulation upstream of the bleaching circuit represents a reduction in the waste water stream, reduction in AOX and pollutants as well as reduced financial and environmental costs of treatment and disposal or discharge.

Peracetate oxidant solutions are composed of sodium peracetate salt, which is a water soluble solid in its native form. Salts in general have significantly lower vapor pressures than liquids and gases at room temperature. Historically, a small fraction of the sodium peracetate can be present as peracetic acid, however, peracetic acid is consumed by reactions with sodium peracetate and does not reach significant concentrations in solution. Exposure to sodium peracetate solution is limited to inhalation of an aerosol or mist and exposure to liquid concentrates.

Improvements to methods to produce and use improved peracetate-ROS formulations on-demand that are suitable for generating ROS, especially singlet oxygen, for use in pulp fiber processing are disclosed. These improved formulations provide enhanced oxidative power and microbial control performance relative to stabilized peracetic acid formulations. These peracetate-ROS formulations are moderately alkaline, have low pollutant potential, have low odor and reduce chemical vapor exposure hazards in the workplace. The improved formulation can be further acidified to improve performance in pulp and paper processing when required.

The use of these formulations for oxidation, bleaching and microbial control applications are commercially useful as effective, safer and more environmentally friendly alternatives to halogen-based oxidants in pulp and paper processing.

Another area of particular need is in food processing. Food processing is the conversion of raw agricultural or synthesized products into food, and for any particular product consumable as a food may include few or several stages of processing. Primary food processing is a term sometimes used to refer to processing that turns raw agricultural products into food which can be eaten. Secondary food processing is a term sometimes used to refer to processing that creates food from ingredients that are ready to use, for example baking bread. Tertiary processing is a term sometimes used to refer to processing to create what is commonly referred to as “processed” food, for example potato chips or frozen meals. Cleaning and sanitizing are critical aspects of food processing, for safety and to prevent or reduce spoiling of food. Detailed procedures, cleaning frequencies and type of cleaning must be developed for all food-product contact surfaces as well as for non-product surfaces which could impact food safety. These surfaces include food surfaces, food contact surfaces and non food contact surfaces such as equipment which can include for example overhead structures, shields, walls, ceilings, lighting devices, refrigeration units and heating, ventilation and air conditioning (HVAC) systems.

Cleaning frequency and type must be clearly defined for each process line (i.e., daily, after production runs, or more often if necessary). The objective of cleaning and sanitizing food contact surfaces is to remove food (nutrients) that bacteria need to grow, and to kill those bacteria that are present. It is important that clean, sanitized equipment and surfaces dry and are stored so as to prevent bacteria growth. All necessary contact equipment used in food processing must also be cleaned and stored in a sanitary manner. The general order for cleaning and sanitization of food product contact surfaces are: rinse, clean, rinse, sanitize and sometimes a final rinse.

Cleaning is the complete removal of food soil using detergents under recommended conditions and procedures. Food soil is defined as any unwanted matter on food contact surfaces, including food product, minerals and films. No single detergent is effective in removing all types of food soil. Types of cleaning methods include: mechanical cleaning often referred to as clean in place (CIP) which requires no disassembly or partial disassembly of equipment; clean out of place (COP) can be partially disassembled and cleaned in specialized COP pressure tanks, and manual cleaning requires total disassembly for cleaning and inspection.

Detergents and cleaning compounds are composed of mixtures of ingredients that interact with soils in a variety of ways, either physically or chemically. The primary physically-active ingredients in food processing are surface active compounds termed surfactants. Surfactants alter physical characteristics such as solubility or colloidal stability. These organic molecules have general structural characteristic where a portion of the structure is hydrophilic and a portion is hydrophobic. Such molecules function in detergents by promoting the physical cleaning actions through emulsification, penetration, spreading, foaming, and wetting. The classes of surfactants are ionic and nonionic.

Chemically active ingredients in cleaning and sanitization include alkaline detergents, acid detergents, water conditioners and oxidizing agents. These compounds modify soil components to make then more soluble and easier to remove. Enzyme-based detergents are amended with enzymes such as amylases and other carbohydrate-degrading enzymes, proteases, and lipases, are added to react with and degrade food soil surfaces.

Sanitization refers to the reduction of microorganisms to levels considered safe to prevent foodborne illness. Appropriate and approved sanitization procedures are processes, and, thus, the duration or time as well as the chemical conditions must be described. The official definition (Association of Official Analytical Chemists) of sanitizing for food product contact surfaces is a process which reduces the contamination level by 99.999% (5 logs) in 30 sec. The standard test organisms used are Staphylococcus aureus and Escherichia coli. General types of sanitization include thermal and chemical sanitization. Thermal sanitization involves the use of hot water or steam for a specified temperature and contact time. Thermal sanitization effectiveness is determined by contamination load, humidity, pH, temperature and time. Steam had limited use due to expense and challenges in regulating and monitoring contact temperature and time. Hot water sanitization through immersion, spray or circulating systems is more commonly used, however, it is a slow process and has higher energy demand and safety concerns for operators. Chemical sanitization involves the use of an approved chemical sanitizer at a specified concentration and contact time. Chemical sanitization is widely accepted, and common sanitizers include chlorine bleach, chloride dioxide, bromine, iodine and quaternary ammonium compounds, acids, alkaline cleaners, hydrogen peroxide and peroxyacetic acid. Many of the commonly used sanitizers have disadvantages due to pH, corrosivity, flammability, skin irritation, aquatic toxicity and odor. Chemical sanitizers are approved by the EPA for use as no-rinse, rinse optional or rinse required food contact surface sanitizers and can be sprayed onto surfaces, circulated through equipment or foamed onto a surface or fogged into the air. A major drawback to chlorine and bromine compounds is corrosiveness to many metal and non-metal surfaces, occupational health concerns such as skin irritation and mucous membrane damage, and health and environmental toxicity concerns from halogenated disinfection byproducts (DPBs).

Food processing uses large amounts of fresh water as a substrate for materials and chemicals used in the processing, resulting in the generation of large amounts of effluent. Water comprises approximately 95-99% of cleaning and sanitizing solutions. The industry continues to work to reduce water consumption by utilizing closed water circuits but that is limited by accumulation of contaminants, disinfection byproducts, cleaning and sanitizing residuals and pollutants in the process water. The water carries detergent and or sanitizer to the substrate as well as carries food and contaminants away from the substrate. Water impurities and hardness usually have the greatest effect on cleaning and sanitization, as water used for cleaning and sanitization must be potable and pathogen free.

Detergents can be significant contributors to the waste discharge (effluent). Of primary concern is pH. Many publicly owned treatment works limit effluent pH to the range of 5 to 9.0. So, it is recommended that in applications where highly alkaline cleaners are used, that the effluent be mixed with rinse water (or some other method be used) to reduce the pH. Recycling of caustic soda cleaners is also becoming a common practice in larger operations. Other concerns are phosphates, which are not tolerated in some regions of the U.S., and the overall soil load in the waste stream that contributes to the chemical oxygen demand (COD) and biological oxygen demand (BOD).

Reductions in amounts of TOC, BOD and COD is also important for process improvements. TOC is the amount carbon atoms tied up in organic compounds in a water sample, and a non-specific indicator of water quality. BOD an analytical parameter representing the amount of dissolved oxygen consumed by aerobic bacteria growing on the organic material present in a water sample at a specific temperature over a specific time period. The BOD value is most commonly expressed in milligrams of oxygen consumed per liter of sample during 5 days of incubation at 20° C. and is often used as a surrogate of the degree of organic water pollution. Chemical Oxygen Demand or COD is a measurement of the oxygen required to oxidize soluble and particulate organic matter in water. Reduction of pollutants and decreasing water usage continues to be a challenge in this processing.

Singlet oxygen is well suited for oxidation of food soils. Singlet oxygen (which is not a radical) is relatively selective towards oxidation in contrast to ozone and radicals including elemental chlorine, hydroxyl radical, hydroperoxyl radical.

A peracetate-ROS formulation is significantly safer than chlorine and chlorine dioxide for use in food processing. Chlorides accumulate in closed loop processes causing corrosion damage to conventional process equipment. Halogenated disinfection byproducts including haloacetic acids, chlorophenols and chlorate also accumulate in closed loop processes without their treatment or removal. Therefore, the water must be segregated, treated and disposed of as waste water. The peracetate oxidant formulation contains no chloride or chlorine content and cannot directly form halogenated disinfection byproducts.

Peracetate oxidant solutions are composed of sodium peracetate salt, which is a water soluble solid in its native form. Salts in general have significantly lower vapor pressures than liquids and gases at room temperature.

Improved compositions and methods to produce activated peracetate-ROS formulations on-demand that are suitable for generating ROS, especially singlet oxygen, were recently disclosed. These activated formulations provide enhanced oxidative power and microbial control performance relative to stabilized peracetic acid formulations containing significant concentrations of hydrogen peroxide, acetic acid, and peroxide stabilizers. These peracetate-ROS formulations are moderately alkaline, have low pollutant potential, have low odor and reduce chemical vapor exposure hazards in the workplace.

The use of these formulations for cleaning and sanitization of food surfaces as well as microbial control applications are commercially useful as effective, safer and more environmentally friendly alternatives to current oxidants used in food processing.

### SUMMARY OF INVENTION

This invention concerns new peracid salt-ROS formulations, new methods of generating peracid salt-ROS formulations, and new uses of such peracid salt-ROS formulations with preferred formulations being peracetate-ROS formulations. The peracid salt-ROS formulations are nonequilibrium peracid salt compositions capable of generating ROS, and especially singlet oxygen, during use in oxidation treatments. With the present invention, it was discovered that changing the chemical feedstock ratios and initially formed product formulation to outside the ranges taught in prior art results in significant improvements to methods of generating peracetate-ROS formulations at larger production scales made by batch, semi-continuous or continuous process methods. Improvements over prior art generally include: higher production efficiency while using less acetyl donor material; more consistent product characteristics between production batches or cycles; increased working time to apply the chemistry; and lower byproduct residuals of the chemistry.

As will be appreciated, peracetic acid is one of several peracids, which are also referred to as peroxyacids. The discussions below and in the appended claims are presented primarily by reference to peracid salt-ROS formulations based on peracetic acid, which are referred to herein generally as peracetate-ROS formulations, but the principles discussed are thought to apply to peracid salt-ROS formulations based on other organic peracids, with replacement of peracetate with the corresponding salt form of an organic peracid other than peracetic acid. The peracid salt-ROS formulations, including peracetate-ROS formulations are preferably in the salt form with an alkali metal salt, preferably sodium and/or potassium, and more preferably sodium. Discussion in the description below and the appended claims to sodium apply also to formulations including potassium instead. Peracid salt-ROS formulations are also referred to as peracid-reactive oxygen species formulations and peracetate-ROS formulations are also referred to as peracetate-reactive oxygen species formulations.

This invention provides methods for producing peracetate-ROS formulations with a substantially reduced excess of acetyl donor material that more closely approaches a stoichiometric 1:1 ratio of hydrogen peroxide to acetyl donor groups relative to prior art preparation methods while maintaining or increasing the production efficiency of an active peracetate-ROS formulation. This invention provides peracetate-ROS formulations having advantageous properties, and which may be prepared by the noted method.

This invention reduces material consumption and associated costs for producing peracetate-ROS formulations compared to previous methods.

This invention provides methods to produce peracetate-ROS formulations with enhanced compositional and performance characteristics with greater consistency of prepared formulations than previous methods in batch, semi-continuous and continuous production processes for large scale commercial uses.

This invention provides an improved peracetate-ROS formulation that increases working time at an elevated concentration range prior to its use or dilution to a point of use concentration.

The improved formulation produced by the methods herein can be in the form of a liquid, an ice, a foam, a fog, an emulsion, a microemulsion or an aerosol. The invention also provides improved formulations for point of use applications which are appropriately formulated for application by injection, flooding, spraying, and/or circulation. The formulations of the invention can be used for applications in food, dairy, beverage, and biopharma; cleaning; decontamination; remediation of soil and groundwater; cleaning of membrane filtration systems; flushing of well casings and water distribution pipes; pulp and paper processing, delignifying, bleaching, brightening, fluffing of pulp fibers and in-situ chemical oxidation, among others.

This invention provides a peracetate-ROS formulation that contains less total organic carbon (TOC) from product residues compared to previous formulations. Further this formulation has less TOC compared to equilibrium peracetic acid products.

The improvements were enabled by the discovery of a previously unknown “threshold” for the amount of excess acetyl donor relative to hydrogen peroxide as the excess acetyl donor used to prepare the peracetate ROS formulation at a high pH is reduced closer to a stoichiometric molar ratio of acetyl donor groups to hydrogen peroxide, below which threshold there was an abrupt change in reaction behavior such that undesirable side reactions were significantly and unexpectedly reduced relative to the desired reaction to form peracetate at high efficiency and with the preferred composition optimized to generate singlet oxygen. It was discovered that changing the chemical feedstock ratios to outside the ranges taught in prior art resulted in an unexpected, disproportionate change and improvement to the peracetate-ROS formulations and efficiency of preparation performance.

In previous work concerning generation of peracetate-ROS formulations, two parameters were used to control generation of the formulations, specifically the ratio of alkali to hydrogen peroxide and the hydrogen peroxide to acetyl donor ratio. Previously these ratios were presented as the ratio of hydrogen peroxide to alkali in the range of 1:1.2 to 1:2.5, now presented as alkali to hydrogen peroxide having a range of 1.2:1 to 2.5:1 and the hydrogen peroxide to acetyl donor ranges presented formerly as from 1:1.25 to 1:4, currently presented as ranging from 0.80:1 to 0.25:1. In this reaction a significant molar excess of acetyl donor over alkaline hydrogen peroxide is required to provide efficient conversion of hydrogen peroxide, the limiting reagent, to peracetate before other side reactions that reduce production efficiency become significant (e.g., less than about 88% hydrogen peroxide to peracetate conversion yield). This reaction is driven by the excess of acetyl donor.

In contrast, in the present invention three parameters are identified as critical to approach stoichiometric hydrogen peroxide to acetyl donor molar ratios for generation of peracetate-ROS formulations with more efficient use of acetyl donor and less reaction byproducts which can be quantified as total organic carbon. The primary controlling parameters are the alkali to acetyl donor ratio and the hydrogen peroxide to acetyl donor ratio. The alkali to hydrogen peroxide ratio is dependent on, and a result of, the first two controlling parameters. These controlling parameters were discovered to be of critical importance for the efficient production of singlet oxygen producing peracetate solutions approaching stoichiometric hydrogen peroxide to acetyl donor groups molar ratios (i.e., 0.80:1 to 1.0:1). This approach minimizes undesirable side reactions that reduce peracetate yield and short-term stability.

The importance of the alkali to acetyl donor molar ratio is not obvious due to its indirect relationship with product concentration, yield and stability when the acetyl donor is in significant stoichiometric excess over hydrogen peroxide and the peracetate product as disclosed in prior art. Scale up was not commercially feasible previously when using a large excess of acetyl donor material because a very large excess of sodium hydroxide over hydrogen peroxide leads to competing consumption of acetyl donor by sodium hydroxide, loss of product yield and pH outside of the previously specified range. However, the alkali to acetyl donor molar ratio discovered in the present invention provides systematic control of the yield and compositional parameters of the produced peracetate solutions when approaching stoichiometric equivalence to the peracetate product. The alkali to hydrogen peroxide ratio is dependent on, and a result of, the first two controlling parameters. The hierarchy of these parameters can be listed as 1) NaOH:acetyl donor groups molar ratio, 2) hydrogen peroxide:acetyl donor groups molar ratio and 3) NaOH:hydrogen peroxide molar ratio.

The present invention provides compositions and methods of producing a peracetate solution by a near-stoichiometric reaction between hydrogen peroxide and an acetyl donor capable of efficiently producing singlet oxygen, has improved short-term stability for improved working time, and can be used in the presence of acidulants and near-neutral pH buffered environments without significant loss to degradation reactions. A method of producing a peracetate solution using a molar ratio of alkali as sodium hydroxide to acetyl donor groups in a range of 1:1 to 1.3:1 combined with a molar ratio of hydrogen peroxide to acetyl donor groups in a range of 0.8:1 to 1:1 and where the preferred peracetate solution pH range is 12.5 to 13.5 when first made and where the peracetate concentration in solution is 1% to 8% and the residual hydrogen peroxide concentration is zero to 1400 mg/L.

One aspect of this disclosure is directed to aqueous, nonequilibrium peracetate compositions for generation of singlet oxygen for use in oxidative treatments. Such a nonequilibrium peracetate composition can comprise:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400 mg/L;
a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

Another aspect of this disclosure is directed to a method for preparing a nonequilibrium peracid salt composition in relatively stable form for short-term storage and handling prior to use to generate singlet oxygen during oxidative treatments. Such a method can comprise:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor groups in a range of from 0.95 to 1.40; and
   a second molar ratio of hydrogen peroxide to the acyl donor groups in a range of from 0.80 to 1.10; and
continuing the reacting at least until the nonequilibrium peracid salt composition is prepared including the composition properties.

Another aspect of this disclosure are directed to methods and uses of oxidative treatments of substrates. Such a method or use can comprise contacting the substrate with a nonequilibrium peracid salt composition, for example of the previously noted aspect. Such a method or use can comprise contacting the substrate with a nonequilibrium adjusted composition prepared by adding one or more additives to the nonequilibrium peracid salt composition. One or more such additives can be added to the nonequilibrium peracid salt composition after preparation of the nonequilibrium peracid salt composition by the method of preparation summarized above, or variations thereof further described below. Such one or more additives may be added after reacting feed components to prepare the nonequilibrium peracid salt composition including the desired composition properties for the nonequilibrium peracid salt composition. Examples of such one or more additives include dilution liquid (e.g., water) to dilute the peracid salt concentration and/or and acidulant to reduce the pH of the composition. An additive can provide multiple effects, such as both dilution and acidification (e.g., dilution with an acidic aqueous solution). Such dilution and/or acidification can be tailored to provide oxidation properties advantageous for different requirements of different oxidation treatment applications. The adjusted properties of the adjusted nonequilibrium composition are a consequence, at least in part, of adding the one or more additives, and are not solely due to changes that would otherwise naturally occur in the prepared nonequilibrium peracid salt composition as the nonequilibrium peracid salt composition ages after preparation and naturally reacts towards an equilibrium condition. As will be appreciated, acidification will result in conversion of some amount of peracid anion (e.g., peracetate) to the peracid form (e.g., peracetic acid), which may be more beneficial for some oxidation treatment applications. When an oxidative treatment includes contacting the objective substrate with the nonequilibrium peracid salt composition, the nonequilibrium peracid salt composition immediately prior to the contacting will preferably, but need not always, at that time have composition properties (e.g., dissolved peracid anion concentration, pH, hydrogen peroxide concentration, and/or stability index) as summarized above or discussed below for the nonequilibrium peracid salt composition as initially prepared. As will be appreciated, the longer that a nonequilibrium peracid salt composition sits prior to being applied to contact a substrate for oxidative treatment, the more likely that the properties of the composition have changed from desired properties for an initially-prepared composition. The method of preparing the nonequilibrium peracid salt composition advantageously prepares the composition with desirable oxidative potential in a relatively stable form, and in combination with the method of oxidative treatment provides particularly advantageous flexibility to adapt that oxidative potential for more effective use according to different requirements and conditions of different oxidative treatment applications.

Various aspects of this disclosure concern pulp and paper processing. There is an ongoing drive by pulp and paper companies to reduce bleaching chemical costs and improve bleaching performance while avoiding significant increases to bleach plant effluent treatment cost for chemical oxidant demand (COD) biological oxygen demand (BOD).

This invention also provides use of improved peracid salt-ROS formulations and methods of generating peracid salt-ROS formulations, with preferred formulations of the invention being peracetate-ROS formulations, for use in pulp and paper processing. The peracid salt-ROS formulations are nonequilibrium peracid salt compositions capable of generating ROS, and especially singlet oxygen, during use in oxidation treatments. In a previous work, it was discovered that changing the chemical feedstock ratios and initially formed product formulation to outside the ranges taught in prior art results in significant improvements to methods of generating peracetate-ROS formulations at larger production scales made by batch, semi-continuous or continuous process methods. Improvements over prior art generally include: higher production efficiency while using less acetyl donor material; more consistent product characteristics between production batches or cycles; increased working time to apply the chemistry; and lower byproduct residuals of the chemistry resulting in lower pollutants being generated during pulp and paper processing.

The peracetate-ROS formulations used in this invention have a substantially reduced excess of acetyl donor material that more closely approaches a stoichiometric 1:1 ratio of hydrogen peroxide to acetyl donor groups relative to prior art preparation methods while maintaining or increasing the production efficiency of an active peracetate-ROS formulation. This invention provides peracetate-ROS formulations having advantageous properties, and which may be prepared by the noted method and used in pulp and paper processing.

This improved formulation reduces material consumption and associated costs for producing peracetate-ROS formulations compared to previous methods. These methods produce peracetate-ROS formulations with enhanced compositional and performance characteristics with greater consistency of prepared formulations than previous methods in batch, semi-continuous and continuous production processes for large scale commercial uses.

This improved peracetate-ROS formulation increases working time at an elevated concentration range prior to its use or dilution to a point of use concentration.

This peracetate-ROS formulation contains less total organic carbon (TOC) from product residues compared to previous formulations. Further this formulation has less TOC, BOD, COD and VOC compared to equilibrium peracetic acid products.

These improvements were enabled by the discovery of a previously unknown “threshold” for the amount of excess acetyl donor relative to hydrogen peroxide as the excess acetyl donor used to prepare the peracetate ROS formulation at a high pH is reduced closer to a stoichiometric molar ratio of acetyl donor groups to hydrogen peroxide, below which threshold there was an abrupt change in reaction behavior such that undesirable side reactions were significantly and unexpectedly reduced relative to the desired reaction to form peracetate at high efficiency and with the preferred composition optimized to generate singlet oxygen. It was discovered that changing the chemical feedstock ratios to outside the ranges taught in prior art resulted in an unexpected, disproportionate change and improvement to the peracetate-ROS formulations and efficiency of preparation performance.

The improved formulation for pulp and paper processing produces a peracetate solution by a near-stoichiometric reaction between hydrogen peroxide and an acetyl donor capable of efficiently producing singlet oxygen, has improved short-term stability for improved working time, and can be used in the presence of acidulants and near-neutral pH buffered environments without significant loss to degradation reactions for use in pulp and paper processing. The improved formulation having a molar ratio of alkali as sodium hydroxide to acetyl donor in a range of 1:1 to 1.3:1 combined with a molar ratio of hydrogen peroxide to acetyl donor in a range of 0.8:1 to 1:1 and where the preferred peracetate solution pH range is 12.5 to 13.5 when first made and where the peracetate concentration in solution is 1% to 8% and the residual hydrogen peroxide concentration is zero to 1400 mg/L and can be used directly in the processing or further diluted as processing may require.

The improved formulation for pulp and paper processing has a molar ratio of alkali as sodium hydroxide to acetyl donor in a range of 1:1 to 1.3:1 combined with a molar ratio of hydrogen peroxide to acetyl donor in a range of 0.8:1 to 1:1 and when first made the peracetate concentration in solution is 1% to 8% and the residual hydrogen peroxide concentration is zero to 1400 mg/L. One aspect of this disclosure is directed to aqueous, nonequilibrium peracetate compositions for generation of singlet oxygen for use in oxidative treatments such as pulp and paper processing.

An aspect of this invention is directed to methods and uses of oxidative treatments of substrates in the pulp and paper processing. Such a method or use can comprise contacting the substrate with a nonequilibrium peracid salt composition. The peracetate solution may provide delignifying, bleaching, and/or brightening pulp. In some embodiments, the peracetate oxidant solution kills the microbial population in the pulp. In some embodiments, the peracetate solution reduces the biofilms and corrosion.

The ROS-generating peracetate formulation may be used for oxidation, delignification and extraction of materials from pulp fibers for brightening and bleaching purposes. These materials can include but are not limited to: lignin, hexenuronic acid, lignin condensation, byproducts of chemical pulping, dihydroconiferyl alcohol, secoiso-lariciresinol, mannans, xylans, hemicellulose, chemical linkages between lignin and carbohydrates (e.g., benzyl ether linkages) and other oxidizable “non-lignin” structures that contribute to kappa number. It may also be used for extracting lignin from cellulosic fibers for the recovery of lignin from the black liquor or spent oxidant liquor.

In some embodiments, the ROS generated by the peracetate formulation, particularly singlet oxygen, are the primary chemical species doing the delignification, brightening and bleaching of fibers.

In some embodiments, the singlet oxygen as the primary reactive oxidant species avoids damage of cellulose fibers relative to other chemical methods for delignification and bleaching.

In some embodiments, the peracetate anion in the peracetate formulation is the primary chemical species doing the delignification, brightening and bleaching of fibers.

In some embodiments, the peracetate anion is primarily reactive to chemical structures susceptible to nucleophilic substitution reactions and nucleophilic oxidation reactions, particularly in lignin chemical structures, and is much less reactive to cellulose chemical structures.

In some embodiments, the combination of peracetate anion and the ROS generated by the peracetate formulation, particularly singlet oxygen, are the chemical species doing the delignification, brightening and bleaching of fibers.

The peracetate oxidant formulation also performs well at its natural pH without the use of additional alkali, which also reduces damage to cellulose fibers. Using the peracetate oxidant formulation to reduce or eliminate the amount of oxygen delignification and/or eliminate at least a portion of pulp bleaching with chlorine, chlorine dioxide or ozone can improve pulp yield, fiber strength, fiber quality and fiber product strength. The peracetate oxidant formulation provides the first known bulk source of singlet oxygen for pulp delignification and bleaching generated on site.

In some embodiments, delignification performance of the ROS-generating peracetate oxidant formulation is high, even at pH 9 or less. Applying the peracetate oxidant in high doses in a single step process is effective, but this approach can be costlier compared to multiple, lower doses of oxidant.

In some embodiments, methods to use the improved ROS-generating peracetate oxidant formulation more efficiently were developed to reduce operating costs of feedstocks so that it can directly compete with chlorine dioxide on a cost basis when considering reducing chlorine chemicals, reducing chlorine bleaching steps, reducing AOX formation and emissions, reducing bleaching effluent for treatment, and reducing capital costs relative to increasing the capacity of conventional mill infrastructure. Additional financial benefits may be realized in lower corrosion-caused maintenance costs, higher pulp yields, greater fiber product strength and increased throughput of an existing pulp line.

Several process variables are important for chemical pulp delignification, brightening and bleaching including chemical concentration, amount of chemical per unit mass of pulp, pulp consistency, temperature, mixing method, mixing energy, contact time with a chemical, residence time in a process stage, number of process stages, process equipment design and overall process design. These variables are incorporated into preferred methods for efficient use of the peracetate oxidant formulation. Methods of using the ROS-generating peracetate oxidant formulation are influenced by the ROS generation behavior of the peracetate oxidant formulation. In some embodiments, thermal acceleration of the reaction(s) that produce ROS, especially singlet oxygen, from the “parent” peracetate formulation is particularly important to performance. In some embodiments increasing the temperature of the peracetate oxidant in pulp treatment accelerates delignification rate by increasing the production rate and concentration of ROS. In some embodiments, increasing the peracetate oxidant concentration in pulp treatment accelerates delignification rate. In some embodiments, increasing pulp consistency increases delignification rate and efficiency by decreasing the dilution of the peracetate oxidant in the liquid phase of the pulp. In some embodiments increasing mixing energy or mixing intensity increases delignification rate.

In some embodiments, heating or thermal acceleration or activation of peracetate oxidant solutions to a temperature between about 50° C. to about 95° C. accelerates the formation of ROS (singlet oxygen) from a “parent” peracetate formulation as shown by enhanced rates of delignification, bleaching and biocidal activity with increasing temperature. Thermal activation that accelerates ROS production rate is useful for pulp treatment in heated environments and hot chemical sanitizing processes.

The rate of delignification also impacts the preservation of pulp fiber yield, strength and quality. Shorter exposure of fiber to oxidizing and alkaline conditions may reduce the amount of non-selective breakdown of cellulose fiber. Shorter retention times may also increase pulp throughput or decrease the size and cost of equipment for a delignification process.

Fiber products, including fiber board, recycle fibers and molded fiber products, produced from pulps of various types used in food packaging and compostables are generally unbleached if chlorine and chlorine dioxide are excluded from the processing. Producing these products with brightened (e.g., 65% ISO brightness or greater) or near-white grades of fiber without the use of traditional bleaching sequences is desirable. In some embodiments, using the peracetate oxidant technology can readily provide a rapid brightening stage over a wide range of production capacity and can be implemented rapidly with minimal capital outlay and space requirements. For existing pulp and paper mills the peracetate oxidant technology is a relatively simple, safe and low-cost retrofit or drop-in replacement. The byproducts of the peracetate oxidant formulation do not contain chlorides and are compatible for being sent to the recovery boiler in a closed-cycle mill process.

In an embodiment, a method of using the peracetate oxidant formulation in bleaching sequences. For example, a conventional three stage or four-stage bleaching sequence may use the sequential pulp treatment stages of chlorine dioxide (D0), oxidative extraction with pressurized oxygen and alkaline hydrogen peroxide (EOP) or extraction with alkaline hydrogen peroxide (Ep), chlorine dioxide (D1), and optionally chlorine dioxide (D2). This bleaching sequence may be abbreviated as D(E_)D and D(EOP)DD. Hydrogen peroxide is used in the sequence to reduce chlorine dioxide use and increase the bleachability of the pulp in a subsequent D stage. The Ep stage is sometimes described as “reactivating” residual lignin and oxidizable materials as chlorine dioxide by products need to be stripped off and/or extracted for the pulp to be receptive to further chlorine dioxide treatment.

In an embodiment, a method of using the peracetate oxidant formulation as a pre-treatment of pulp fiber before a bleach plant sequence where pulp is made more susceptible to delignification in the first stages of the bleach plant (e.g., DₒE, DₒEp, DₒEo, DₒEop) and the additional extracted lignin, as a result of peracetate pre-treatment, flows forward with pulp mill effluent from the bleach plant. The extraction stage, E, is an important stage to follow the peracetate stage with the benefit of reducing or eliminating ClO2 use between the peracetate and extraction stages. However, in longer bleaching sequences the peracetate oxidant formulation may make the D0 and extraction stages more efficient, reduce the amount of ClO2 used in D0, and provide a more permanent brightness gain after extraction (as opposed to a temporary brightness gain from excess hydrogen peroxide used in an extraction stage) which carries forward to the final bleaching stage thereby reducing or eliminating the ClO2 use in a final chlorine dioxide stage.

In some embodiments, the peracetate oxidant solution may be used within the bleaching sequence as a replacement for the EOP stage. The peracetate oxidant is more effective than hydrogen peroxide for removing or extracting residual lignin and is a more selective oxidant than alkaline hydrogen peroxide. The greater performance and selectivity of the peracetate solution may eliminate at least one chlorine dioxide stage, such as eliminating D2 or eliminating D1 and D2. This approach reduces the number of stages needed in a bleach plant, reduces the amount of AOX produced, reduces the amount of chlorinated waste water for disposal and reduces the amount of bleaching chemicals needed. Eliminating at least one chlorine dioxide stage may increase fiber strength and pulp yield. Using the peracetate oxidant as a more selective oxidant for the E stage may increase fiber strength and pulp yield.

In some embodiments, the peracetate oxidant technology is used before or after a pulping process (mechanical, chemical or enzymatic pulping) and may be used up stream or down stream of additional delignification stages such as oxygen delignification or enzymatic delignification. The potential benefit of using the peracetate oxidant chemistry before or after any of these earlier processing stages is to directly remove lignin or to fragment lignin making it more receptive to subsequent treatment stages that ultimately remove lignin from the fiber. The net technical effects of using the peracetate oxidant chemistry can provide more rapid delignification and brightening, higher throughput in the brightening stage or stages, and an overall reduction in bleaching chemical use. For example, fiber brightening may be completed within a working time of about 1 to about 120 minutes, about 60 to about 120 minutes, about 30 to about 60 minutes, about 10 to about 30 minutes, about 1 to 5 minutes and preferably about 10 to 45 minutes of contact time with the peracetate oxidant formulation at an appropriate temperature and pH range.

In another embodiment, conducting fiber brightening with the peracetate oxidant formulation after a sulfide digester pulping stage and prior to a hydrogen peroxide or chlorine dioxide brightening stage.

In another embodiment, treatment of a pulp with the peracetate oxidant formulation for enhancing the brightening of a bleached chemi-thermomechanical pulp (BCTMP) or mechanical pulp before hydrogen peroxide or chlorine dioxide brightening without the substantial removal of lignin. This may be done with peracetate or acidified peracetate. A secondary benefit is increasing brightness of BCTMP without loss of fiber strength or sheet strength.

In an embodiment, pulp brightening treatment is conducted after the final chemical treatment stage in a bleach plant, preferably after a final washing stage, as the pulp is transferred to a storage tank such as a high density storage chest. This treatment is also referred to as “post-bleach brightening” and is conducted to increase the final brightness of a bleached pulp and inhibit color reversion. The peracetate oxidant formulation (as-made or acidified during use, depending on the pH and receptivity of the pulp being treated) oxidizes color centers or color-forming compounds remaining after lignin removal is complete or nearly complete in bleached pulp.

In an embodiment, the pH of the peracetate oxidant formulation may be reduced to a lower pH prior to use for brightening a pulp to avoid alkaline darkening reactions of a bleached pulp during treatment. The pH may be reduced by the use of an acid including inorganic acids (mineral acids) and organic acids.

Another benefit of using the peracetate oxidant formulation for delignification and brightening is odor control during fiber processing and eliminating odors in fiber products.

In another embodiment, conducting fiber brightening with the peracetate oxidant formulation after a sulfide digester pulping stage will rapidly oxidize sulfide carryover and eliminate odors created by the digester process. In another embodiment, conducting fiber treatment with the peracetate oxidant formulation after an oxygen delignification stage will remove lignin and non-lignin materials not removed by the oxygen delignification stage and eliminate odors created by the oxygen oxidation process.

In another embodiment, conducting fiber treatment with the peracetate oxidant formulation before an oxygen delignification stage will remove lignin and non-lignin materials not removed by the oxygen delignification stage and may enhance the performance and efficiency of an oxygen delignification stage while minimizing the amount of organic carbon that could potentially consume oxygen as COD.

In another embodiment, conducting fiber treatment with the peracetate oxidant formulation during an oxygen delignification stage will remove lignin and non-lignin materials not removed by the oxygen delignification stage and may enhance the performance and efficiency of an oxygen delignification stage while minimizing the amount of organic carbon that could potentially consume oxygen as COD.

Types of fiber treated in this invention include wood pulp and other fibers used in paper, packaging, recycle fibers and molded fiber products non-limiting examples include bamboo, eucalyptus, wheat straw, rice, bagasse, palm, flax, hemp, jute and other plant-based sources. The lignocellulosic pulp employed in the present invention can be prepared from any lignocellulose-containing material derived from natural sources such as, but not limited to, hardwood, softwood, gum, straw, bagasse and/or bamboo by various chemical, semichemical, thermal, mechanical or combination pulping processes. Chemical and semichemical pulping processes include, but are not limited to kraft, modified kraft, kraft with addition of sulfur and/or anthraquinone, and sulfite. Mechanical pulping processes include, but not limited to stone groundwood, pressurized groundwood, refiner mechanical, thermo-refiner mechanical, pressure refined mechanical, thermo-mechanical, pressure/pressure thermo-mechanical, chemi-refiner-mechanical, chemi-thermo-mechanical, thermo-chemi-mechanical, thermo-mechanical-chemi, and long fiber chemi-mechanical pulp.

In some embodiments, the use of peracetate oxidant formulation is significantly safer than chlorine and chlorine dioxide. Peracetate oxidant solutions are composed of sodium peracetate salt, which is a water soluble solid in its native form. Salts in general have significantly lower vapor pressures than liquids and gases at room temperature. A small fraction of the sodium peracetate can be present as peracetic acid, however, peracetic acid is consumed by reactions with sodium peracetate and does not reach significant concentrations in solution. Exposure to sodium peracetate solution is limited to inhalation of an aerosol or mist and exposure to liquid concentrates.

In some embodiments, a method provides for treating pulp in pulp and paper mills. The treating may consist of delignifying, bleaching and/or brightening the pulp. The methods may include providing a peracetate oxidant solution. The peracetate solution may include peracetate anions and a peracid. In some embodiments, the peracetate solution may include a pH from about pH 12 to about pH 13.5. In some embodiments, the peracetate solution has a molar ratio of peracetate anions to peracid ranging from about 10,000:1 to about 40,000:1. In some embodiments, the peracetate solution has a molar ratio of peracetate to hydrogen peroxide of greater than about 16:1. The peracetate solution may provide delignifying, bleaching, and/or brightening pulp. In some embodiments, the peracetate oxidant solution kills the microbial population in the pulp. In some embodiments, the peracetate solution inhibits biofilm and slime formation on equipment and reduces corrosion on and around pulping, bleaching and papermaking equipment.

In some embodiments the improved sodium peracetate oxidant solution can be used as-made in its alkaline form (PM3) or acidified to a lower pH (aPM3). The method of generating sodium peracetate solution offers a unique path to a pH-flexible peracetic acid containing product for a variety of uses. The PM3 form is preferred when a nucleophilic oxidant (peracetate anion) combined with an oxidant with electrophilic character (singlet oxygen) are the dominant species. The aPM3 form is preferred when an electrophilic oxidant (peracetic acid), which may be combined with hydroxyl radicals and acetoxy radicals formed at elevated process temperatures, are the dominant species. The choice between which form is dominant is determined by technical effect desired, use conditions or process conditions.

In some embodiments, a method provides for microbial control by reducing the microbial load in contaminated water of water recycle loops. These water recycling loops include pulp and paper mills. The methods may include providing a peracetate oxidant solution. The peracetate solution may provide bleaching, sanitizing and/or disinfection of contaminated water and surfaces. The peracetate oxidant solution may provide enhanced separation of microbes from contaminated water.

In some embodiments, the peracetate oxidant solution kills the microbial population in the contaminated water. In some embodiments, the microbes are removed from the contaminated water. In some embodiments, the peracetate solution reduces the biofilms and microbial corrosion.

In some embodiments, a method provides for microbial control and reduction of oxidation byproducts in water treatment, bleaching and paper making using highly active peracetate oxidant solutions.

In some embodiments, the amount of peracetate oxidant solution used is dependent on the severity of contamination, the degree of microbial control desired and residual oxidant solution necessary for effective microbial control.

In some embodiments, the contaminated water can be sequentially dosed with peracetate oxidant solution until the degree of microbial control desired is reached and the sequential dosing has a synergistic effect on microbial control. The reducing of the microbial load prevents bacteria in the contaminated water from becoming anaerobic and prevents the formation of sulfides, ammonia, volatile organic acids which result in reduced release of volatile materials and odor control.

In some embodiments, a method is provided for the ability to combine the use of peracetate oxidant solution and an alternative oxidant for improved antimicrobial treatment of water. In some embodiments, the alternative oxidant is selected from the group consisting of chlorine, chlorine bleach, bromine, iodine and fluorine.

In some embodiments, a method is provided for reducing the microbial load in contaminated water previously treated with an alternative oxidant by treating with a peracetate oxidant solution for improved microbial control of water.

In some embodiments, heating or thermal activation of peracetate oxidant solutions to a temperature between about 38° C. to about 95° C. accelerates the formation of ROS products as shown by greatly enhanced bleaching and biocidal activity with increasing temperature. Thermal activation that accelerates ROS production rate is useful for microbial control in heated environments and hot chemical sanitizing processes. In some embodiments, a method is provided for reducing the microbial load in a slurry comprising containing a population of microbes with a peracetate oxidant solution; and mixing said slurry with the peracetate oxidant solution.

In some embodiments, the improved peracetate oxidant formulation has a very low organic halide formation potential in wastewater treatment and pulp bleaching compared to chlorine and chlorine dioxide.

Various aspects of this disclosure concern food processing. This invention provides use of improved peracid salt-ROS formulations and methods of generating peracid salt-ROS formulations, with preferred formulations of the invention being peracetate-ROS formulations, for use in food processing. The peracid salt-ROS formulations are nonequilibrium peracid salt compositions capable of generating ROS, and especially singlet oxygen, during use in oxidation treatments. In previous work, it was discovered that changing the chemical feedstock ratios and initially formed product formulation to outside the ranges taught in prior art results in significant improvements to methods of generating peracetate-ROS formulations at larger production scales made by batch, semi-continuous or continuous process methods. Improvements over prior art generally include: higher production efficiency while using less acetyl donor material; more consistent product characteristics between production batches or cycles; increased working time to apply the chemistry; and lower byproduct residuals of the chemistry resulting in lower pollutants being generated during food processing.

The peracetate-ROS formulations used in this invention have a substantially reduced excess of acetyl donor material that more closely approaches a stoichiometric 1:1 ratio of hydrogen peroxide to acetyl donor groups relative to prior art preparation methods while maintaining or increasing the production efficiency of an active peracetate-ROS formulation. This invention provides peracetate-ROS formulations having advantageous properties, and which may be prepared by the noted method and used in food processing.

This improved formulation reduces material consumption and associated costs for producing peracetate-ROS formulations compared to previous methods. These methods produce peracetate-ROS formulations with enhanced compositional and performance characteristics with greater consistency of prepared formulations than previous methods in batch, semi-continuous and continuous production processes for large scale commercial uses.

This improved peracetate-ROS formulation increases working time at an elevated concentration range prior to its use or dilution to a point of use concentration.

The improved formulation produced by the methods herein can be in the form of a liquid, an ice, a foam, a fog, an emulsion, a microemulsion or an aerosol. The invention also provides improved formulations for point of use applications which are appropriately formulated for application by injection, flooding, spraying, and/or circulation.

This peracetate-ROS formulation contains less total organic carbon (TOC) from product residues compared to previous formulations. Further this formulation has less TOC, BOD, COD and VOC compared to equilibrium peracetic acid products.

These improvements were enabled by the discovery of a previously unknown “threshold” for the amount of excess acetyl donor relative to hydrogen peroxide as the excess acetyl donor used to prepare the peracetate ROS formulation at a high pH is reduced closer to a stoichiometric molar ratio of acetyl donor groups to hydrogen peroxide, below which threshold there was an abrupt change in reaction behavior such that undesirable side reactions were significantly and unexpectedly reduced relative to the desired reaction to form peracetate at high efficiency and with the preferred composition optimized to generate singlet oxygen. It was discovered that changing the chemical feedstock ratios to outside the ranges taught in prior art resulted in an unexpected, disproportionate change and improvement to the peracetate-ROS formulations and efficiency of preparation performance.

The improved formulation produces a peracetate solution by a near-stoichiometric reaction between hydrogen peroxide and an acetyl donor capable of efficiently producing singlet oxygen, has improved short-term stability for improved working time, and can be used in the presence of acidulants and near-neutral pH buffered environments without significant loss to degradation reactions for use in food processing. The improved formulation having a molar ratio of alkali as sodium hydroxide to acetyl donor in a range of 1:1 to 1.3:1 combined with a molar ratio of hydrogen peroxide to acetyl donor in a range of 0.8:1 to 1:1 and where the preferred peracetate solution pH range is 12.5 to 13.5 when first made and where the peracetate concentration in solution is 1% to 8% and the residual hydrogen peroxide concentration is zero to 1400 mg/L and can be used directly in the processing or further diluted as processing may require.

There is an ongoing need for improved cleaning and sanitization of food surfaces as well as microbial control applications that are commercially useful as effective, safer and more environmentally friendly alternatives to current oxidants used in food processing.

The improved formulation has a molar ratio of alkali as sodium hydroxide to acetyl donor in a range of 1:1 to 1.3:1 combined with a molar ratio of hydrogen peroxide to acetyl donor in a range of 0.8:1 to 1:1 and when first made the peracetate concentration in solution is 1% to 8% and the residual hydrogen peroxide concentration is zero to 1400 mg/L. One aspect of this disclosure is directed to aqueous, nonequilibrium peracetate compositions for generation of singlet oxygen for use in oxidative treatments such as cleaning, sanitization, microbial control, decontamination, water recycling, odor control in food processing.

The improved formulation produced by the methods herein is distributed to its point of use. The form in which the formulation is distributed can be a liquid, an ice, a foam, a fog, an emulsion, a microemulsion or an aerosol. The invention also provides improved formulations for point of use applications which are appropriately formulated for application by injection, flooding, spraying, and/or circulation.

This invention is directed to methods and uses of oxidative treatments of substrates in the food processing. Such a method or use can comprise contacting the substrate with a nonequilibrium peracid salt composition. The peracetate solution may provide cleaning and sanitization of a substrate. In some embodiments, the peracetate oxidant solution kills the microbial population on or in the substrate. In some embodiments, the peracetate solution reduces the biofilms and corrosion.

In some embodiments, the ROS generated by the peracetate formulation, particularly singlet oxygen, are the primary chemical species doing the cleaning and sanitization of a substrate. The direct reaction of peracetate with substrate is minimal, which contrasts with the use of conventional peracetic acid in combination with hydrogen peroxide as the primary oxidants, which have much lower performance efficiency (and therefore, higher cost) for cleaning and sanitization.

In some embodiments, the peracetate oxidant formulation produces singlet oxygen as the primary reactive oxidant species and therefore avoids damage relative to other chemical methods for sanitization. The peracetate oxidant formulation provides the first known bulk source of singlet oxygen for food sanitization generated on site.

In some embodiments, sanitization performance of the ROS-generating peracetate oxidant formulation is high, even at pH 10 or less. Applying the peracetate oxidant in high doses in a single step process is effective, but this approach can be costlier compared to multiple, lower doses of oxidant.

In some embodiments, methods to use the ROS-generating peracetate oxidant formulation more efficiently were developed to reduce operating costs of feedstocks so that it can directly compete on a cost basis when considering reducing chlorine chemicals, reducing halogenated disinfection byproducts formation and emissions, reducing effluent for treatment, and reducing capital costs relative to increasing the capacity of typical food processing.

Several process variables are important for sanitization including chemical concentration, amount of chemical per unit mass, temperature, mixing method, mixing energy, contact time with a chemical, residence time in a process stage, number of process stages, process equipment design and overall process design. These variables are incorporated into preferred methods for efficient use of the peracetate oxidant formulation. Methods of using the ROS-generating peracetate oxidant formulation are influenced by the ROS generation behavior of the peracetate oxidant formulation. In some embodiments, thermal acceleration of the reaction(s) that produce ROS, especially singlet oxygen, from the “parent” peracetate formulation is particularly important to performance. In some embodiments increasing the temperature of the peracetate oxidant in treatment accelerates sanitization rate by increasing the production rate and concentration of ROS. In some embodiments, increasing the peracetate oxidant concentration in treatment accelerates sanitization rate.

In some embodiments, heating or thermal acceleration or activation of peracetate oxidant solutions to a temperature useful for food processing accelerates the formation of ROS (singlet oxygen) from a “parent” peracetate formulation as shown by enhanced rates of sanitization, and biocidal activity with increasing temperature. Thermal activation that accelerates ROS production rate is useful for treatment in heated environments and hot chemical sanitizing processes.

For existing food processing facilities, the peracetate oxidant technology is a relatively simple, safe and low-cost retrofit or drop-in replacement. The byproducts of the peracetate oxidant formulation do not contain chlorides and are readily biodegradable and have very little corrosivity or volatility in a closed-cycle process.

In some embodiments, the use of peracetate oxidant formulation is significantly safer to work with than large quantities of chlorine, hypochlorite, chlorine dioxide, chloramine and concentrated peracetic acid. Peracetate oxidant solutions are composed of sodium peracetate salt, which is a water soluble solid in its native form. Salts in general have significantly lower vapor pressures than liquids and gases at room temperature. A small fraction of the sodium peracetate can be present as peracetic acid, however, peracetic acid is consumed by reactions with sodium peracetate and does not reach significant concentrations in solution. Exposure to sodium peracetate solution is limited to inhalation of an aerosol or mist and exposure to liquid concentrates.

In some embodiments, a method provides for treating in food facilities. The treating may consist of cleaning and or sanitizing a primary, secondary or tertiary food process. The methods may include providing a peracetate oxidant solution. The peracetate solution may include peracetate anions and a peracid. In some embodiments, the peracetate solution may include a pH from about pH 12 to about pH 13.5. In some embodiments, the peracetate solution has a molar ratio of peracetate anions to peracid ranging from about 10,000:1 to about 40,000:1. In some embodiments, the peracetate solution has a molar ratio of peracetate to hydrogen peroxide of greater than about 16:1. In some embodiments, the peracetate oxidant solution kills the microbial population on the substrate. In some embodiments, the peracetate solution reduces the biofilms and corrosion.

In some embodiments, a method provides for microbial control by reducing the microbial load in contaminated water of water recycle loops. These water recycling loops include food processing systems. The methods may include providing a peracetate oxidant solution. The peracetate solution may provide bleaching, sanitizing and/or disinfection of contaminated water and surfaces. The peracetate oxidant solution may provide enhanced separation of microbes from contaminated water.

In some embodiments, the peracetate oxidant solution kills the microbial population in the contaminated water. In some embodiments, the microbes are removed from the contaminated water. In some embodiments, the peracetate solution reduces the biofilms and microbial corrosion on substrates.

In some embodiments, a method provides for microbial control and reduction of oxidation byproducts in water treatment, using highly active peracetate oxidant solutions.

In some embodiments, the amount of peracetate oxidant solution used is dependent on the severity of contamination, the degree of microbial control desired and residual oxidant solution necessary for effective microbial control.

In some embodiments, the contaminated water can be sequentially dosed with peracetate oxidant solution until the degree of microbial control desired is reached and the sequential dosing has a synergistic effect on microbial control. The reducing of the microbial load prevents bacteria in the contaminated water from becoming anaerobic and prevents the formation of sulfides, ammonia, volatile organic acids which result in reduced release of volatile materials and odor control.

In some embodiments, a method is provided for the ability to combine the use of peracetate oxidant solution and an alternative oxidant for improved antimicrobial treatment of water. In some embodiments, the alternative oxidant is selected from the group consisting of chlorine, chlorine bleach, bromine, iodine and fluorine.

In some embodiments, a method is provided for reducing the microbial load in contaminated water previously treated with an alternative oxidant by treating with a peracetate oxidant solution for improved microbial control of water.

In some embodiments, the improved peracetate oxidant solution can be used over a wide range of temperatures for example from about 2° C. to about 95° C. depending on type of food processing. In some embodiments, heating or thermal activation of peracetate oxidant solutions to a temperature between about 38° C. to about 95° C. accelerates the formation of ROS products as shown by enhancing biocidal activity with increasing temperature. Thermal activation that accelerates ROS production rate is useful for microbial control in heated environments and hot chemical sanitizing processes. In some embodiments, a method is provided for reducing the microbial load in a substrate comprising containing a population of microbes with a peracetate oxidant solution; and mixing said substrate with the peracetate oxidant solution.

In some embodiments, the peracetate oxidant has a very low organic halide formation potential in process water treatment as compared to chlorine and chlorine dioxide. This is an important concern for worker exposure in food processing plants.

In some embodiments, the peracetate oxidant is generated at, or near, the point of use as an aqueous solution due to its high activity and half-life of minutes to hours depending on concentration and use conditions. The oxidant is active long enough to serve as an oxidant and/or biocide before it is consumed or attenuates leaving benign and readily degradable residuals including oxygen, sodium acetate and glycerol.

These and other aspects of this disclosure are subject to various refinements and enhancements as discussed herein, including in the section below titled “Example Implementation Combinations” and in the appended claims, and as illustrated in the drawings.

### BRIEF DESCRIPTION OF THE DRAWINGS

FIG. 1 shows a graph comparison of pH, peracetic acid concentration and acetyl donor groups to hydrogen peroxide ratios of the formulation vs prior art.

FIG. 2 shows an ionization curve for 5.8% w/v sodium peracetate concentration at 25° C.

FIG. 3 shows a graph comparison of pulp brightness treated with acidified sodium peracetate (solid bars) and as-made sodium peracetate (patterned bars) versus the pounds of PAA equivalent per ton of oven dried pulp.

FIG. 4 compares brightness (circles) and kappa number (triangles) for pulp after the D₀-Ep stages (open symbols) and NaPAc-Dₒ-Ep stages (solid symbols) relative to the D₀ chlorine dioxide dose.

FIG. 5 depicts brightness of pulp after the D₀-Ep-D1 stages (open symbols) and NaPAc-Dₒ-Ep-D1 stages (solid symbols) relative to the D₀ chlorine dioxide dose. Extrapolated ClO₂ reduction for equivalent final brightness with NaPAc pre-treatment indicated by dotted arrows.

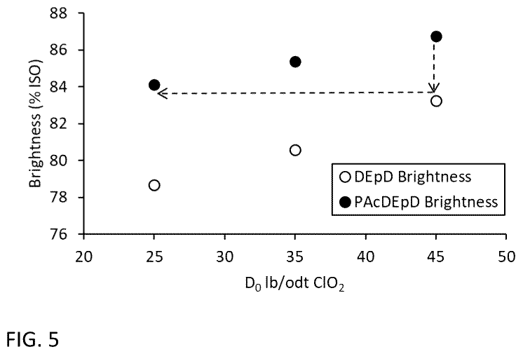

### DETAILED DESCRIPTION

### Definitions

Unless defined otherwise, all technical and scientific terms used herein have the same meaning as commonly understood by one of ordinary skill in the art.

The term “reactive oxygen species” as used herein generally refers to a species such as may include singlet oxygen (¹O₂), superoxide radical (O₂^{•-}), hydroperoxyl radical (HOO⁻), hydroxyl radical (HO⁻), acyloxy radical (RC(O)—O⁻), and other activated or modified forms of ozone (e.g., ozonides and hydrogen trioxide). Each of these ROS has its own oxidation potential, reactivity/compatibility profile, compatibility/selectivity and half-lives.

The term “substrate” as used herein generally refers to solid object surfaces, particulates and liquids amenable to contact with the improved formulation. A food processing substrate can be any substrate having contact with or containing a food, food soil, food intermediate or a derivative thereof. For example, an interior surface of a food processing vessel; a food conveyance surface (such as for example a conveyance surface of a belt conveyor, vibratory conveyor, pump or conduit); a food cutting surface; a food cutting blade surface; food blender surface; a food mincer surface; a food grinder surface; a food masher surface; a food cooking surface; a food preparation utensil surface; or combinations thereof.

The term “food product” as used herein generally refers to any material intended for consumption by a human or animal, including in forms suitable for consumption as a food, in forms suitable for being prepared by a consumer (alone or in combination with other ingredients) into a consumable food, and in preliminary or intermediate forms during any stage of processing prior to achieving a consumable form. Food products include raw agricultural products (whether as harvested or in an initially synthesized form for synthesized materials) to be processed into a form for distribution or sale the food marketplace of for consumption and each intermediate form during processing to prepare such a form for distribution, sale or consumption. For example, food products include harvested vegetables in raw harvested form as well as intermediately processed forms prior to form for distribution, sale or consumption (e.g., washed, sliced, chopped, minced, mashed, blanched, par-boiled, cooked, frozen, preserved, packaged and blended forms). Likewise, food products include initially butchered meat as well as intermediately processed forms prior to a form for distribution, sale or consumption (e.g., cut, preserved, packaged, partially-cooked, frozen, cooked, packaged, or mixed (with other ingredients) forms). Similarly, food products include harvested fish and seafood in raw harvested form, as well as intermediately processed forms prior to a form for sale or consumption.

The term “acyl group”, as used herein, is a —C(O)R′ group, where R is generally a hydrocarbon-based group and more specifically is an alkyl group, or aryl group (e.g., phenyl or benzyl). An acetyl group is a type of acyl group where R′ is a methyl group, i.e., —C(O)CH₃. An “acyl donor”, particularly an “acetyl donor”, functions to transfer an acyl or particularly an acetyl group, respectively, to another chemical species. “Acyl Donor” includes, but is not limited to, an acetyl donor chosen from the group including: monoacetin, diacetin, triacetin (TA), acetylsalicylic acid, and tetraacetylethylenediamine (TAED). “Acyl donor” refers to a material that provides an acyl group for preparation of the peracetate-ROS formulations whereas “acyl donor group” refers to an acyl group on an acyl donor that is available on the acyl donor material to be transfer for preparation of the peracetate-ROS formulation.

The term “alkali” or “alkali concentrate” includes any alkali material. In a preferred embodiment, alkali is an aqueous sodium hydroxide solution, or an aqueous potassium hydroxide solution.

The term ‘acidulants” includes any acid used to impart acidity to a substrate. Nonlimiting examples of acids useful in the invention may include: hydrochloric, sulfuric, acetic, formic, lactic, citric, malic, and other acids. Acids may be inorganic or organic acids.

The term “side reactions” includes any chemical reaction that occurs at the same time as the actual main reaction, but to a lesser extent. It leads to the formation of by-product, so that the yield of main product is reduced.

The term “byproducts” means any additional substance that results from a chemical reaction. Byproducts may be useful as co-solvents, pH buffers, chelating agents or stabilizers. For example, the byproduct of monoacetin, diacetin and triacetin is glycerol, a potential co-solvent that is readily biodegradable. Another example is the byproduct of TAED (tetraacetylethylenediamine) which is DAED (diacetylethylenediamine), which can act as a chelating agent for transition metal ions and potentially serve as a peroxide stabilizer. Another example of a byproduct is the carboxylic acid produced after a peracid reacts with a material in a chemical oxidation process or decomposes. Acetic acid, a byproduct of peroxyacetic acid, can serve as a co-solvent, an acidulant, a pH buffer, and a chelating agent.

The term “pulp” as used herein generally refers to a suspension of cellulose fibers in water consisting of any lignocellulose-containing material derived from natural sources such as, but not limited to, hardwood, softwood, bamboo, eucalyptus, wheat straw, rice and other plant-based sources, straw, bagasse and/or bamboo and such pulp produced by various chemical, semichemical, thermal, or mechanical pulping processes, or a combination pulping processes. This suspension may also be referred to as a slurry.

The terms “delignifying” and “delignification” as used herein generally refers to removal of lignin from wood and non-wood fibers by mechanical, chemical or enzymatic means or a combination thereof the polymer lignin from wood.

The term “bleaching” as used herein generally refers to a chemical process used to whiten and purify pulp and the processing of wood to decrease the color of the pulp and to make it whiter.

The term “brightening” as used herein generally refers to increasing the reflectance and/or whiteness of fibers, which may be related to a reduction in kappa number as a result of delignification and bleaching without the use of traditional bleaching to achieve a brightness of 65% ISO brightness units or greater.

The term “pulp treatment process” as used herein generally refers at least one of pulping, delignification, brightening and bleaching.

The term “cleaning” in the context of food processing as used herein means the substantially complete removal of food soil, typically using detergents under recommended conditions and procedures.

The term “sanitize” means reduction of microorganisms to levels considered safe from a public health viewpoint.

The term “sterilize” refers to the statistical destruction of substantially all living organisms.

The term “disinfect” refers to inanimate objects and the destruction of substantially all vegetative cells.

The term “slurry” refers to a medium including solids dispersed in a liquid, and in food processing typically in flowable form, and includes certain food intermediates or byproducts resulting from processing for example fruits, vegetables and dairy. In pulp processing, pulp fibers to be processed are typically in a slurry form dispersed in aqueous liquid.

The term “food processing” as used herein generally refers to any processing of a food product, from a raw harvested or initially synthesized form, prior to preparation of a food in a final form for consumption. Some examples of food processing include washing; peeling; cleaning; sanitization; slicing; chopping; mincing; mashing; cooking or partially cooking (e.g., blanching or par boiling); blending, mixing or combining with other ingredients; preserving (e.g., sterilization; sterile packaging or adding preservatives); refrigeration; freezing; and packaging. Food processing includes conversion of agriculture products to food, including so-called primary food processing to turn raw agricultural products into food which can be eaten, so-called secondary food processing to create food from ingredients that are ready to use, for example baking bread and so-called tertiary processing to creating what is sometimes referred to as “processed” food, for example potato chips or frozen meals.

The term “food contact surface” as used herein means any surfaces that come into contact with a food product or from which drainage onto a food product occurs during any stage of food processing. Food contact surfaces include, for example, cutting surfaces of counters or tables, interior surfaces of tanks and other vessels in which food is subjected to processing, surfaces of utensils (e.g., knives, spoons, mixers, spatulas, etc.) that contact food products, and surfaces of food product conveyors (e.g., belt conveyors, liquid or slurry conduits, vibratory conveyors, etc.).

The term “food additive” as used herein generally refers to any substance the affects the characteristic of any food. This includes any substance used in processing, and packaging. Additives are used to improve or maintain safety, freshness, taste, texture or appearance.

The term “pollutant” in the food processing context as used herein is generally defined as the presence in food or associated with food of toxic chemicals (elements or compounds) and/or biological contaminants which are not naturally present in food or are above their natural background levels (for those chemicals which are naturally found in some foods). These include disinfection byproducts.

References to peracid concentration (e.g., peracetate concentration) are to the concentration of the peracid anion (e.g., peracetate anion) component of the peracid salt (e.g., peracetate salt), that is excluding the mass of the metal component (e.g., sodium, potassium) of the peracid salt, on a weight/volume ratio, that is a weight (or mass) of the peracid anion to the total volume of the formulation. As will be appreciated, when a peracid-based formulation comprises the peracid component primarily in the form of a conjugate base (e.g., peracetate anion for peracetic acid-based formulation) as is the case with peracid salt-ROS formulations discussed herein having a very large molar ratio of peracid anion (e.g., peracetate anion) to peracid (e.g., peracetic acid), such as for example 10,000:1 or larger, a weight/volume concentration of the formulation measured in terms of an equivalent amount of peracetic acid will be close to the concentration of the peracid anion, and needs to be adjusted only to remove the mass of a dissociated proton.

The present invention involves improved peracetate-ROS formulations, and methods of making peracetate-ROS formulations, capable of producing significant quantities of reactive oxygen species, including singlet oxygen. An unexpected finding enabling the improvements was the discovery of the noted “threshold” where there was an abrupt change and improvement in product production efficiency and characteristics of the product solution's behavior/properties as the molar ratio of hydrogen peroxide:acetyl donor was reduced toward 1:1 when making peracetate-ROS formulations at a high pH. The threshold appeared to be at a molar ratio of around 1:1.20 to 1:1.25. This finding is in contrast to the teachings of prior art where a more substantial excess of acetyl donor groups was disclosed (i.e., hydrogen peroxide:acetyl donor groups molar ratio of 1:1.25 to 1:4) to make the peracetate formulation and generally with formula preparation at lower alkaline pH's at the lower end of this prior art range.

In some embodiments the peracetate-reactive oxygen species formulation has a very alkaline pH as prepared, with the pH in a range having a lower limit selected from the group consisting of about pH 12.2, about pH 12.3, about pH 12.4 and about pH 12.5 and having an upper limit selected from the group consisting of about pH 13.5, about pH 13.2, about pH 13.0 and about pH 12.9, and with one preferred range being from about 12.5 to about 13.5 and with another preferred range being from pH 12.5 to pH 12.9. As will be appreciated, the peracid-reactive oxygen species formulations are typically aqueous compositions. Also as will be appreciated, the peracetate-reactive oxygen species formulations will be non-equilibrium compositions that will degrade over time. However, the combination of very alkaline pHs with minimal excess acyl donor groups at which the peracetate-reactive oxygen species formulations are prepared provide advantages of contributing to reduction of side reactions during preparation and slower degradation of the non-equilibrium composition until the non-equilibrium composition is subjected to a lower-pH environment, for example as would be the case when added to a liquid composition to be treated that is at a lower pH, or is contacted with a solid object surface to be treated.

In some embodiments the peracetate-ROS formulation has a peracid anion to peracid molar ratio in a range having a lower limit selected from the group consisting of about 10,000:1, about 15,000:1 and about 18,000:1 and an upper limit selected from the group consisting of about 40,000:1 and about 38,000:1. One preferred range is from 15,000 to 40,000, and a more preferred range is from 18,000 to 38,000. In one a preferred embodiment the peracid anion to peracid ratio is from about 18,970:1 to about 37,880:1. This ratio of peracid anion to peracid enables a preferred calculated pH range of about 12.5 to about 12.8 for the peracetate-ROS formulation of the present invention.

In some embodiments an alkali hydrogen peroxide solution is generated using a molar ratio of hydrogen peroxide to alkali in the range having an upper limit selected from the group consisting of 1:0.8, 1:0.9 and 1:1.0 and a lower limit selected from the group consisting of 1:1.5, 1:1.3, 1:1.2 and 1:1.18, and with one preferred range being from 1:1.0 to 1:1.2 and another preferred range being from 1:1.0 to 1:1.18.

In some embodiments the peracid salt-ROS formulation is produced by mixing the alkali hydrogen peroxide solution with an acyl donor such that the molar ratio of hydrogen peroxide to acyl donor groups, and preferably acetyl donor groups, is in a range of having a first limit (upper limit) selected from the group consisting of 1:1.0, 1:1.05, 1:1.08 or 1:1.10 and a second limit (lower limit) selected from the group consisting of 1:1.25, 1.23, 1.20, or 1.18, with one preferred range being from 1:1.0 to 1:1.23, another preferred range being from 1.1.0 to 1:1.20, yet another preferred range being from 1:1.05 (and more preferably from 1:1.08) to a selected upper limit and preferably the selected upper limit is 1.123, more preferably 1.120 and even more preferably 1.18. Any ratios described herein can be alternatively stated simply as the decimal quotient value for the ratio. For example, a ratio of 1:1.10 could alternatively be stated as 0.91 (the quotient of 1/1.10). Also, some ratios are discussed herein in an alternative format with the components of the ratios reversed, and for which the quotient value will be a reciprocal value. For example, the discussion below includes references to the molar ratio of hydrogen peroxide to acyl donor groups. As one example, a molar ratio of acyl donor groups to hydrogen peroxide of 1.20:1 (or more simply stated as a quotient value of 1.20) is the same as a molar ratio of hydrogen peroxide to acyl donor groups of 0.83:1 (or more simply stated as a quotient value of 0.83).

In some embodiments the peracetate-ROS formulation has a molar ratio of peracid anions, preferably peracetate anions, to hydrogen peroxide of greater than about 16:1.

In some embodiments a peracetate-ROS formulation, which may be considered to be in the form of a prepared concentrate, is produced with a peracetate concentration (on a peracetate basis, excluding the salt metal such as sodium or potassium) in a range having a lower limit selected from the group consisting of about 1.0% wt/vol, about 2.0% wt/vol and about 3.0% wt/vol and an upper limit selected from the group consisting of about 8.0% wt/vol, about 6.0% wt/vol and about 5% wt/vol, with one preferred concentration range being from about 2.0 wt/vol to about 6.0% wt/vol and a more preferred concentration range being from about 3.0% wt/vol to about 5% wt/vol.

In some embodiments the acyl donor is an acetyl donor, with one preferred acetyl donor being triacetin. Although much of the description herein is presented in terms of acetyl donor, the same principles apply to other acyl donors.

In some embodiments the hydrogen peroxide in the formulation is no more than, and preferably less than, 10 mg/L. The limit for level of detection for hydrogen peroxide is 10 mg/L by one common hydrogen peroxide analysis technique.

In some embodiments the production efficiency in this improved formulation can be defined as the efficiency of hydrogen peroxide use and/or efficiency of triacetin use relative to the theoretical limit of complete conversion to peracetic acid of a stoichiometric molar feed ratio of hydrogen peroxide to acetyl donor groups of 1:1 (which equates to a molar ratio of hydrogen peroxide to triacetin of 1:0.33 when triacetin is used to provide the acetyl donor groups). For example, peracetate may be made at a 98% conversion efficiency of hydrogen peroxide and 90% conversion efficiency of triacetin. However, this is not a limitation on the molar ratio ranges of ingredients or the product formulation. One very useful measure for evaluating production efficiency with the present invention is the conversion efficiency of hydrogen peroxide to peracetate, since the hydrogen peroxide will typically be provided in an amount equal to or no larger than, and more typically somewhat smaller than, a stoichiometric amount relative to acetyl donor groups. Under conditions with a stoichiometric or molar deficiency of hydrogen peroxide, 100% conversion efficiency of hydrogen peroxide to peracetate represents a maximum theoretical conversion efficiency, regardless of the magnitude of the molar excess of acetyl donor groups used. Surprisingly, and unexpectedly, the conversion efficiency of hydrogen peroxide is seen to increase even as the molar excess of acetyl donor groups is decreased to below a threshold molar ratio, and this surprising and unexpected result is thought to be a consequence of a marked reduction in side reactions that result in a lower yield of peracetate relative to the feed of hydrogen peroxide. In this respect, the amount of peracetate in a prepared peracetate ROS formulation is determined as an equivalent quantity of peracetic acid.

In some embodiments the alkali:acetyl donor groups ratio is at least 1:1, and preferably somewhat larger than 1:1, on a molar basis, and preferably the alkali is sodium hydroxide.

In some embodiments, the levels of total organic carbon (TOC), biochemical oxygen demand (BOD) and chemical oxygen demand (COD) of this improved formulation are lower than the original range described in the prior art and is also an advantage over equilibrium peracetic acid.

In some embodiments the mass of chemical ingredients for generating the improved formulation range is lower than the ranges found in the prior art. For example, the hydrogen peroxide:triacetin ratio of the prior art used 2.37 to 5.19 lbs chemical feeds (100% basis) to produce 1.0 lb of peracetic acid equivalents (excluding the sodium). In contrast, the hydrogen peroxide:triacetin ratio of the present invention uses 2.00 to 2.25 lbs chemical feeds (100% basis) to produce 1.0 lb of peracetic acid equivalents (excluding the sodium). For comparison, equilibrium peracetic acid uses approximately 4.75 lbs chemical feeds (100% basis) per pound of peracetic acid. Some advantages associated with the chemistry of the peracetate ROS formulation and preparation method of the present invention are lower material, transportation and storage costs associated with smaller chemical feedstock quantities and increased safety from having less chemicals brought to and handled at a facility.

In some embodiments the improvements to the chemistry formulations used to produce the peracetate-ROS formulation of this invention enable the reliable production at high efficiency and large scale for industrial uses by batch, semi-continuous, or continuous process methods. The improved method provides stoichiometric, or nearly stoichiometric, use of the acetyl donor groups relative to hydrogen peroxide. The most material-efficient and cost-efficient hydrogen peroxide:acetyl group molar ratio is 1:1 and reaching this ratio was achieved in practice while maintaining high production efficiency, minimal hydrogen peroxide residual, and high ROS activity. The improvements have led to the development of a peracetate-ROS formulation that is different in composition to prior art and provides several benefits over the prior art.

In some embodiments the improved formulation produced by the methods herein is in the form of a liquid, an ice, a foam, a fog, an emulsion, a microemulsion or an aerosol. The invention also provides improved formulations for point of use applications which are appropriately formulated for application by injection, flooding, spraying, and/or circulation.

### Technical Improvements and Benefits of the Improved Formulations Include:

Higher production efficiency is achieved with low excess acetyl donor groups use.
More consistent and increased stability of product for maintaining product concentration before it decreases below the LCL (lower concentration limit) for biocidal uses.
Increased consistency of production processes to generate peracetate-ROS product formulations regarding output concentration, production efficiency, pH, and degradation rate.
Lower total organic carbon (TOC) levels in the product than previous formulation range of the prior art.

In some embodiments enhancing the peracetate product formulation with additives can be achieved with greater precision. This is due to greater purity of the peracetate product and elimination of excess hydrolysis reactions producing acetic acid and glycerin. This is a more “pure” sodium peracetate solution than prior art approaches.

In some embodiments adding triacetin after producing peracetate solution is a method for slowly producing acetic acid without degrading the peracetate concentration. This is a method for activating the peracetate solution at a moderate rate over time.

In some embodiments adding this improved formulation to a media having a pH less than about 12, results in greater oxidative activity than peracetic acid according to the oxidation-reduction potential (ORP) response or technical effect. In some embodiments adding this improved formulation to a media having a pH less than about 11, and more preferably having a pH less than about 10, results in greater oxidative activity than peracetic acid according to the oxidation-reduction potential (ORP) response or technical effect. In some embodiments adding this improved formulation to an acidic media produces greater oxidative activity than peracetic acid according to oxidation-reduction potential (ORP) response or technical effect. This behavior is potentially relevant to bleaching, brightening and other applications such as water treatment where the ORP of a solution can be correlated with a level of biocidal control at a given pH.

The oxidative reductive potential (ORP) is a measure of how oxidizing or reducing a solution is relative to a standard reference potential measured in volts. Standard reference potentials are measured relative to the hydrogen/hydrogen ion oxidation-reduction potential of 0.000 V at unit activity for the standard hydrogen electrode (SHE). Generally, solutions with potentials greater than 0 V vs SHE are considered oxidizing (electron accepting) while solutions with potentials less than 0 V vs SHE are considered reducing (electron donating). The measured ORP of water is influenced by its pH or hydrogen ion activity. As the hydrogen ion activity (e.g., concentration) increases, the ORP of water increases to more positive values. ORP is also influenced by the presence of reducing or oxidizing agents relative to their standard reduction-oxidation potentials and solution activities.

ORP is used as a general measure of the antimicrobial strength of a solution containing an oxidizing antimicrobial agent, biocide or disinfectant. ORP may be correlated to relative oxidant concentration for lower oxidant concentrations at constant pH and temperature. This feature is the basis for ORP monitoring systems sometimes used in water treatment and disinfection processes where oxidant dose may be adjusted to maintain a desired ORP and corresponding biocidal activity for a particular oxidant. A ORP value of greater than 650 mV (vs SHE) typically indicates effective microbial control conditions when using oxidative biocide products.

A limitation of the prior peracetate formulations was a significant loss of production efficiency when the molar ratio of hydrogen peroxide to acetyl donor groups was greater than 1:1.5 when using acetyl donor materials, especially triacetin. This loss was caused in part by the slow dissolution rate of the acetyl donor material (e.g., triacetin) in water, which can result in slowing the reaction rate with alkali hydrogen peroxide and allowing side-reactions to occur which reduced production efficiency. Using a greater excess of acetyl donor material increased the reaction rate with alkali hydrogen peroxide to increase production efficiency and minimize hydrogen peroxide residual in the product formulation. The “production efficiency” refers to the conversion efficiency of hydrogen peroxide to peracetate and represents a total measure of how effectively competing reactions are being minimized in the production process.

It was discovered that efficiency losses were caused substantially by chemical side reactions inherent to the prior method/formulation. One side reaction between the peracetate product and excess acetyl donor material discovered in this invention is capable of reducing the pH of the reaction solution rapidly enough during the production process to cause the desired reaction between alkaline hydroperoxyl anion and acetyl groups to slow down and even stop. If the desired reaction is slowed by an excessive reduction of pH during the production process, unreacted hydrogen peroxide (in hydrogen peroxide form) will rapidly react with the peracetate anion resulting in the degradation of the peracetate product. This issue could be minimized by increasing the amount of caustic (e.g., sodium hydroxide) added to the reaction relative to the hydrogen peroxide. However, excessive amounts of caustic would also compete in the reaction with acetyl groups thereby reducing production efficiency. Thus, controlling and limiting the chemical side reactions can improve efficiency losses.

An inherent characteristic of the chemistry is that as the production efficiency decreases, the concentration of peracetate that can be produced decreases. For example, as production efficiency decreases below 90% (% hydrogen peroxide conversion to peracetate and not lost to degradative side reactions) the concentration of peracetate that can be made in the product solution decreases to less than about 3% (as PAA) and chemical feedstock consumption and cost increase significantly. A correlation has also been observed between lower production efficiency and shorter working time due to lower product stability.

In some embodiments, the residual hydrogen peroxide concentration in the peracetate-reactive oxygen species product solution is less than about 1500 mg/L, and preferably less than 750 mg/L. In some embodiments the residual hydrogen peroxide concentration in the peracetate-reactive oxygen species product solution is less than 400 mg/L and preferably less than 10 mg/L, below the level of detection.

A key aspect of the improved formulation was discovered where a hydrogen peroxide:acetyl donor groups molar ratio of 1:1.0 to 1:1.20 (hydrogen peroxide:triacetin-molar ratio of 1:0.33 to 1:0.40) provided an abrupt change in pH behavior, production efficiency, and decay rate of the peracetate product solution in comparison to that described in prior art. The observed “threshold” of these changes can be described as a point where the amount of excess acetyl donor groups present in the production process is reduced to below a critical concentration where the rate of side-reactions that compete with the desired reaction between the hydroperoxyl anion and acetyl donor are reduced more than expected in proportion to incremental changes made in the production method.

Below is a listing of major competing reactions during and/or after production of a peracetate-ROS formulation and a description of each of the reactions:
1. HOO−+TA=>PAc−+glycerol byproduct
2. PAc−+PAA=>OAc−+HOAc+¹O₂
3. PAc−+H₂O₂=>OAc−+³O₂+H₂O
4. PAc−+TA=>HOAc+PAc−+glycerol byproduct
5. NaOH+TA=>NaOAc+glycerol byproduct

In the noted reactions, TA represents triacetin, PAc-represents peracetate anion, PAA represents peracetic acid, OAc-represents acetate anion, HOAc represents acetic acid, ¹O₂ represents singlet oxygen, ³O₂ represents triplet oxygen and NaOAc represents sodium acetate.

Reaction 1 is the desired reaction for the production of peracetate in the product solution, this is a rapid mildly exothermic reaction.

Reaction 2 is desired to produce ROS once the peracetate is made and put into use, this reaction accelerates as pH decreases into a more activated pH range of less than pH 12.

Reaction 3 occurs very rapidly when there is excess hydrogen peroxide in the presence of peracetate anion and is an exothermic reaction.

Reaction 4 was discovered in this invention to be significant in rate, however, it was not obvious because it has no direct impact on peracetate concentration or reaction mixture solution temperature.

Reaction 5 occurs at a moderately rapid rate, but is slower than reaction 1 and can be minimized by using as little excess sodium hydroxide as necessary.

Reactions 3 and 4 are the most rapid and impactful side reactions that can occur during the peracetate production process. Reaction 3 causes rapid consumption of peracetate, heating of the reaction mixture and product solution, and loss of peracetate production efficiency. Reaction 3 occurs to a significant extent if process conditions cause the rate of the desired reaction 1 to slow down or an excessive amount of hydrogen peroxide residual remains in the product solution.

Reaction 4 reduces the pH of the reaction mixture causing reaction 1 to slow and reaction 3 to accelerate resulting in loss of production efficiency and concentration. Reaction 4 can lead to a premature decrease of pH in the reaction mixture, which slows or stops the reaction to form peracetate because the hydroperoxyl anion HOO— is converted to hydrogen peroxide through its acid-base equilibrium. Additionally, as the reaction solution pH decreases, the rate of reaction 2 increases and produces more singlet oxygen at the expense of consuming peracetate, which also results in shortening the product lifetime or working time. It is desirable to not promote reaction 2 until the product solution is put into use.

Table 1 below illustrates the relative impacts of the two side reactions (reaction 2 and 3) on the degradation rate of the peracetate product. Reducing or eliminating these side reactions after the peracetate production process increases the half-life or working time of the concentrated product solution before use. Reducing or eliminating these side reactions during the peracetate production process increases feedstock conversion efficiency (production efficiency) and reduces feedstock consumption per unit of peracetate product, which results in reduced production reaction byproduct residuals and total organic (TOC) in the product solution.

TABLE 1
Comparison of pH and peracetate concentration over 60 minutes for the
peracetate-ROS formulation prepared by the new method of this invention
when left to stand at room temperature as-made and when spiked with triacetin (molar
ratio of 1:1.1 PAc⁻:acetyl donor groups) or hydrogen peroxide (molar ratio
of 1:0.57 PAc⁻:hydrogen peroxide).

| | PAc⁻ | PAc⁻ | PAc⁻ + TA | PAc⁻ + TA | PAc⁻ + HP | PAc⁻ + HP |
|---|---|---|---|---|---|---|
| | pH | Conc | pH | Conc | pH | Conc |
| T = 0 min | 12.8 | 4.50% | 10.7 | 4.50% | 11.5 | 4.50% |
| T = 60 min | 12.3 | 2.79% | 8.9 | 1.37% | 12.5 | 0.87% |

PAc⁻ + TA is an example of reaction 2 accelerated by reaction 4
PAc⁻ + HP (hydrogen peroxide) is an example of reaction 3

In this invention, important production process improvements are made to prevent the reduction in reaction rate of reaction 1, minimize the rate or occurrence of competing reactions, and prevent the buildup of unreacted acetyl donor material (triacetin) in the reaction mixture, reactor process or product working tank. What is unexpected in enabling these improvements is an abrupt change (reduction) in relative rates of competing reactions at a threshold ratio or concentration of acetyl donor (triacetin) outside the range cited in prior art while producing a peracetate solution capable of efficiently generating singlet oxygen with the characteristics described above. Although optimizing a continuous production process design and its components can compensate for some of these limitations, developing a method to better control the underlying chemical reactions is a more reliable method to improve production process efficiency and consistency.

Alkyl peroxide products used for water treatment, pulp treatment, microbial control, and sanitization applications introduce a residual level of total organic carbon (TOC) into a treated water and effluents, which can potentially be a carbon substrate supporting microbial growth (COD) and biological oxygen demand (BOD). A benefit to the improved formulation is that it reduces TOC significantly for an alkyl peroxide-based product compared to prior art and especially compared to equilibrium peracetic acid formulations commonly used. The production method produces an improved peracetate-ROS formulations having measured TOC:peracetate anion mass ratio of 0.51, whereas the TOC:peracetate anion mass ratio in prior art (PAA) is in the range of 0.96 to 1.44 (Example 8, Table 13). Producing a peracetate-ROS formulation with a TOC:peracetate anion mass ratio of less than about 0.60 is a preferred advantage of the invention. BOD and COD measurements were also made and the improved peracetate formulation was found to have significantly lower BOD and COD measurements relative to peracetic acid (Example 8, Table 14).

In some embodiments, a method to produce a peracetate-reactive oxygen species formulation solution capable of efficiently generating singlet oxygen with the formulation described above.

In some embodiments, a method for generating a peracetate-reactive oxygen species formulation, including for use in pulp and paper processing, comprises: generating an alkaline hydrogen peroxide solution having a molar ratio of hydrogen peroxide to alkali in a range having an upper limit selected from the group consisting of 1:0.8, 1:0.9 and 1:1.0 and a lower limit selected from the group consisting of 1:1.5, 1:1.3, 1:1.2 and 1:1.18, and with one preferred range being from 1:1.0 to 1:1.2 and another preferred range being from 1:1.0 to 1:1.18 of about 1:1.0 to about 1:1.2; mixing the alkaline hydrogen peroxide solution with an acetyl donor producing a peracid concentrate; the peracid concentrate generating the peracetate-reactive oxygen species formulation having a pH value from about pH 12.2 to about pH 13.5, and preferably from about 12.5 to about 13.5.

In some embodiments, including for use in pulp and paper processing, a hydrogen peroxide:acyl donor groups ratio (or acetyl donor concentration) beyond a threshold where competing side reactions are reduced to rates significantly less than the reaction between hydroperoxyl anion and acetyl donor. In some embodiments this molar ratio of hydrogen peroxide to acetyl donor groups is from about 1:1.0 to about 1:1.25.

In some embodiments, a method to produce a peracetate solution formulation, including for use in pulp and paper processing, having a peracetate concentration of about 2% wt/vol or 5% wt/vol, wherein the production efficiency is equal to or greater than about 90% efficiency (based on hydrogen peroxide conversion to peracetate).

In some embodiments, a method to produce a peracetate solution formulation, including for use in pulp and paper processing having a peracetate concentration in a range from about 3.0% wt/vol to about 8.0% wt/vol, wherein the production efficiency is equal to or greater than about 95% efficiency (based on hydrogen peroxide conversion to peracetate).

In some embodiments, including for use in pulp and paper processing, a peracetate solution formulation (≥2% peracetate) with peracetate concentration that decreases less than 5% of the initial concentration within 5 to 10 minutes following its production. This formulation can be used in sanitization.

In some embodiments, including for use in pulp and paper processing, a peracetate solution formulation having a TOC:peracetate mass ratio of not greater than, and preferably less than, 0.60 for use in water treatment, pulp treatment, microbial control and sanitization.

In some embodiments a peracetate-ROS solution formulation, including for use in pulp and paper processing, is a diluted formulation that is diluted to a point of use concentration having an extended working time. A preferable extended working time can be up to 120 minutes depending on the use. Uses of the diluted formulation may include for example sanitizing solutions. In some variations of such embodiments, the diluted formulation has properties of pH, molar ratio of peracetate anion to peracetic acid, and molar ratio of peracetate anion to hydrogen peroxide as described herein for the peracetate-ROS formulations.

The improved formulation can be efficiently produced in a “continuous” process as compared to the prior art feedstock ratio range wherein reducing the alkali hydrogen peroxide:triacetin molar ratio to less than 1:0.5 (a 1:1.5 hydrogen peroxide:acetyl donor groups molar ratio) did not make the desired formulation efficiently and degraded more rapidly over time.

This previous practical (ratio) limit is thought to be due to a limitation caused by the relatively low water solubility limit of the acetyl donor material (e.g., triacetin) and a slow dissolution rate into water. A slow dissolution rate allows time for undesirable competing reactions to occur that reduced the product yield and process efficiency relative to the limiting reagent, hydrogen peroxide.

However, the improved formulations have shown that competing side reactions can be significantly reduced in a specific formulation range outside of the formulation range taught in prior art while maintaining the most important features for singlet oxygen generation activity.

The ability to reduce the molar excess of acetyl donor groups to below 1.25 times the molar quantity of hydrogen peroxide while maintaining high conversion efficiency (≥90% relative to hydrogen peroxide consumption and losses) led to unexpected changes in behavior of the product formulation. One significant change is that the pH of the reaction process solution is maintained in a higher range than the formulation range of the prior art. During the reaction between the hydroperoxyl anion and acetyl donor group, if the pH drops too rapidly below about pH 12.2 (approaching the pKa of hydrogen peroxide of 11.6), the desired reaction slows down or stops. This new pH behavior provides a key benefit for keeping hydrogen peroxide substantially in its alkaline, anion form throughout the entire reaction period while in the presence of elevated concentrations of reactants and products. This is an advantage for preventing competing reactions which reduce production efficiency, make the product less stable, and produce higher residual total organic carbon (TOC).

For water treatment, including in pulp and paper processing, the higher pH of the product concentrate made by the improved method does not significantly impact the pH of water it is added to since there is a low amount of NaOH in the product solution. Alkali pH of the product concentrate is primarily due to the sodium peracetate, which is analogous to the pH effect of other weak acids, in their conjugate base forms, having pKa greater than 7 (e.g., sodium carbonate).

In some embodiments the improved product formulation remains in an elevated pH range without decreasing rapidly during and after production. This new behavior led to the discovery of how peracetate can unexpectedly produce acetic acid by reaction with acetyl donor groups without consuming the peracetate in the product. The reaction between peracetate and acetyl donor groups presumably occurs by the peracetate acting as a nucleophile (similar to hydroxide or hydroperoxide anion), which adds to the carbonyl carbon of the acetyl group followed by displacement and water hydrolysis to form acetic acid, an alcohol byproduct of the acetyl donor molecule, and recovery of the peracetate anion.

The pH of the product solution does decrease slowly over time as a result of sodium peracetate (pKa=8.2) being consumed to form acetate and acetic acid (pKa=4.7), but not as rapidly as in the presence of excess acetyl donor groups.

The improvements to the peracetate-ROS formulation production method and formulation solves the above disadvantages. The improved method provides stoichiometric, or nearly stoichiometric, use of the acetyl donor groups relative to hydrogen peroxide. The most material-efficiency and cost-efficient hydrogen peroxide:acetyl donor groups molar ratio is 1:1 and reaching this ratio could be achieved in practice while maintaining high production efficiency, minimal hydrogen peroxide residual, and high ROS activity. The improvements have led to the development of a peracetate-ROS product formulation that is different in composition and solution behavior after production, compared to the prior art. The improvements create a more consistent product produced from a continuous generation system regarding output concentration, production efficiency, pH, and degradation rate. A slower degradation rate was achieved for peracetate-ROS formulations, which provides a longer working time to use the chemistry or dilute the chemistry to a point of use concentration before significant loss in assay occurs, which is important in pulp and paper processing.

Maintaining a high reaction rate between the hydroperoxyl anion and triacetin throughout the reaction process was critical to preventing other side reactions. Reducing the excess of triacetin used in the production process was beneficial to reducing the likelihood of this buildup occurring. Maintaining a high reaction rate between the hydroperoxyl anion and triacetin throughout the reaction process was beneficial to reducing the likelihood of the buildup occurring.

An unexpected result was obtaining a high reaction rate with triacetin in which all three acetyl donor groups reacted rapidly with HOO— to form the peracetate anion in high yield in a continuous production process. And doing so without a large excess of NaOH. This is in contrast to prior art where the reaction with triacetin was slower, requiring an excess to react quickly enough to avoid undesirable side reactions. A correlation has been made between high yield or high efficiency to produce peracetate and the product solution stability.

In an embodiment technical improvements and benefits of use of the improved formulations in processing include:
Lower carbon content in the formulation product measured as BOD, and COD reflecting less carbon byproducts formed as compared to previous formulation.
   Less BOD and COD in effluents to be treated prior to discharged to surface water (river). Lower effluent treatment cost and lower impact on treatment capacity of a treatment facility.
Lower VOC (minimal excess acetyl groups that can be hydrolyzed to acetic acid; higher caustic ratio to keep peracetate product and acetate byproduct in non-volatile anion form, ionized form).
   No VOC emissions when used as-made in PH neutral to alkaline environments.
   Provide odor control without adding VOCs.
Higher “stability index” provides longer working time and less off-gassing of oxygen before use.
   Less O2 gas release in a dispensing line before use (Improved stability)·
Higher “stability index” enables higher product concentrations to be made that are practical to use (working time, off-gassing), which reduces equipment size/capacity and diluent water volume.
   Less diluent water volume needed for making product. Diluent water in a mill is city water or non-potable water (river, white water, recycled) that may require softening and/or filtration or other treatment. RO water is great if available (from boiler water systems).
Less acidulant needed to reduce pH of product (minimized acetate byproduct competing for acid).
Less VOC in acidified PM3 with less acetate byproduct from minimal excess acetyl groups.

In an embodiment, the sodium peracetate oxidant solution for use can be used as-made in its alkaline form (PM3) or acidified to a lower pH (aPM3). The method of generating sodium peracetate solution offers a unique path to a pH-flexible peracetic acid containing product for a variety of uses. The PM3 form is preferred when a nucleophilic oxidant (peracetate anion) combined with an oxidant with electrophilic character (singlet oxygen) are the dominant species. The aPM3 form is preferred when an electrophilic oxidant (peracetic acid), which may be combined with hydroxyl radicals and acetoxy radicals formed at elevated process temperatures, are the dominant species. The choice between which form is dominant is determined by technical effect desired, use conditions or process conditions.

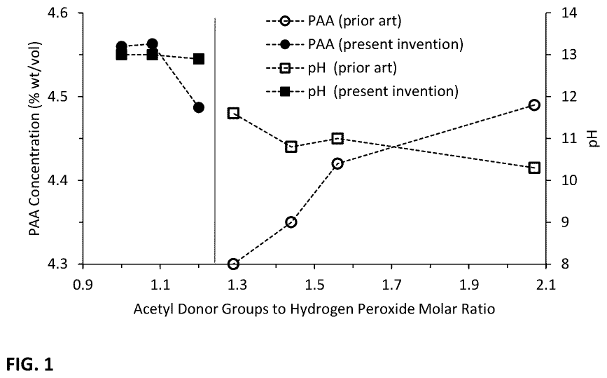

Acidified sodium peracetate (aPM3) is produced by the method of generating sodium peracetate solution and adding an appropriate amount of acid to neutralize residual sodium hydroxide in solution and to transform greater than about 50% of peracetate anion to the peracetic acid form. Preferably greater than about 60% of the peracetate in the peracetic acid form, preferably greater than about 80% of the peracetate in the peracetic acid form, preferably greater than about 90% of the peracetate in the peracetic acid form, and preferably greater than about 99% of the peracetate in the peracetic acid form depending on the use application and technical effect desired. The calculated ionization curve of a 5.8% w/v sodium peracetate concentration at 25° C. is provided in FIG. 1 as an example of this pH-dependent transition, left to right, from the as-made alkaline peracetate form to the acidified peracetic acid form.

The use conditions or process conditions in which the sodium peracetate formulation is used may dictate the extent of acidification in addition to the extent of conversion of peracetate to peracetic acid. The pH of the peracetic acid solution may be adjusted to match the pH of the substrate, article, material, or process fluid it is being added to, non-limiting examples include PH balance with tissue (meat, fish, livestock, people, plants), pH that minimizes corrosion, pH that matches a pulp pH, pH that matches a fermentation process pH, pH that enhances sanitization as in a sanitizing cleanser, pH that is acidic enough to maintain or modify a process pH.

The choice of acids include mineral acids and organic acids which are a source of hydrogen ions and have an acidity constant (pKa) less than about one order of magnitude greater than that of peracetic acid (i.e., pKa less than 9.2). Examples of mineral acids include sulfuric acid, hydrochloric acid, nitric acid, hydrofluoric acid, sulfamic acid and phosphoric acid, sodium bisulfate, and ammonium bisulfate. Examples of organic acids include formic acid, acetic acid, citric acid, malic acid and lactic acid. Some phenolic materials in lignin or byproducts of delignification may also contribute acid protons with acid groups having pKa values less than 10. Hydrobromic and hydroiodic acids can be oxidized to forms of bromine and iodine by the peracid, which could be useful, but these ions are reactive and change the oxidant species composition.

In an embodiment, the as-made sodium peracetate formulation may be acidified shortly after production by combining an amount of acid (acidulant) to the sodium peracetate solution in proportion to the amount of peracetate and excess alkali to reduce the solution pH to a predetermined pH level (e.g., pH 2 to pH 8) prior to use.

In an embodiment, the as-made sodium peracetate solution may be diluted with water to a lower concentration, such as a lower use concentration, and the diluted solution acidified by combining an amount of acid (acidulant) to the diluted sodium peracetate solution in proportion to the amount of peracetate and excess alkali to reduce the solution pH to a predetermined pH level (e.g., pH 2 to pH 8) prior to use.

In an embodiment, the as-made sodium peracetate solution may be combined with a dilution fluid comprising water and an acid (acidulant) to dilute the as-made sodium peracetate concentration to a lower use concentration in a solution with a predetermined pH level (e.g., pH 2 to pH 8) prior to use.

A product differentiator is a peracetic acid (PAA) product that is pH 4 or greater, especially a near-neutral pH PAA product. Equilibrium PAA and distilled PAA are very acidic having a pH range of about 1 to about 3, typically having a pH range of less than 2. What enables a near-neutral pH product from a practical standpoint are the absence of hydrogen peroxide (avoiding decomposition losses during and after pH adjustment) and the ability to produce it as needed without storage. No conventional PAA product solution can be stored for more than several hours in this higher pH range (due to the requirement of the composition to be a non-equilibrium PAA composition in this pH range) without refrigeration, and no more than several days with refrigeration.

In pulp and paper fiber treatment processes the as-made alkaline sodium peracetate product (PM3) is preferred in some uses while acidification of the peracetate to a substantially peracetic acid form (aPM3) is preferred in other uses. The choice between PM3 and aPM3 is then based on the technical performance provided and/or the use or process conditions the oxidant is being used in.

In some embodiments, the PM3 form is preferred when a nucleophilic oxidant (peracetate anion) is combined with an oxidant with electrophilic character (singlet oxygen) and are the dominant species to react with lignin and hemicellulose structures to cause fragmentation for extraction from cellulosic fibers and oxidize and bleach color centers or color-forming compounds. This PM3 product solution is fed to pulp stock that is near neutral or at elevated pH (for example, pulp stock at pH 5 to pH 12 or pulp stock to be processed at pH 5 to pH 12).

In another embodiment, aPM3 form is preferred when an electrophilic oxidant (peracetic acid) combined with hydroxyl radicals and acetoxy radicals formed at elevated process temperatures are the dominant species to react with chemical structures less responsive to PM3 or to use an acidic oxidant that avoids adding alkaline chemicals to a pulp that is sensitive to darkening by alkaline chemicals (e.g., sodium hydroxide, sodium peracetate). The aPM3 product solution is fed to pulp stock that is near neutral to acidic pH (for example, pulp stock at pH 6 to pH 2 or pulp stock to be processed at pH 6 to pH 2).

The preferred acids to acidify the sodium peracetate solution include mineral acids which are a source of hydrogen ions and have an acidity constant (pKa) less than that of peracetic acid (i.e., pKa less than 8.2). Examples of mineral acids include sulfuric acid, hydrochloric acid, nitric acid, hydrofluoric acid, sulfamic acid, phosphoric acid, sodium bisulfate, and ammonium bisulfate. Sulfuric acid is one of the most common mineral acids used in pulp and paper mills for its low cost, low volatility and compatibility with recovery systems in the kraft pulping process. Mineral acids do not add organic carbon as BOD to bleach plant effluents. In contrast using an organic acid such as acetic acid adds BOD to bleach plant effluents and is a volatile organic carbon substance.

In some embodiments delignification and pre-treatment of fiber occurs before a bleach sequence.

In some embodiments, the peracetate oxidant technology is used before a pulping process (mechanical, chemical or enzymatic pulping) and may be used up stream or downstream of additional delignification stages such as oxygen delignification or enzymatic delignification. The potential benefit of using the peracetate oxidant chemistry before any of these earlier processing stages is to directly remove lignin or to fragment lignin making it more receptive to subsequent treatment stages that ultimately remove lignin from the fiber. The net technical effects of using the peracetate oxidant chemistry can provide more rapid delignification and brightening, higher throughput in the brightening stage or stages, and an overall reduction in bleaching chemical use.

In some embodiments, the peracetate oxidant formulation may be used for delignification and extraction of materials from pulp fibers during pulp and paper processing. It may also be used for extracting lignin from cellulosic fibers for the recovery of lignin from the black liquor or spent oxidant liquor.

In some embodiments, the reactive oxygen species generated by the peracetate formulation, particularly singlet oxygen, are the primary chemical species doing the delignification, brightening and bleaching of fibers.

In some embodiments, the peracetate anion in the peracetate formulation is the primary chemical species doing the delignification, brightening and bleaching of fibers.

In some embodiments, the combination of peracetate anion and the ROS generated by the peracetate formulation, particularly singlet oxygen, are the chemical species doing the delignification, brightening and bleaching of fibers.

There is an ongoing drive by pulp and paper companies to reduce bleaching chemical costs and improve bleaching performance while avoiding significant increases to bleach plant effluent treatment cost for chemical oxidant demand (COD) biological oxygen demand (BOD). An approach to achieving these objectives is to treat the brownstock pulp upstream of the bleach plant with the singlet oxygen-producing sodium peracetate chemistry of this invention after kraft cooking, sulfite cooking and oxygen delignification stages conducted in the pulp mill prior to the bleach plant. Treatment of brownstock pulp with a modest amount of the singlet oxygen-producing sodium peracetate chemistry of this invention helps to fragment lignin in the brownstock pulp entering the bleach plant such that it reduces the amount of chlorine dioxide ClO₂) required to remove lignin while providing a brightness gain that carries through to the final pulp brightness, thereby further reducing the chlorine dioxide consumption.

The peracetate oxidant formulation also performs well at its natural pH without the use of additional alkali, which also reduces damage to cellulose fibers. Using the peracetate oxidant formulation to reduce or eliminate the amount of oxygen delignification and/or eliminate at least a portion of pulp bleaching with chlorine, chlorine dioxide or ozone can improve pulp yield, fiber strength, fiber quality and fiber product strength. The peracetate oxidant formulation provides the first known bulk source of singlet oxygen for pulp delignification and bleaching.

Singlet oxygen is well suited for oxidation of phenols, chlorinated phenols and similar electron-rich phenolic materials including lignin. Lignin generally consists of crosslinked polyphenolic materials created by enzyme-mediated polymerization of coniferyl, sinapyl and p-coumaryl alcohols. Singlet oxygen (which is not a radical) is relatively selective towards phenol oxidation and has little direct impact on cellulose fibers. In contrast, ozone and radicals including elemental chlorine, chlorine dioxide, hydroxyl radical, hydroperoxyl radical, superoxide and even triplet oxygen are more reactive towards cellulose in conventional delignification and bleaching processes.

In an embodiment, a method of using the peracetate oxidant formulation as a pre-treatment of pulp fiber before a bleach plant sequence where pulp is made more susceptible to delignification in the first stages of the bleach plant (e.g., DₒE, DₒEp, DₒEo, DₒEop) and the additional extracted lignin, as a result of peracetate pre-treatment, flows forward with pulp mill effluent from the bleach plant. The extraction stage, E, is an important stage to follow the peracetate stage with the benefit of reducing or eliminating ClO₂ use between the peracetate and extraction stages. However, in longer bleaching sequences the peracetate oxidant formulation make the D0 and extraction stages more efficient, reduce the amount of ClO2 used in D0, and provide a more permanent brightness gain after extraction (as opposed to a temporary brightness gain from excess hydrogen peroxide an extraction stage) which carries forward to the final bleaching stage thereby reducing or eliminating the ClO2 use in a final chlorine dioxide stage.

In an embodiment, a method of using the peracetate oxidant formulation in bleaching sequences. For example, a conventional three stage or four-stage bleaching sequence may use the sequential pulp treatment stages of chlorine dioxide (D0), oxidative extraction with pressurized oxygen and alkaline hydrogen peroxide (EOP) or extraction with alkaline hydrogen peroxide (Ep), chlorine dioxide (D1), and optionally chlorine dioxide (D2). This bleaching sequence may be abbreviated as D(E_)D and D(EOP)DD. Hydrogen peroxide is used in the sequence to reduce chlorine dioxide use and increase the bleachability of the pulp in a subsequent D stage. The Ep stage is sometimes described as “reactivating” residual lignin and oxidizable materials. The chlorine dioxide by products need to be stripped off and/or extracted for the pulp to be receptive to further chlorine dioxide treatment.

In some embodiments, the peracetate oxidant solution may be used within the bleaching sequence as a replacement for the EOP stage. The peracetate oxidant is more effective than hydrogen peroxide for removing or extracting residual lignin and is more selective oxidant than alkaline hydrogen peroxide. The greater performance of the peracetate solution may eliminate at least one chlorine dioxide stage, such as eliminating D2 or eliminating D1 and D2. This approach reduces the number of stages needed in a bleach plant, reduces the amount of AOX produced, reduces the amount of chlorinated waste water for disposal and reduces the amount of bleaching chemicals needed. Eliminating at least one chlorine dioxide stage may increase fiber strength and pulp yield. Using the peracetate oxidant as a more selective oxidant for the EOP stage may increase fiber strength and pulp yield.

In an embodiment, pulp brightening treatment is conducted after the final chemical treatment stage in a bleach plant, preferably after a final washing stage, as the pulp is transferred to a storage tank such as a high density storage chest. This treatment is also referred to as “post-bleach brightening” and is conducted to increase the final brightness of a bleached pulp and inhibit color reversion. The peracetate oxidant formulation (as-made or acidified during use, depending on the pH and receptivity of the pulp being treated) oxidizes color centers or color-forming compounds remaining after lignin removal is nearly complete in bleached pulp.

In an embodiment, the pH of the peracetate oxidant formulation may be reduced to a lower pH prior to use for brightening a pulp to avoid alkaline darkening reactions of a bleached pulp during treatment. The pH may be reduced by the use of an acid including inorganic acids (mineral acids) and organic acids.

In some embodiments, conducting fiber brightening with the peracetate oxidant formulation after a sulfide digester pulping stage will rapidly oxidize sulfide carryover and eliminate odors created by the digester process. For example, fiber brightening may be completed within a working time of about 1 to about 120 minutes, about 60 to about 120 minutes, about 30 to about 60 minutes, about 10 to about 30 minutes, about 1 to 5 minutes and preferably about 10 to 45 minutes of contact time with the peracetate oxidant formulation at an appropriate temperature and pH range.

In another embodiment, conducting fiber treatment with the peracetate oxidant formulation after an oxygen delignification stage will remove lignin and non-lignin materials not removed by the oxygen delignification stage and eliminate odors created by the oxygen oxidation process while minimizing the amount of organic carbon that could potentially consume oxygen as COD.

In another embodiment, conducting fiber treatment with the peracetate oxidant formulation before an oxygen delignification stage will remove lignin and non-lignin materials not removed by the oxygen delignification stage and may enhance the performance and efficiency of an oxygen delignification stage while minimizing the amount of organic carbon that could potentially consume oxygen as COD.

In another embodiment, conducting fiber treatment with the peracetate oxidant formulation during an oxygen delignification stage will remove lignin and non-lignin materials not removed by the oxygen delignification stage and may enhance the performance and efficiency of an oxygen delignification stage. Use of peracetate oxidant during the delignification stage involves elevated pressures (6-8 bar), elevated temperatures (80° C. to about 120° C.) and retention times of 30-60 minutes.

Abbreviations used in the sequences below are as follows: chlorine dioxide (D), extraction with alkaline hydrogen peroxide (Ep), hydrogen peroxide (P) and alkaline sodium peracetate product (PM3).

### PM3 D Ep D

### PM3 D Ep D PM3

### PM3 D Ep D D

### PM3 D Ep D D PM3

### PM3 D Ep PM3 D

### PM3 D Ep PM3 D PM3

### PM3 PP

### PM3 P P PM3

PM3 Ep PM3 P PM3 (This sequence, with optional use of aPM3 in the second and/or third PM3 stages are specific examples of TCF bleach sequences for kraft or sulfite pulp known as “chemical pulps”).

The PM3 in any sequence could alternatively be aPM3 if a fiber's response to aPM3 is preferred. It can be beneficial, in general, to alternate between nucleophilic and electrophilic oxidants in a bleach sequence.

Ep can alternatively be another extraction chemistry step such as E, Eo or Eop.

Referring to the last three sequences above: A chelation step, Q, before Ep, after the first PM3 stage may be used to prevent fiber strength loss. Chelation may also be used with the P stage. Chelation or binding of transition metals (e.g., iron, manganese, copper) is often used when hydrogen peroxide is used in an extraction stage, Ep, or in a hydrogen peroxide stage, P, to prevent damage of the cellulose structures resulting in loss of fiber strength. Chelation is especially important when a pulp has not been previously processed at acidic pH (e.g., acid stage or acidic chlorine dioxide stage) to extract transition metals. Materials commonly used for chelation or binding of transition metals include ethylenediaminetetraacetic acid (EDTA), diethylenetriamine pentaacetic acid (DTPA), sodium silicate and magnesium hydroxide. Chelation was previously found to be unnecessary when using the peracetate chemistry in the absence of an earlier acidic pH process stage.

Ozone (Z) can be used in a bleach sequence incorporating the use of PM and aPM in the following examples:

### Z Ep PM3 P

### Z Ep PM3 P PM3

### PM3 Ep Z Ep D P

### PM3 Ep Z Ep D PM3

The PM3 in a sequence could alternatively be aPM3 if a fiber's response to aPM3 is preferred. Ep can alternatively be another extraction chemistry step such as E, Eo or Eop. Chelation may be used prior to or with the application of hydrogen peroxide in a stage in the absence of an earlier acidic pH process stage.

The above examples incorporating the use of PM3 and aPM3 forms can also be used in the processing of mechanical pulp, chemical thermo-mechanical pulp (CTMP), bleached chemical thermo-mechanical pulp (BCTMP), alkaline peroxide mechanical pulp (APMP) and non-wood pulp.

In an embodiment, a method of generating sodium peracetate solution and peracetic acid solution by a single apparatus that generates an alkaline peracetate solution in a first output stream with the properties of 12.4-12.9 and an acidified peracid stream in a second output stream with greater than about 80% of the peracetate of the first output stream in the peracetic acid form and preferably greater than about 90% of the peracetate in the peracetic acid form, and preferably greater than about 99% of the peracetate in the peracetic acid form.

In an embodiment, the alkaline peracetate solution may be acidified shortly after production by combining an amount of acid (acidulant) to the sodium peracetate solution in proportion to the amount of peracetate and excess alkali to reduce the solution pH to a predetermined pH in the range from pH 2 to pH 8 prior to use.

In an embodiment, a method of bleaching pulp with a nucleophilic oxidant (peracetate anion) combined with an oxidant with electrophilic character (singlet oxygen) as the dominant oxidant species in one stage of a bleach sequence and with an electrophilic oxidant (peracetic acid) combined with hydroxyl radicals and acetoxy radicals as the dominant oxidant species in a different stage of the bleach sequence.

In an embodiment, a method of providing peracetate solution or acidified peracetate solution in a fiber refining process to affect properties of the fiber where the pH is controlled in a range that promotes actions including fiber swelling, fiber softening, and fibrillation to improve the bonding ability of fibers to form strong and smooth paper sheet or to develop properties such as bulk, absorbency, porosity, or optical properties.

In some embodiments, methods to use the ROS-generating peracetate oxidant formulation more efficiently were developed to reduce operating costs of feedstocks so that it can directly compete with chlorine dioxide on a cost basis when considering reducing chlorine chemicals, reducing chlorine bleaching steps, reducing AOX formation and emissions, reducing bleaching effluent for treatment, and reducing capital costs relative conventional mill infrastructure. Additional financial benefits may be realized in lower corrosion-caused maintenance costs, higher pulp yields, greater fiber product strength and increased throughput of an existing pulp line.

In some embodiments, methods of using the ROS-generating peracetate oxidant formulation are influenced by the ROS generation behavior of the peracetate oxidant formulation. Thermal acceleration of the reaction(s) that produce ROS, especially singlet oxygen, from the “parent” peracetate formulation is particularly important to performance. Several process variables are important for pulp delignification, brightening and bleaching and these variables are incorporated into preferred methods for efficient use of the peracetate oxidant formulation.

In some embodiments, a method treating pulp further comprises a method of heating or maintaining the heat of the pulp in a range from about 38° C. to about 95° C., more preferably 65° C. to about 75° C. prior to or following contacting with a peracetate oxygen composition. Thermal activation that accelerates ROS production rate is useful for treating the pulp. Peracetate oxidant solution can be thermally activated to enhance its production of ROS and biocidal activity. Thermal activation is useful throughout the treatment process. For example, pulp bleaching is very slow at room temperature (takes more than 1 hour to achieve modest bleaching) but is very rapid at 70° C.

In some embodiments, a method of reducing the microbial load in a pulp slurry may include: providing a slurry containing a population of microbes and providing a peracid composition. The peracid composition may include a mixture of an alkali concentrate, a hydrogen peroxide and an acyl donor having a pH value ranging from about pH 12 to about pH 13.5. The peracid composition may include a first molar ratio of peracid anion to peracid acid ranging from about 10000:1 to 40000:1. The peracid composition may include a second molar ratio of peracetate to hydrogen peroxide of 16:1 or more. The method may include contacting the peracid composition with the slurry. In some embodiments, the method may include mixing, after the contacting of the improved peracid formulation and the slurry.

In some embodiments, a slurry for reducing the microbial load is selected from slurries of wood pulp and wood products, silica, starch, synthetic polymers, polysaccharide gels, biomass feedstocks for fermentation, recycled paper and textiles and materials processed as slurries.

In an embodiment, the rate of ROS generation by the peracetate formulation is directly proportional to the rate of peracetate concentration decline. In some embodiments, the rate of ROS generation is thermally activated to accelerate delignification.

The ROS, which are dominated by singlet oxygen generated by the peracetate formulation, are doing the majority of the delignification, brightening and bleaching reactions in pulp. Furthermore, an improved ROS generation rate and concentration is within the first 5-15 minutes of applying the peracetate solution for pulp delignification under these test conditions and initial peracetate oxidant concentration.

Fiber products, including fiber board, recycle fibers and molded fiber products, produced from pulps of various types used in food packaging and compostables are generally unbleached if chlorine and chlorine dioxide are excluded from the processing. Producing these products with brightened (e.g., 65 ISO brightness units or greater) or near-white grades of fiber without the use of traditional bleaching lines is desirable. In some embodiments, using the peracetate oxidant technology can readily provide a rapid brightening stage over a wide range of production capacity and can be implemented rapidly with minimal capital outlay and space requirements. For existing pulp and paper mills the peracetate oxidant technology is a relatively simple, safe and low-cost retrofit or drop-in replacement. The byproducts of the peracetate oxidant formulation do not contain chlorides and are compatible for being sent to the recovery boiler in a closed-cycle mill process.

Another benefit of using the peracetate oxidant formulation for delignification and brightening is odor control during fiber processing and eliminating odors in fiber products.

Another benefit of using the peracetate oxidant formulation for delignification and brightening is odor control during fiber processing and eliminating odors in fiber products.

In some embodiments, using peracetate oxidant formulation is significantly safer than chlorine and chlorine dioxide. Peracetate oxidant solutions are composed of sodium peracetate salt, which is a water soluble solid in its native form. Salts in general have significantly lower vapor pressures than liquids and gases at room temperature. A small fraction of the sodium peracetate can be present as peracetic acid, however, peracetic acid is consumed by reactions with sodium peracetate and does not reach significant concentrations in solution. Exposure to sodium peracetate solution is limited to inhalation of an aerosol or mist and exposure to liquid concentrates.

Referring now to an exemplary counter-flow delignification process designed to reduce consumption of the peracetate oxidant formulation. In general, an oxidant dose is added to a pulp stream at a primary addition point where the pulp and oxidant are contacted together and mixed. After a period of time the oxidant liquor containing residual active oxidant formulation is separated from the pulp and conveyed to a secondary addition point, upstream of the primary addition point where untreated pulp and oxidant liquor are contacted together and mixed. The initial oxidant demand of the untreated pulp is reduced by the time it reaches the primary oxidant addition point.

In a counter-flow delignification process a source pulp or brownstock is fed into the process in the forward-flow direction. The brownstock may be coming from an upstream chemical digester, enzymatic process, oxygen delignification stage or from a market pulp supply. The brownstock is heated to or maintained at a temperature of 65-75° C. entering the process. The brownstock passes through a dilution mixer and is then dewatered in a first wash stage to about 15% consistency. The separated black liquor is collected in a first black liquor tank.

Prior to exiting the first filter stage the pulp is showered with a black liquor stream containing a residual amount of oxidant, then passes through a pulp mixer or pulp fluffer and into a first fiber chest. The residence time in the fiber chest may be several minutes. The fiber is pumped from the first fiber chest into the second wash stage where it is dewatered to up to about a 15% consistency. The separated black liquor is collected in a second black liquor tank.

Prior to exiting the second filter stage the pulp is showered with a peracetate oxidant stream containing a residual amount of oxidant, then passes through a pulp mixer or pulp fluffer and into a second fiber chest. The residence time in the fiber chest may be several minutes. The fiber is pumped from the second fiber chest into the third wash stage where it is showered and washed with clean water and dewatered to up to about a 15% consistency. The separated black liquor wash is collected in a third black liquor tank. The delignified pulp is then conveyed to the next storage or processing stages in the particular mill or facility.

In some embodiments, oxidation chemistry may be used for treatment of pulp as well as microbial control of contaminated water, reducing biological growth, disinfecting and sanitizing. The oxidation chemistry used may have minimal impacts on pH and scaling potential of fluids. A relatively short-lived active oxidant may be a benefit for avoiding negative impacts on pulp quality, paper quality, fermentation feedstock quality, food product quality and for minimizing oxidant corrosivity and environmental impacts. Selectivity of the oxidation chemistry towards different materials is also desirable for efficiency of oxidant use, compatibility with a variety of materials and avoidance of unnecessary or undesirable side reactions. Oxidant solutions that generate a variety of reactive oxygen species (ROS) in their treatment environments may be good candidates for achieving some or all of these attributes.

ROS may be generated in-situ by several chemical methods including the Fenton catalytic cycle with hydrogen peroxide and iron catalysts (produces hydroxyl and superoxide radicals), combining ozone with hydrogen peroxide (produces ozonides and oxygen-based radicals), and combining hypochlorite with hydrogen peroxide (produces singlet oxygen). Other methods of generating ROS may include photochemical approaches, which are generally very dilute in ROS and are not practical for large volume treatment systems or for highly scaling fluids or fluids with high turbidity.

Some ROS (e.g., hydroxyl radical and ozonides) are too short lived and too reactive to be practical in highly contaminated or hydrocarbon environments. Salt and carbonate may rapidly quench the hydroxyl radical. Ozone and stronger oxidants, like hydroxyl radical, oxidize salts to form toxic chlorate and bromate byproducts. Chlorine-containing oxidant formulations are typically more corrosive than peroxides, are less efficient for H2S oxidation and rapidly chlorinate unsaturated hydrocarbons.

In some embodiments, a method provides for treating pulp and microbial control in water recycling loops, pulp and paper mills, cooling towers and water loops, feedstock processing systems, and non-potable water systems. The methods may include providing a preferred ROS-producing oxidant formulation, peracetate oxidant solution.

In some embodiments, one preferred ROS-producing oxidant formulation is a peracetate solution for use in pulp and paper processing. The peracetate solution may include generating an alkaline hydrogen peroxide solution from the combination of an alkali and a hydrogen peroxide concentrate, mixing the alkaline hydrogen peroxide solution with an acyl donor such that a peracetate solution concentrate is formed. In some embodiments, the peracetate solution may include peracetate anions and a peracid. In some embodiments, the peracetate solution may include a pH from about pH 12 to about pH 13.5. In some embodiments, the peracetate solution has a molar ratio of peracetate anions to peracid ranging from about 10000:1 to about 40000:1. ROS-generating peracetate oxidant solutions may contain no hydrogen peroxide, and are produced on site and on demand at alkaline pH. The peracetate oxidant solution produces multiple ROS by itself and when placed into contaminated environments. In some embodiments, the ROS most important in peracetate oxidant solutions include singlet oxygen, superoxide radical, hydroperoxyl radical, acetyloxy radical and potentially other radical fragments. When a combination of these ROS are generated together in peracetate oxidant solutions they produce an oxidative-reductive potential (ORP) response in water that may exceed 900 mV (vs standard hydrogen electrode) around pH 7. These solutions may be more convenient and effective to use than other approaches. The dominant ROS may be selectively reactive such that they are effective in a variety of environments.

In some embodiments, a method may include making a reactive species formulation. The method may include providing an alkaline hydrogen peroxide solution. The method may include contacting the alkaline hydrogen peroxide solution with an acyl donor. A peracid concentrate may be produced by the contacting of the alkaline hydrogen peroxide with the acyl donor. The peracid concentrate may have a molar ratio of hydrogen peroxide to acyl donor reactive groups ranging from about 1:1.20 to about 1:1:1.25. The method may include maintaining the peracid concentrate pH value in a range from about pH 12 to about pH 13.5.

In some embodiments, a method of reducing the microbial load in a slurry may include: providing a slurry containing a population of microbes and providing a peracid composition. The peracid composition may include a mixture of an alkali concentrate, a hydrogen peroxide and an acyl donor having a pH value ranging from about pH 10 to about pH 12. The peracid composition may include a first molar ratio of peracid anion to peracid acid ranging from about 60:1 to 6000:1. The peracid composition may include a second molar ratio of peracetate to hydrogen peroxide of 16:1 or more. The method may include contacting the peracid composition with the slurry. In some embodiments, the method may include mixing, after the contacting of the peracid composition and the slurry.

In some embodiments, a slurry for reducing the microbial load is selected from slurries of wood pulp and wood products, recycled paper and materials processed as slurries.

In some embodiments, the peracetate oxidant solution is shown to reduce toxic organic halide formation (e.g., chlorinated phenols, dioxins, haloacetic acids) during the bleaching of wood pulp and other fibers used in paper, packaging and molded fiber products including bamboo, bagasse, eucalyptus, wheat straw, rice, hemp and other plant-based sources. For example, bleaching softwood pulp with the peracetate oxidant produces about ten times less total organic halides (TOX) than chlorine dioxide and about 2.5 times less TOX than peracetic acid. Bleaching with the peracetate oxidant can reduce pollution from chemical bleaching of fibers and minimizes toxic byproduct content in chemically bleached paper and molded fiber products such as those used for food packaging and compostable products.

The ability to mitigate microbes that have developed resistance to biocides is a growing challenge in pulp and paper processing. Changing the biocide type periodically is one method used to mitigate microbes that have developed resistance to a particular biocide However, resistance to multiple forms of chlorine and bromine has created problems with virulent pathogens that are increasingly resistant to antibiotics.

The peracetate oxidant solution provides several different oxidant species in a single solution including the peracetate parent oxidant and several daughter products formed in-situ including singlet oxygen, hydroperoxyl radical, superoxide radical and combined forms that impart high oxidative-reductive potentials (ORP) that are desirable for and correlated with effective microbial control. The combination of multiple oxidant species along with a high ORP can help mitigate resistance of microbes to disinfectants.

In pulp and paper water treatment processes, the chlorine-free and bromine-free reactive oxygen species formulations may be used to provide treatment without formation of undesired chlorinated or brominated byproducts. In these water treatment processes, the chlorine-free and bromine-free active oxygen species formulations may be used to provide treatment in the absence of chlorine, chlorine dioxide and/or ozone. For applications of the formulations herein the formulation is contacted with a substrate or environment to be oxidized or treated. Any means of contacting may be employed, that is suitable for retention of the oxidation activity of the formulation and that is suitable for the environment and/or substrate. Formulations are liquid and may be employed in a concentrated form or a diluted form. Formulations may be diluted, if desired, before, during or after initial contact. The concentration of formulations in contact with an environment and/or substrate may be varied during contact.

A given application may employ separate contacting events which may be the same or different and which may employ the same formulation. A given application may employ contact with more than one formulation or precursor thereof. The environment and/or substrate may, for example, be contacted with an activated liquid formulation containing reactive oxygen species. Alternatively, the environment and/or substrate may be contacted with a liquid precursor formulation that will generate reactive oxygen species on activation and the formulation is activated as or after it comes into contact with the environment or substrate.

For example, the environment or substrate may itself provide for activation, such as providing acidity that affects ROS formation rates and changes in oxidant speciation, fragmentation behavior or reactivity caused by acid-base equilibria. One or more additional steps of activation to form additional reactive species may occur after the contact of the formulation or the precursor formulation with the environment and/or substrate. For example, redox active materials or charged materials including transition metal species, unsaturated organic materials, sulfides and suspended solids can interact with and react with the parent oxidant to initiate fragmentation of the parent peracetate oxidant leading to the formation of ROS. Thermal activation can also be used to increase the formation rate of ROS, increase the fragmentation rate of the peracetate and increase overall peracetate oxidant solution's antimicrobial activity, bleaching power and reactivity with impurities or substrates. Irradiation of peracetate-containing solutions with ultraviolet light may also be used to promote activation. Contact with the environment or substrate may be controlled by addition of a selected volume or concentration of formulation to the environment or in contact with the substrate. Alternatively, contact may occur by addition, including controlled addition of the substrate to the formulation.

Contact may be combined with stirring or other agitation, with scrubbing, scraping or other abrasive method if appropriate for the environment and/or substrate. Contact may be combined with removal precipitant or other solids present or formed in the environment or on contact with the substrate. The environment or substrate may be pre-treated prior to contact.

Microbial control in water is imperative to a wide variety of processing and manufacturing systems. Treatment of water for microbial control in water recycle loops associated with pulp and paper processing is critical for maintaining efficient processes, protecting equipment from biofouling and biocorrosion, preventing contamination of products, reducing downtime and protecting the health of people exposed to such processes and products. Furthermore, microbial control in water recycle loops also provides odor control by minimizing fermentation, hydrogen sulfide production and algal decomposition. Microbial control in pulp and paper mills serves to protect the integrity of pulp slurries, coating ingredients, whitewater loop, process equipment, and paper quality. Controlling sessile bacteria helps to prevent the accumulation of biofilm deposits which cause microbiologically influenced corrosion (i.e., biocorrosion). Slime deposits are often a combination of bacteria and fungi. Importantly, when biofilms and their detritus detach from surfaces in the wet end papermaking process, they can cause holes and other defects in finished paper products. Therefore, preventing biofilm growth helps to avoid such defects.

Another embodiment is the ability to combine the use of peracetate oxidant solution and chlorine bleach for improved antimicrobial treatment of water. When a highly impaired water is treated with peracetate oxidant solution the ORP can be increased to, for example, about 600-700 mV vs SHE, which is a reasonable level for microbial disinfection. Treating the same water with a comparable dose of bleach can increase the ORP to a similar mV range, which is also a reasonable level for disinfection. When the bleach treatment is added on top of the peracetate oxidant treatment the ORP can be increased to over 800 mV, which indicates that there is an additive oxidative effect that increases the oxidation potential of the water and the corresponding level of antimicrobial treatment. This additive behavior between oxidants is in contrast to the typical consumptive reaction between peroxide-based oxidants and chlorine bleach. For example, combining hydrogen peroxide treatment with chlorine bleach treatment results in the consumptive reaction between bleach and hydrogen peroxide and a net loss of oxidants.

In some embodiments, microbial control in water at slightly alkaline pH was compared between peracetate oxidant, chlorine bleach, peracetic acid and chlorine dioxide. Alkaline pH is encountered in a variety of applications where microbial control and sanitization is needed, including pulp and paper processing. Some oxidants are less effective at sanitizing at alkaline pH such as chlorine bleach (hypochlorite) at a pH above its pKa of 7.5. Peracetate oxidant and chlorine dioxide performed well as antimicrobial disinfectants at slightly alkaline pH compared to peracetic acid and chlorine bleach, which had the lowest performance.

Referring now to an exemplary paper mill processing system, typically chlorine bleach is used to control microbial growth in printing paper in stock preparation and white water recovery. Pulp stock or fiber furnish is pumped into the blend chest where chemical additives may be added, such as dyes. A blend of pulp types (hardwood and softwood) may be added and combined. Re-processed fiber and broke pumped from the broke chest are also combined in the blend chest. The thick stock made in the blend chest is transferred to the machine chest where the consistency is leveled during a short retention time. The thick stock is then transferred to the wire pit for dilution to the head box consistency. The diluted stock then passes through a cleaner bank to remove unwanted solids and then to a deaerator to separate entrained gas from the stock. After passing through a final screening the diluted stock is fed into the head box. From the head box the stock is fed to the former or wires for sheet forming. Suction boxes under the wire remove bulk water from the sheet and this water is sent to the white water chest. The sheet then passes through a series of heated drying rollers and pressing rollers to produce the finished paper sheet. The white water is sent through a cleaning device, such as a centrifuge, to separate and recover fibers before the water returns to the wire pit for stock dilution. Trimmings and loose fiber are collected from the former, pressing and drying stages and sent to the broke chest. The broke is processed into dispersed fiber and returned to the blend chest. Each stage in the paper mill, and every surface in that stage, is contaminated with microbes and requires periodic cleaning to maintain consistent paper quality. Two locations for chlorine bleach addition for microbial control in the white water and broke chests.

Compounds for microbial control in system can be injected at multiple points throughout the system. Exemplary, but by no means limiting injection points are at the white water chest and at the broke chest.

In one embodiment, peracetate oxidant solution is added to at least one of the injection points at injection. The peracetate oxidant solution could replace or be used in conjunction with chlorine bleach or other common bleaching compounds. Peracetate oxidant injection at the injections points results in improved efficiency of oxidant mixing, contact and water treatment.

In some embodiments, sodium peracetate oxidant solution is used to control microbial growth in a printing paper mill in stock preparation and white water recovery. White water entrains fiber, chemicals and microbes from the paper web. Microbes have an opportunity to propagate during extended residence time in the white water chest. Pulp sources entering the machine chest, such as boke and recovered fiber, will carry elevated microbial loads after their recovery form the paper machine process. Microbial concentrations can exceed 10⁶ to 10⁷ cells/mL, a level that reduces paper quality, accelerates biofilm growth and microbially influenced corrosion, increases paper defects and odor problems. These problems increase the frequency of down time for maintenance and increase paper reject.

Several points exist where the peracetate oxidant solution can be added to the paper mill process. Ideally the peracetate solution is added to a fluid (water and pulp) where there is a contact time of several minutes to allow for more effective microbial control in the presence of high solids and allowing for thermal activation of the peracetate in warm and hot water streams that are typical in a paper mill. The use of peracetate oxidant has virtually no impact on pH, thereby avoiding the use of a second chemical feed for pH balance as is necessary when using moderate concentrations of acidic oxidants like chlorine dioxide and peracetic acid in a closed or partially closed-loop system.

In some embodiments, the peracetate oxidant solution is shown to be efficient for the bleaching of Kraft pulp and its performance approaches that of chlorine dioxide. The preferred pH for bleaching with peracetate oxidant solution is about pH 8 to about pH 12 where the ROS content and activity is greatly enhanced at elevated temperatures. Pulp bleaching is very slow at room temperature (takes more than 1 hour to achieve modest bleaching) but is very rapid at 50° C. (30 minutes to achieve significant bleaching). For comparison, the most efficient pH for bleaching with peracetic acid is at pH 7 and lower, however it is not as efficient as peracetate oxidant overall and does not show thermal activation for the production of ROS. Using peracetate oxidant in pH neutral to alkaline bleaching conditions has very little impact on alkali consumption in the bleaching process. In contrast, pH neutral to alkaline bleaching with chlorine dioxide or peracetic acid consumes large quantities of alkali to neutralize the acidity in these oxidants as alkali is caustic soda.

In some embodiments, peracetate oxidant solutions have the ability to reduce corrosion in pulp and paper mills serving to protect the integrity of pulp slurries, coating ingredients, whitewater loop, broke processing system, process equipment, and paper quality. Controlling sessile bacteria helps to prevent the accumulation of biofilm deposits which cause microbiologically influenced corrosion (i.e., biocorrosion). Slime deposits are often a combination of bacteria and fungi. Importantly, when biofilms and their detritus detach from surfaces in the wet end papermaking process, they can cause holes and other defects in finished paper products. Therefore, preventing biofilm growth helps to avoid such defects.

In some embodiments, tests were conducted to evaluate the formation potential of halogenated organic oxidation byproducts with peracetate oxidant relative to other common oxidants (peracetic acid, chlorine bleach, chlorine dioxide) and a blank (no oxidant). Treatment of flowback water from bleaching of wood pulp were conducted. Water samples were tested for total organic halide (TOX) after water treatment and bleaching processes. There was no detectable TOX formation in the treated flowback water and significantly reduced TOX formation during pulp delignification and bleaching.

In food treatment processes the as-made alkaline sodium peracetate product (PM3) is preferred in some uses while acidification of the peracetate to a substantially peracetic acid form (aPM3) is preferred in other uses. The choice between PM3 and aPM3 is then based on the technical performance provided and/or the use or process conditions the oxidant is being used in.

In an embodiment, as-made alkaline sodium peracetate product (PM3) is directly applied to a water streams, poultry chill tanks, dairy tanks, fermentation process streams, cooling water process streams, brining tanks and various other environments in food processing or other processing contexts.

In an embodiment the as-made alkaline sodium peracetate product (PM3) is diluted to less than 8000 ppm (sodium peracetate), and often to less than 2600 ppm (sodium peracetate) for use in food processing including but not limited to cleaning, sanitizing hard surfaces, food sprayers, tanks, package washing, sterilizing filling, and food packaging systems, CIP and COP-applications, and pre and post-harvest applications.

In an embodiment the as-made alkaline sodium peracetate product is diluted to about 1 ppm to about 8000 ppm, preferably about 2 ppm to about 4500 ppm, preferably about 3 ppm to about 2600 ppm, preferably about 5 ppm to about 1100 ppm, more preferably about 10 ppm to about 300 ppm before being added to a food processing system. The diluted formulation can be used during but not limited to cleaning, sanitizing hard surfaces, food sprayers, tanks, package washing, CIP and COP applications, pre and post harvest applications. In some implementations, the as-made sodium peracetate product is diluted to a concentration range having an upper limit of about 8000 ppm, about 4600 ppm, about 2600 ppm, about 1300 ppm, about 1100 ppm, or about 300 ppm or even about 110 ppm and a lower limit of about 1 ppm, about 2 ppm, about 3 ppm, about 5 ppm, about 10 ppm or even about 40 ppm. Some additional example ranges for a diluted formulation include sodium peracetate of about 1 ppm to about 2600 ppm, about 3 ppm to about 1300 ppm, 5 ppm to about 1100 ppm, about 10 ppm to about 300 ppm and about 40 ppm to about 110 ppm before being added to a food processing system.

In an embodiment the as-made alkaline sodium peracetate product is diluted, for example into any of the concentration ranges identified in the prior paragraph, prior to acidification. For example, in some implementations the as-made alkaline sodium peracetate product is diluted to about 1 ppm to about 8000 ppm, preferably 2 ppm to about 4500 ppm, preferably about 3 ppm to about 2600 ppm, preferably about 5 ppm to about 1100 ppm, preferably about 10 ppm to about 300 ppm prior to acidification. Following acidification, the diluted and acidified formulation can be used during but not limited to cleaning, sanitizing hard surfaces, food sprayers, tanks, package washing, CIP and COP applications, pre and post harvest applications.

In an embodiment the diluted sodium acetate formulation is used in a food sprayer line wherein the food sprayer is used in a variety of applications including for example applying coatings, flavorings, antimicrobial agents, cleaning agents, and spray drying.

In an embodiment, the alkaline peracetate solution may be acidified shortly after production by combining an amount of acid (acidulant) to the sodium peracetate solution in proportion to the amount of peracetate and excess alkali to reduce the solution pH to a predetermined pH in the range from pH 2 to pH 8 prior to use.

In an embodiment, the acidified sodium acetate solution at a near neutral pH is directly applied to hard surfaces, food line spraying, tanks, CIP and COP indications, and pre and post harvest applications.

Measurement and monitoring of pH is essential during food processing as it results in consistent well defined food products, avoids consumer health issues and meets regulatory standards. pH can affect look, taste, smell and quality of food as well as shelf life. The general pH range is from about 1.5 to about 10, with a pH of about 3 to about pH 7 for a majority of foods and uses. A pH of about 0 to about pH 4.6 is considered very acidic. Foods at pH 4.6 and below are generally considered high-acid foods and foods at pH above pH 4.6 are generally considered low-acid foods. Measurement of pH for food and during processing is very important for proper handling. pH measurements of liquid food samples which are mostly homogenous can be measured directly. Semi-solid and solid food samples or intermediates are blended into a uniform paste and diluted as required for pH measurements.

Microorganisms require a specific pH range for growth. The minimum, optimum, and maximum pH required for microbial growth varies depending on the microorganism. Very low or very high pH values will prevent microbial growth during food processing. However, very few foods naturally have pH values low enough to completely inhibit the growth of microorganisms, especially yeasts and molds which can tolerate lower pH ranges than most bacteria.

Food processing methods are directed to control microbial growth or inactivate microorganisms in food products during processing to lower risk of foodborne pathogens or spoilage microorganisms. This control extends to equipment and surfaces throughout the processing facility. Microorganisms including yeast, mold and bacteria are very sensitive to pH during food processing, very low or high pH values can prevent microbial growth. However, additional treatments are usually necessary to maintain microbial control such as heat processing, pH control, acidification, and preservation.

In poultry processing, the improved peracetate product can be used in various steps/stages throughout the processing.

In poultry processing, temperature reduction is really the only non-chemical method to decrease bacterial growth, specifically pathogen but also spoilage bacteria, during processing. This temperature reduction is usually performed in a series of chilling tanks.

In poultry processing federal regulations mandates that a broiler carcass is washed and is chilled to less than 4° C. within 4 hours of slaughter. This process is the first step in the cold chain for poultry meat processing and is a very important for quality meat and food safety. If not properly managed the chiller tanks can become a source of cross contamination. Water quality is very important during this stage of processing, traditionally the pH of the water in these tanks is kept at 7 or above when using peracetic acid as an antimicrobial. Currently peracetic acid is the most common antimicrobial used however, chlorine, bromine, chlorine dioxide, cetylpyridinium chloride, organic acids, trisodium phosphate are also approved for use.

In an embodiment the as-made alkaline sodium peracetate product is diluted to about 1 ppm to about 2600 ppm, about 3 ppm to about 1300 ppm, about 5 ppm to about 1100 ppm, about 10 ppm to about 300 ppm, or even about 40 ppm to about 110 ppm, prior to addition to a chill tank.

In an embodiment, the improved peracetate product is added to a chill tank to maintain a concentration of about 3 ppm to about 2600 ppm, or about 3 ppm to about 1300 ppm, and, preferably about 10 ppm to about 300 ppm, or even about 40 to 110 ppm, of improved product in a chill tank.

In an embodiment, the improved peracetate oxidant is added to water in a chill tank to wash and chill broiler carcasses reducing microbial load.

In an embodiment, the improved peracetate oxidant is added to water in a chill tank to prevent the growth of Salmonella and Campylobacter.

In an embodiment, the improved peracetate oxidant is added to water in a chill tank maintained at a pH of at least 6. The peracetate oxidant performs well at alkaline pH making it effective for antimicrobial activity.

In an embodiment, the improved peracetate oxidant is added to water in a chill tank to reduce or replace common antimicrobials.

In an embodiment, the improved peracetate oxidant product can be used in kosher food processing.

In an embodiment, the improved peracetate oxidant product can be used in various stages of egg, fruit, grain, vegetable, poultry, and meat processing.

In an embodiment, the improved peracetate oxidant product can be used in dairy processing for the production of whey and lactose.

In an embodiment, the improved peracetate oxidant product can be used for commercial sterilization of aseptic filling systems, glass and plastic/polymeric food packaging.

Disinfection by-products (DBPs) are formed when disinfectants like chlorine interact with natural organic materials in water. As water is used extensively in food processing, DBPs are produced frequently and exposure to DBPs are linked to health risks. There are several categories of DPBs in processing of fresh-cut fruits and vegetables where disinfectants, especially chlorine, can react with natural organic materials (NOM). For example, in potato flume wash water the following have been found: nitrogenous DPBs (N-DPBs, like chloramines and chlorinated nitrogen compounds), carbonaceous disinfection by products (C-DPBs, like chlorinated tannin, lignin-like phenolics, chlorophyll, carotenoids, etc.), haloacetic acids (HAAs), trihalomethanes (THMs).

In an embodiment, using an ROS-generating peracetate oxidant formulation during food processing reduces demand for chlorine chemicals, reducing halogenated disinfection byproducts formation and emissions, and reducing effluent for treatment.

In some embodiments, cleaning and sanitization performance of the ROS-generating peracetate oxidant formulation is high, even at pH 10 or less. Applying the peracetate oxidant in high doses in a single step process is effective, but this approach can be costlier. The capital cost for the peracetate oxidant technology is almost negligible compared to traditional processes including oxygen and chlorine dioxide sanitization.

In some embodiments, methods to use the ROS-generating peracetate oxidant formulation more efficiently were developed to reduce operating costs of feedstocks so that it can directly compete with chlorine dioxide on a cost basis when considering reducing chlorine chemicals, reducing halogenated disinfection byproducts formation and emissions, reducing effluent for treatment, and reducing capital costs relative conventional food facility infrastructure.

In an embodiment, the improved peracetate oxidant formulation is used either alone or in combination with traditional disinfectants in food processing to reduce disinfectant use thus reducing the amount of DPBs produced during processing.

In some embodiments, methods of using the ROS-generating peracetate oxidant formulation are influenced by the ROS generation behavior of the peracetate oxidant formulation. Thermal acceleration of the reaction(s) that produce ROS, especially singlet oxygen, from the “parent” peracetate formulation is particularly important to performance. Several process variables are important for substrate cleaning and sanitization, these variables are incorporated into preferred methods for efficient use of the peracetate oxidant formulation.

In some embodiments, the improved peracetate oxidant solution can be used over a wide range of temperatures for example from about 2° to about 95° C. depending on type of food processing.

In some embodiments, a method treating substrates further comprises a method of heating or maintaining the heat of the substrate in a range from about 38° C. to about 95° C., more preferably 60° C. to about 80° C. prior to or following contacting with a peracid composition. Thermal activation that accelerates ROS production rate is useful for treating the substrate. Peracetate oxidant solution can be thermally activated to enhance its production of ROS and biocidal activity. Thermal activation is useful throughout the treatment process.

Microbial control in water is imperative to a wide variety of processing and manufacturing systems. These systems can include food processing systems. Treatment of water for microbial control in food processing loops is critical for maintaining efficient processes, protecting equipment from biofouling and biocorrosion, preventing contamination of products, reducing downtime and protecting the health of people exposed to such processes and products. Furthermore, microbial control in water recycle loops also provides odor control by minimizing fermentation, hydrogen sulfide production and algal decomposition.

Microbial control in food processing serves to control sessile bacteria helping to prevent the accumulation of biofilm deposits which cause microbiologically influenced corrosion (i.e., biocorrosion). Slime deposits are often a combination of bacteria and fungi.

Microbial control may also occur on surfaces serving to clean, sanitize and/or disinfect the surfaces of a processing or manufacturing system. Microbial control targets include aerobic and anaerobic bacteria (slime formers, acid producers, metal depositors, nitrobacteria, sulfate reducers, nitrate reducers), fungi, algae, molds, spores and yeast. Some bacteria are pathogenic, for example, Legionella pneumophila, which poses health risks. Some algae, such as cyanobacteria, produce algal toxins that pose potential health risks.

Compounds used for microbial control need to be effective and efficient at neutral and alkaline pH. They also need to be effective at elevated levels of suspended solids (including silt, food intermediates, oils,) and dissolved solids (including salt, scaling minerals, carbonate, dissolved metals, scale inhibitors and other additives that may be encountered in various processes).

Microbial control is generally achieved using chemical biocides. Oxidizing biocides (e.g., chlorine gas, chlorine bleach, iodine, hypobromous acid, chlorine dioxide, chloramines, bromamines, fluorine, peroxyacetic acid, hydrogen peroxide, ozone) are typically fast acting and relatively short lived compared to non-oxidizing biocides (e.g., glutaraldehyde, dodecylguanidine, bromohydroxyacetophenone, bronopol, hydantoins, isothiazolins, polyhexamethylene biguanide), which are slower acting, but leave long lasting active residuals that can persist for several weeks in the environment. Commonly used oxidizing biocides are effective in the treatment of water with relatively low levels of contaminants, however significant issues arise when higher concentrations of organic materials and salinity are present. Microbial resistance to chlorine and bromine-based oxidizing biocides is a growing issue in municipal and industrial water systems.

There are numerous tradeoffs in selecting a biocide for specific applications. Chlorine was first used in municipal water treatment in the U.S. in 1909 as a disinfectant. Since then chlorine and chlorine-based biocides have been the standard for large scale municipal and industrial disinfection. Oxidizing biocides based on free chlorine and bromine in water react readily with organic materials to form halogenated disinfection byproducts, which are persistent in the environment and often exhibit high toxicity. The antimicrobial activity of aqueous chlorine and bromine decreases rapidly above about pH 7 and pH 8, respectively. Chlorine dioxide is an effective biocide over a wider pH range and has a lower potential to form halogenated disinfection byproducts if generated properly. However, byproducts of chlorine dioxide include chlorite and chlorate, which are regulated in drinking water. Peroxyacetic acid (PAA), which is a stabilized mixture of PAA, hydrogen peroxide, acetic acid and water, is an effective biocide, but not as efficient as chlorine dioxide in that higher doses are necessary to achieve similar performance. PAA performance declines as pH becomes more alkaline and promotes non-beneficial decomposition reactions between PAA, hydrogen peroxide and metal contaminants. Hydrogen peroxide by itself has significantly lower antimicrobial efficacy than PAA and halogen-based biocides while microbes can rapidly develop tolerance to it in water recycle loops. PAA and hydrogen peroxide rapidly degrade in the environment and form significantly fewer disinfection byproducts than halogenated biocides. Oxidizing biocides can also directly oxidize odor-causing materials such as phenols, sulfides and mercaptans.

Corrosivity of oxidizing biocides is another issue, especially when the biocides come in contact with various process materials such as steel, copper and brass alloys. Oxidizing biocides used in processes where elevated temperatures and turbulence are present in the liquid phase should ideally have low vapor pressures to minimize vapor phase corrosion of surrounding equipment and structures. Biocide materials that are gases in their native form are the most volatile and present the greatest corrosion and occupational exposure hazards, including chlorine, chlorine dioxide and ozone.

Control of biocide dosing in a process stream by monitoring the oxidation potential of the treated water is an advantage for real-time process control. The oxidation-reduction potential (ORP) of a solution can be correlated with a level of biocidal control at a given pH and often with the concentration of active biocide present (and corresponding corrosivity). Various forms of chlorine, bromine, chlorine dioxide and sometimes ozone can provide a strong ORP response when used at low concentrations at neutral to moderately alkaline pH. For example, the ORP of chlorine bleach or chlorine dioxide at a 1-2 ppm concentration in relatively clean fresh water at pH 7 can exceed 700 mV vs standard hydrogen electrode (ORP greater than 650 mV typically provides effective bacteria control). In contrast, PAA, hydrogen peroxide and non-oxidizing biocides do not provide a meaningful ORP response above a dissolved oxygen background in fresh water, which is about 420-520 mV at pH 7.

There is a need for highly effective and fast acting oxidizing biocides that are safer to use, have lower environmental impacts and contribute to pollution prevention efforts. Water-based alkyl peroxide salt solutions that efficiently produce reactive oxygen species (ROS) are a class of highly active oxidants that provide multiple biocidal species, have low volatility, degrade to benign residuals, can be produced from stable feedstocks under mild conditions, and reduce or eliminate several harmful disinfection and oxidation byproducts.

In some embodiments, a method provides for microbial control by reducing the microbial load in contaminated water of water recycle loops in food facilities. The methods may include providing a peracetate oxidant solution. The peracetate solution may include peracetate anions and a peracid. In some embodiments, the peracetate solution may include a pH from about pH 12 to about pH 13.5, and in some other embodiments a pH of from about pH 10 to pH 12.

In some embodiments, the peracetate solution has a molar ratio of peracetate anions to peracid ranging from about 60:1 to about 6000:1. In some embodiments, the peracetate solution has a molar ratio of peracetate to hydrogen peroxide of greater than about 16:1. The peracetate solution may provide cleaning, sanitizing and/or disinfection of contaminated water and surfaces. The peracetate oxidant solution may provide enhanced separation of microbes from contaminated water. In some embodiments, the peracetate oxidant solution kills the microbial population in the contaminated water. In some embodiments, the microbes are removed from the contaminated water. In some embodiments, the peracetate solution reduces the biofilms and microbial corrosion.

In some embodiments, a method provides for microbial control and reduction of oxidation byproducts in food processing water treatment, using highly active peracetate oxidant solutions. For example, water reuse at a potato chip manufacturing facility was provided by achieving several treatment objectives including: microbial control and odor control with the fast acting oxidizing peracetate-singlet oxygen chemistry, clarification to reduce suspended solids, foaming potential and oxidant demand. This processing resulted in production of solids that are suitable for agricultural uses (e.g., land application, fertilizer, compost) or use in biogas generation. It also minimizes the use of volatile organic compounds in the process to reduce air emissions and worker exposure to irritating or harmful vapors. Water treatment was accomplished by a chemical-physical process incorporating the sodium peracetate-singlet oxygen oxidation chemistry as an odor control and microbial control agent. A standard coagulant and floc polymer were used to help clarify suspended materials from the water by gravity settling or air flotation.

In some embodiments, the amount of peracetate oxidant solution used is dependent on the severity of contamination, the degree of microbial control desired and residual oxidant solution necessary for effective microbial control.

In some embodiments, the contaminated substrate can be sequentially dosed with peracetate oxidant solution until the degree of microbial control desired is reached and the sequential dosing has a synergistic effect on microbial control. The reducing of the microbial load prevents bacteria in the contaminated water from becoming anaerobic and prevents the formation of sulfides, ammonia, volatile organic acids which result in reduced release of volatile materials and odor control.

In some embodiments, a method is provided for the ability to combine the use of peracetate oxidant solution and an alternative oxidant for improved antimicrobial treatment of water. In some embodiments, the alternative oxidant is selected from the group consisting of chlorine, hypochlorite (e.g., chlorine bleach), monochloramine, chlorine dioxide, bromine, hypobromite, monobromamine, iodine and fluorine. In some embodiments, a method is provided for the ability to combine the use of peracetate oxidant solution and an alternative non-oxidizing biocide for improved antimicrobial treatment of water. In some embodiments, the alternative non-oxidizing biocide is selected from the group consisting of glutaraldehyde, dodecylguanidine, quaternary ammonium compounds, quaternary phosphonium compounds, bromohydroxyacetophenone, bronopol, hydantoins, isothiazolins, polyhexamethylene biguanide.

In some embodiments, a method is provided for reducing the microbial load in contaminated water previously treated with an alternative oxidant by treating with a peracetate oxidant solution for improved microbial control of water.

In some embodiments, heating or thermal activation of peracetate oxidant solutions to a temperature between about 38° C. to about 95° C. accelerates the formation of ROS daughter products as shown by biocidal activity with increasing temperature. Thermal activation that accelerates ROS production rate is useful for microbial control in heated environments and hot chemical sanitizing processes.

In some embodiments, a method is provided for reducing the microbial load in a slurry comprising containing a population of microbes with a peracetate oxidant solution; and mixing said slurry with the peracetate oxidant solution.

In some embodiments, oxidation chemistry may be used for treatment of food processing as well as microbial control of contaminated water, reducing biological growth, disinfecting and sanitizing. The oxidation chemistry used may have minimal impacts on pH and scaling potential of fluids. A relatively short-lived active oxidant may be a benefit for avoiding negative impacts on food product quality and for minimizing oxidant corrosivity and environmental impacts. Selectivity of the oxidation chemistry towards different materials is also desirable for efficiency of oxidant use, compatibility with a variety of materials and avoidance of unnecessary or undesirable side reactions. Oxidant solutions that generate a variety of reactive oxygen species (ROS) in their treatment environments may be good candidates for achieving some or all of these attributes.

In an embodiment, the peracetate oxidant formulation is used during various stages of potato chip production. In general the processing of potatoes consists of peeling and washing the potatoes, slicing the potatoes to a uniform thickness (generally between 1.7-1.85 mm) and size (generally between 3-7 mm), cold water washing or blanching maybe used to remove starch in order to optimize taste, dehydrating to remove excess water, frying the chips at a temperature of about 160-180° C. for 2-3 minutes, degreasing the chips with a de-oiler to remove excess oil on the chip surface to maintain taste, seasoning of potato chips, cooling and sorting of chips and packaging. A peracetate oxidant solution can be used throughout the processing including but not limited to washing the potatoes, adding to waste water from blanching, dehydrating steps to clarify the water, as well as used to clean and sanitize equipment used throughout the process. Rejected potatoes and peelings are sent to be used for animal feed and starch that is removed in the rinsing process is sold for starch processing. The improved peracetate oxidant formulation can be used as-made, diluted and/or acidified depending on the requirements of the processing step.

In some embodiments use of the improved peracetate oxidant formulation improved potato chip processing and water reuse by achieving microbial control and odor control during processing, water clarification by reducing suspended solids, foaming potential and oxidant demand, and minimization of the use of volatile organic compounds reducing air emissions and worker exposure to harmful vapors.

In some embodiments use of the improved peracetate oxidant formulation reduces microbial load in waste water, food contact surfaces, and non contact surfaces and equipment used during the processing.

Water system equipment is serviced to remove bacterial growth, biofilm, slime buildup, mineral scale deposits, corrosion and contamination. These issues are common among, various industrial and food processing waters, water recycling loops, and non-potable water systems. Microbial control, removal of slime (the decaying remains of dead bacteria and other organic materials), microbial corrosion control and scale removal are significant maintenance issues for prolonging the production capacity and lifetime these systems. Pipelines, tanks and other equipment carrying raw water, wastewater, produced water, and other untreated water will encounter microbial growth and slime formation and will require cleaning.

In some embodiments, a method provides for microbial control in water recycling loops, food facilities, and non-potable water systems. The methods may include providing a preferred ROS-producing oxidant formulation, peracetate oxidant solution.

The peracetate oxidant solution provides several different oxidant species in a single solution including the peracetate parent oxidant and several daughter products formed in-situ including singlet oxygen, hydroperoxyl radical, superoxide radical and combined forms that impart high oxidative-reductive potentials (ORP) that are desirable for and correlated with effective microbial control. The combination of multiple oxidant species along with a high ORP can help mitigate resistance of microbes to disinfectants.

The presence of ROS or other reactive species in the formulations herein may in some cases be directly detected and it may be possible to determine the concentrations of certain reactive species (e.g., using spectroscopic methods). However, in some embodiment, in formulations herein the presence of reactive species may only be indirectly demonstrated by measurement of changing properties of the formulation (e.g., ORP measurements or pH change, by changes in concentration of precursors (e.g., rate of peroxyacetic acid concentration decline) or by changes in reactivity of the formulation or the rate or occurrence of oxidation of certain species (e.g., polysaccharide breakdown).

In some embodiments, the reactive oxygen species formulations may be used in various applications as oxidants and/or biocides. As described herein, different formulations, as assessed by ORP measurement and dye oxidation rate among other properties, may exhibit enhanced activity as a chemical oxidant or as a disinfectant, antimicrobial or biocide. In some embodiments, uses of the reactive oxygen species formulations are provided herein for various industrial or domestic oxidation, clean up and disinfection applications.

More specific applications include without limitation, water treatment and reuse; food process water cleaning and reuse, waste water treatment, raw water, ground water, and recycle and non-potable water systems.

In water treatment processes, the chlorine-free and bromine-free reactive oxygen species formulations may be used to provide treatment without formation of undesired chlorinated or brominated byproducts. In water treatment processes, the chlorine-free and bromine-free active oxygen species formulations may be used to provide treatment in the absence of chlorine, chlorine dioxide and/or ozone. For applications of the formulations herein the formulation is contacted with a substrate or environment to be oxidized or treated. Any means of contacting may be employed, that is suitable for retention of the oxidation activity of the formulation and that is suitable for the environment and/or substrate. Formulations are liquid and may be employed in a concentrated form or a diluted form. Formulations may be diluted, if desired, before, during or after initial contact. The concentration of formulations in contact with an environment and/or substrate may be varied during contact.

Microbial control targets include aerobic and anaerobic bacteria (slime formers, acid producers, metal depositors, nitrobacteria, sulfate reducers, nitrate reducers), fungi, algae, molds, and yeast. Some bacteria are pathogenic, for example, Legionella pneumophila, which poses health risks. Some algae, such as cyanobacteria, produce algal toxins that pose potential health hazards. Biocides used for microbial control need to be effective and efficient at neutral and alkaline pH. They also need to be effective at elevated levels of suspended solids and dissolved solids. Oxidizing biocides are a fast-acting line of defense and represent a significant expense in operations. Oxidizing biocides should be very active and have a limited lifetime with no reactive residuals so that they do not interfere with non-oxidizing biocide chemicals used to provide longer-term biostatic conditions.

Another embodiment is the ability to combine the use of peracetate oxidant solution and chlorine bleach for improved antimicrobial treatment of water. When a highly impaired water is treated with peracetate oxidant solution the ORP can be increased to, for example, about 600-700 mV vs SHE, which is a reasonable level for microbial disinfection. Treating the same water with a comparable dose of bleach can increase the ORP to a similar mV range, which is also a reasonable level for disinfection. When the bleach treatment is added on top of the peracetate oxidant treatment the ORP can be increased to over 800 mV, which indicates that there is an additive oxidative effect that increases the oxidation potential of the water and the corresponding level of antimicrobial treatment. This additive behavior between oxidants is in contrast to the typical consumptive reaction between peroxide-based oxidants and chlorine bleach. For example, combining hydrogen peroxide treatment with chlorine bleach treatment results in the consumptive reaction between bleach and hydrogen peroxide and a net loss of oxidants.

Similarly, combining peracetic acid treatment with chlorine bleach treatment results in reaction between bleach and the hydrogen peroxide contained in the peracetic acid solution (e.g., 15% peracetic acid solution can contain 10-25% hydrogen peroxide) resulting in a net loss of oxidants. In addition, the alkalinity of chlorine bleach (sodium hypochlorite in sodium hydroxide solution) can accelerate the consumptive reaction between peracetic acid and hydrogen peroxide when diluted into a water stream of neutral to slightly alkaline pH (peracetic acid is ionized by alkalinity and then reacts with hydrogen peroxide).

In some embodiments, microbial control in water at slightly alkaline pH was compared between peracetate oxidant, chlorine bleach, peracetic acid and chlorine dioxide. Alkaline pH is encountered in a variety of applications where microbial control and sanitization is needed, including water treatment and chill tanks in poultry processing, a type of food processing. Some oxidants are less effective at sanitizing at alkaline pH such as chlorine bleach (hypochlorite) at a pH above its pKa of 7.5. Peracetate oxidant and chlorine dioxide performed well as antimicrobial disinfectants at slightly alkaline pH compared to peracetic acid and chlorine bleach, which had the lowest performance.

In some embodiments, peracetate oxidant solution is used for cleaning and sanitization. The cleaning and sanitization of equipment used for food, beverage and dairy processing and the sanitization of packaging, bottles and containers for packaging of these products is critical for protecting consumers from illness, prevent spoilage, increase shelf life, and maintain clean equipment and facilities. Common methods of cleaning and sanitizing equipment surfaces is conducted by soaking, spraying, clean in place (CIP) and clean out of place (COP) processes. CIP processes involve the preparation of cleansers and sanitizer solutions in day tanks (often in 50-500 gallon volumes) and dispensing them into interior surfaces of pipes, filters, tanks and other processing equipment that is not disassembled for cleaning. CIP is an automated method of cleaning which is faster, less labor intensive, repeatable and has less risk of chemical exposure. Generally CIP cleans in several ways depending on the type of equipment used, for example in pipes CIP can deliver highly turbulent, high flow-rate solutions, wherein the turbulence will dislodge food intermediates and pathogens, on a substrate surface CIP can deliver low power spray to wet a surface in the case of a lightly soiled substrate and CIP can deliver a high power spray to highly soiled surfaces and substrates. Several factors affecting CIP include temperature of cleaning solution, concentration of the cleaning solution, contact time of the cleaning solution and turbulence of cleaning solution. COP is used when pieces of equipment and utensils cannot be cleaned where they are used and must be disassembled for cleaning non limiting examples include fittings, clamps, hoses, and impellers. The disassembled equipment is taken to a cleaning station where it is cleaned and sanitized as necessary before re assembly.

Chemical cleansers and sanitizers are used where hot water sanitization at high temperature (at least 77° C.) is not practical or damaging to equipment and where other contaminants (e.g., organic materials, mineral scale, stains) also need to be removed. Alkaline oxidizing cleanser solutions are particularly effective at removing protein soils, oils, fat deposits and killing microbes compared to alkali detergents alone. Acidic oxidizing cleansers are effective at removing mineral scale, milkstone, iron and killing microbes.

The heating of sanitizing solutions (e.g., hypochlorite, chlorine dioxide, iodine, peracetic acid) to modest temperatures (typically 40-60° C.) is a common practice to improve the effectiveness of a disinfectant. This is partly based on the principles that diffusion rates and chemical reaction rates increase with increasing temperature and that surface tension decreases thereby improving surface wetting and interaction with microbial deposits. The peracetate oxidant solution has the additional benefit over conventional oxidizing biocides of being thermally activated to produce multiple germicidal reactive oxygen species more rapidly, which significantly accelerates and increases the oxidant solution's sanitizing power. The peracetate oxidant performs well at alkaline pH making it effective for alkaline oxidizing cleanser solutions with strong germicidal activity.

Hypochlorite is problematic in heated sanitizing solutions due to its corrosivity to stainless steel, particularly aggressive pit corrosion. For example, the warranty of a stainless steel cleanser system or CIP system is voided if the chlorine concentration exceeds 80 mg/L at 40° C. The presence of chloride ion also enhances the corrosion of stainless steel at elevated temperatures. Chlorine is also volatile and off-gasses rapidly from warm cleanser solutions. Peracetate oxidant solution is compatible with stainless steel and has a very low corrosion rate on copper. It has low volatility allowing it to remain in solution at elevated temperatures for improved efficiency and eliminates exposure of personnel to chlorine or chlorine dioxide vapors. Peracetate oxidant has very low halogenated byproduct formation potential making it safer for cleaning and sanitizing food contact surfaces (no toxic halogenated residues) and preventing discharge of halogenated oxidation and disinfection byproducts. Because of these attributes peracetate oxidant can be safely used in higher concentrations than hypochlorite, chlorine dioxide and ozone for sanitization.

In some embodiments, a method of reducing the microbial load in a substrate may include: providing a substrate containing a population of microbes and providing a peracid composition. The peracid composition may include a mixture of an alkali concentrate, a hydrogen peroxide and an acyl donor having a pH value ranging from about pH 12 to about pH 13.5. The peracid composition may include a first molar ratio of peracid anion to peracid acid ranging from about 10000:1 to 40000:1. The peracid composition may include a second molar ratio of peracetate to hydrogen peroxide of 16:1 or more. The method may include contacting the peracid composition with the substrate. In some embodiments, the method may include mixing, after the contacting of the improved peracid formulation and the substrate.

In an embodiment, the rate of ROS generation by the peracetate formulation is directly proportional to the rate of peracetate concentration decline. In some embodiments, the rate of ROS generation is thermally activated to accelerate sanitization.

The ROS, which are dominated by singlet oxygen generated by the peracetate formulation, are doing the majority of the sanitization. Furthermore, an improved ROS generation rate and concentration is within the first 5-15 minutes of applying the peracetate solution for substrate sanitization under these test conditions and initial peracetate oxidant concentration.

In some embodiments, using peracetate oxidant formulation is significantly safer than chlorine and chlorine dioxide. Peracetate oxidant solutions are composed of sodium peracetate salt, which is a water soluble solid in its native form. Salts in general have significantly lower vapor pressures than liquids and gases at room temperature. A small fraction of the sodium peracetate can be present as peracetic acid, however, peracetic acid is consumed by reactions with sodium peracetate and does not reach significant concentrations in solution. Exposure to sodium peracetate solution is limited to inhalation of an aerosol or mist and exposure to liquid concentrates.

In some embodiments, oxidation chemistry may be used for microbial control of contaminated water, reducing biological growth, disinfecting and sanitizing. The oxidation chemistry used may have minimal impacts on pH and scaling potential of fluids. A relatively short-lived active oxidant may be a benefit for avoiding negative impacts on food product quality and for minimizing oxidant corrosivity and environmental impacts. Selectivity of the oxidation chemistry towards different materials is also desirable for efficiency of oxidant use, compatibility with a variety of materials and avoidance of unnecessary or undesirable side reactions. Oxidant solutions that generate a variety of reactive oxygen species (ROS) in their treatment environments may be good candidates for achieving some or all of these attributes.

In some embodiments, one preferred ROS-producing oxidant formulation is a peracetate solution. The peracetate solution may include generating an alkaline hydrogen peroxide solution from the combination of an alkali and a hydrogen peroxide concentrate, mixing the alkaline hydrogen peroxide solution with an acyl donor such that a peracetate solution concentrate is formed. In some embodiments, the peracetate solution may include peracetate anions and a peracid. In some embodiments, the peracetate solution may include a pH from about pH 12 to about pH 13.5. In some embodiments, the peracetate solution has a molar ratio of peracetate anions to peracid ranging from about 10000:1 to about 40000:1. ROS-generating peracetate oxidant solutions may contain no hydrogen peroxide, and are produced on site and on demand at alkaline pH. The peracetate oxidant solution produces multiple ROS by itself and when placed into contaminated environments. In some embodiments, the ROS most important in peracetate oxidant solutions include singlet oxygen, superoxide radical, hydroperoxyl radical, acetyloxy radical and potentially other radical fragments. When a combination of these ROS are generated together in peracetate oxidant solutions they produce an oxidative-reductive potential (ORP) response in water that may exceed 900 mV (vs standard hydrogen electrode) around pH 7. These solutions may be more convenient and effective to use than other approaches. The dominant ROS may be selectively reactive such that they are effective in a variety of environments.

In some embodiments, a method may include making a reactive species formulation. The method may include providing an alkaline hydrogen peroxide solution. The method may include contacting the alkaline hydrogen peroxide solution with an acyl donor. A peracid concentrate may be produced by the contacting of the alkaline hydrogen peroxide with the acyl donor. The peracid concentrate may have a molar ratio of hydrogen peroxide to acyl donor reactive groups ranging from about 1:1.20 to about 1:1:1.25. The method may include maintaining the peracid concentrate pH value in a range from about pH 12 to about pH 13.5.

In some embodiments, a method of reducing the microbial load in a substrate may include: providing a slurry containing a population of microbes and providing a peracid composition. The peracid composition may include a mixture of an alkali concentrate, a hydrogen peroxide and an acyl donor having a pH value ranging from about pH 10 to about pH 12. The peracid composition may include a first molar ratio of peracid anion to peracid acid ranging from about 60:1 to 6000:1. The peracid composition may include a second molar ratio of peracetate to hydrogen peroxide of 16:1 or more. The method may include contacting the peracid composition with the slurry. In some embodiments, the method may include mixing, after the contacting of the peracid composition and the slurry.

In some embodiments, the peracetate oxidant solution is shown to reduce disinfection byproducts (DBPs) during food processing.

The ability to mitigate microbes that have developed resistance to biocides is a growing challenge in food processing. Changing the biocide type periodically is one method used to mitigate microbes that have developed resistance to a particular biocide.

The peracetate oxidant solution provides several different oxidant species in a single solution including the peracetate parent oxidant and several daughter products formed in-situ including singlet oxygen, hydroperoxyl radical, superoxide radical and combined forms that impart high oxidative-reductive potentials (ORP) that are desirable for and correlated with effective microbial control. The combination of multiple oxidant species along with a high ORP can help mitigate resistance of microbes to disinfectants.

In food water treatment processes, the chlorine-free and bromine-free reactive oxygen species formulations may be used to provide treatment without formation of undesired chlorinated or brominated byproducts. In these water treatment processes, the chlorine-free and bromine-free active oxygen species formulations may be used to provide treatment in the absence of chlorine, chlorine dioxide and/or ozone. For applications of the formulations herein the formulation is contacted with a substrate or environment to be oxidized or treated. Any means of contacting may be employed, that is suitable for retention of the oxidation activity of the formulation and that is suitable for the environment and/or substrate. Formulations are liquid and may be employed in a concentrated form or a diluted form. Formulations may be diluted, if desired, before, during or after initial contact. The concentration of formulations in contact with an environment and/or substrate may be varied during contact.

A given application may employ separate contacting events which may be the same or different and which may employ the same formulation. A given application may employ contact with more than one formulation or precursor thereof. The environment and/or substrate may, for example, be contacted with an activated liquid formulation containing reactive oxygen species. Alternatively, the environment and/or substrate may be contacted with a liquid precursor formulation that will generate reactive oxygen species on activation and the formulation is activated as or after it comes into contact with the environment or substrate.

For example, the environment or substrate may itself provide for activation, such as providing acidity that affects ROS formation rates and changes in oxidant speciation, fragmentation behavior or reactivity caused by acid-base equilibria. One or more additional steps of activation to form additional reactive species may occur after the contact of the formulation or the precursor formulation with the environment and/or substrate. For example, redox active materials or charged materials including transition metal species, unsaturated organic materials, sulfides and suspended solids can interact with and react with the parent oxidant to initiate fragmentation of the parent peracetate oxidant leading to the formation of ROS. Thermal activation can also be used to increase the formation rate of ROS, increase the fragmentation rate of the peracetate and increase overall peracetate oxidant solution's antimicrobial activity, and reactivity with impurities or substrates.

Irradiation of peracetate-containing solutions with ultraviolet light may also be used to promote activation. Contact with the environment or substrate may be controlled by addition of a selected volume or concentration of formulation to the environment or in contact with the substrate. Alternatively, contact may occur by addition, including controlled addition of the substrate to the formulation.

Contact may be combined with stirring or other agitation, with scrubbing, scraping or other abrasive method if appropriate for the environment and/or substrate. Contact may be combined with removal precipitant or other solids present or formed in the environment or on contact with the substrate. The environment or substrate may be pre-treated prior to contact.

In some embodiments, transport and storage of peracetate oxidant formulations is avoided by its generation from stable feedstocks at or near the point of use. The small amount of peracetate present on site is produced in water at dilute concentrations (less than 8%) thereby avoiding hazards associated with highly concentrated or pure oxidant materials and minimizing fugitive air emissions and worker exposure to harmful materials, VOCs or nuisance odors. Potential fugitive air emissions from the peracetate oxidant solution production process are a small amount of water vapor and oxygen gas. The produced peracetate oxidant solution concentrate is dispensed by means of a pump, eductor or other engineered conveyance device that transfers the liquid product in a contained system to the point of use. The peracetate oxidant solution is produced as needed on site and on demand thereby eliminating storage and handling of large quantities of the oxidant product material on site.

In some embodiments, peracetate oxidant solutions have the ability to reduce corrosion in food facilities serving to protect the integrity of substrates, slurries, coating ingredients, and process equipment. Controlling sessile bacteria helps to prevent the accumulation of biofilm deposits which cause microbiologically influenced corrosion (i.e., biocorrosion). Slime deposits are often a combination of bacteria and fungi. Therefore, preventing biofilm growth helps to avoid such defects.

In some embodiments, peracetate oxidant solution is less corrosive than commonly used oxidizing biocides (chlorine, chlorine dioxide), especially when the biocides come in contact with various process materials such as steel, copper and brass alloys. Oxidizing biocides used in processes where elevated temperatures and turbulence are present in the liquid phase should ideally have low vapor pressures to minimize oxidant loss to evaporation and vapor phase corrosion of surrounding equipment and structures. It is important to consider corrosion rates of materials like metal alloys under various oxidant use conditions including shock treatments and bleaching at high concentrations, water treatment at lower concentrations and vapor corrosion in the head space above oxidant solutions.

In some embodiments, tests were conducted to evaluate the formation potential of halogenated organic oxidation byproducts with peracetate oxidant relative to other common oxidants (peracetic acid, chlorine bleach, chlorine dioxide) and a blank (no oxidant). Water samples were tested for total organic halide (TOX) after water treatment and cleaning processes. There was no detectable TOX formation in the treated flowback water and significantly reduced TOX formation during substrate sanitization.

### EXAMPLES

### Example 1: Peracetate-ROS Formulation Production Efficiency

A peracetate-ROS formulation of the present invention was made in 500 mL “batches” with high efficiency using a minimal excess of acetyl donor groups to hydrogen peroxide. The formulation was made with a target peracetate concentration of 4.5% wt/vol measured as peracetic acid and an assumed production efficiency of 94% relative to hydrogen peroxide.

To three separate 1 L glass beakers containing magnetic stir bars was added 376, 378, and 380 mL (beakers 1, 2 and 3, respectively) of distilled water. The liquid contents of each beaker were stirred at a high rate for vortex mixing while 42.2 mL of 25% NaOH solution was added to each beaker. To the mixing NaOH solution in each beaker was added 57.5 mL of 17.5% hydrogen peroxide. After 60 seconds of mixing an amount of triacetin was added providing 1.0, 1.08 and 1.2 molar equivalents of acetyl donor groups relative to hydrogen peroxide, which was 19.5 mL, 21.3 mL, and 23.7 mL triacetin added to beakers 1, 2 and 3, respectively. The reaction mixture was mixed for another 60 seconds at which time the reaction was considered complete and the product solution in each beaker immediately analyzed for peracetate concentration, pH, and hydrogen peroxide residual.

Peracetate concentration was measured as peracetic acid using a standard iodometric titration method. In this method a 0.50 ml sample of the concentrated peracetate solution was diluted into about 25 mL of distilled water. To this solution was added 1 mL of an ammonium molybdate reagent (HACH part no. 193332 containing 3-7% hexaammonium heptamolybdate) followed by addition of one packet of Sulfite 1 reagent (HACH part no 220399 containing potassium iodide and starch indicator). This solution was covered and mixed gently on a magnetic stir plate for 5 minutes. The mixture was titrated to a colorless endpoint with 0.100 N sodium thiosulfate solution and the volume of titrant measured to the nearest 0.05 mL.

Residual hydrogen peroxide in the concentrated peracetate solutions was measured by selectively forming the molybdate-hydrogen peroxide complex and measuring its concentration by UV-Vis absorption spectroscopy. The absorbance value measured at 330 nm was used to determine the hydrogen peroxide concentration relative to a calibration curve of absorbance vs concentration for a series of hydrogen peroxide standard solutions at 50, 100, 200, 300 and 400 mg/L hydrogen peroxide. The indicator molybdate solution was prepared by diluting 0.40 mL of ammonium molybdate reagent (HACH part no. 193332 containing 3-7% hexaammonium heptamolybdate) to 200 mL in distilled water. The indicator molybdate solution was calibrated by measuring the 330 nm absorbance for the series of hydrogen peroxide standard solutions. Test sample preparation was designed to fill a 3.5 to 4 mL volume cuvette with 1 cm pathlength for absorbance measurement in a standard UV-Vis spectrophotometer. To prepare a sample for measurement, a 0.200 mL volume of the concentrated peracetate solution, or hydrogen peroxide standard solution, was added to 2.80 mL of the prepared molybdate indicator solution. The absorbance spectrum was measured within 2 minutes of sample preparation. The spectrum of a blank sample (distilled water added to the molybdate indicator) was subtracted from the spectra of standard solutions and unknown samples prior to obtaining the background-corrected absorbance value. The unknown hydrogen peroxide concentration was calculated from the curve fit equation for the calibration standards and the measured absorbance value. The detection limit of this procedure is approximately 10 mg/L hydrogen peroxide in 45,000 mg/L peracetate.

Using 1.00 molar equivalents of acetyl donor groups to hydrogen peroxide in the above peracetate solution preparation procedure generated a peracetate product solution concentration measured at 4.56% wt/vol as peracetic acid, with less than 10 mg/L (below detection limit) hydrogen peroxide. The solution pH was 13.0, which was measured using a high sodium pH electrode (Oakton model no. WD-35805-05). The efficiency of peracetate production relative to the amount of hydrogen peroxide used was 95%.

Using 1.08 molar equivalents of acetyl donor groups to hydrogen peroxide in the above peracetate solution preparation procedure generated a peracetate product solution concentration measured at 4.56% wt/vol as peracetic acid, with less than 10 mg/L (below detection limit) hydrogen peroxide. The solution pH was 13.0, which was measured using a high sodium pH electrode. The efficiency of peracetate production relative to the amount of hydrogen peroxide used was 95%.

Using 1.20 molar equivalents of acetyl donor groups to hydrogen peroxide in the above peracetate solution preparation procedure generated a peracetate product solution concentration measured at 4.49% wt/vol as peracetic acid, with less than 10 mg/L (below detection limit) hydrogen peroxide. The solution pH was 12.9, which was measured using a high sodium pH electrode. The efficiency of peracetate production relative to the amount of hydrogen peroxide used was 94%.

Peracetate concentration (measured as peracetic acid) and pH results described above are presented in FIG. 1 (solid symbols) where they are compared to the trends observed in prior art where peracetate production efficiency (presented as peracetic acid concentration) decreased with decreasing molar excess of acetyl donor groups relative to hydrogen peroxide. Previous trends in FIG. 1 (open symbols) assumed a production efficiency of 93% relative to hydrogen peroxide. Below about 1.5 molar equivalents of acetyl donor groups to hydrogen peroxide the production efficiency fell to less than 90% and limited the peracetate concentration that could be produced. In the present invention there is a previously unknown discontinuity in the efficiency trend below the lower acetyl donor groups:hydrogen peroxide molar ratio limit (1.25:1) taught in prior art. There is also an unexpectedly abrupt increase in solution pH below the 1.25:1 acetyl donor groups:hydrogen peroxide molar ratio.

### Example 2: Microbial Reduction in Groundwater from Storage Ponds

Reduction of microbial load in two different groundwater sources held in an open-air storage ponds. Water quality analysis of the two groundwater sources is listed in Table 2. Water parameters were measured with Oakton brand pH, ORP and conductivity sensors calibrated with standard solutions. Total iron, hardness and sulfate were measured using HACH methods 10249, 8030 and 10248, respectively, with a DR900 colorimeter. Both water sources contained elevated pH, total dissolved solids, hardness as CaCO₃, and sulfate.

Analysis of total microbial activity was measured using the LuminUltra® ATP (adenosine triphosphate) analysis method according to the manufacturer's instructions. The prepared samples were analyzed for ATP concentration using a PhotonMaster luminometer calibrated with a LuminUltra ATP standard to convert relative luminosity units (RLU) to ATP concentration as pg/mL.

Serial dilution was used for identifying and enumerating general types of acid producing bacteria, APB, and sulfate reducing bacteria, SRB. Serial dilution culture vials (Biotechnology Solutions) contained 0.5% salinity phenol red dextrose culture broth or API-RP30 culture broth. Dilution of 1 mL water sample added to 9 mL of culture broth were made according to product instructions up to a 10⁻⁶ dilution. Fungus also grew in the phenyl red dextrose media, favoring the round yeast cell form, which provided an estimate of fungal concentration.

TABLE 2
Water quality parameters of the untreated water sources.

| Parameter | Water Source 1 | Water Source 2 |
|---|---|---|
| pH | 8.15 | 8.36 |
| ORP (mV vs SHE) | 372 | 364 |
| Conductivity (mS/cm) | 5.09 | 3.65 |
| TSS (mg/L) | 0 | 4 |
| Total Fe (mg/L) | 1.5 | 0.5 |
| Mg (mg/L as CaCO₃) | 1500 | 450 |
| Ca (mg/L CaCO₃) | 2850 | 2450 |
| Ba²⁺ (mg/L) | <1 | <1 |
| SO₄²⁻ (mg/L) | 1400 | 2400 |
| ATP (pg/mL) | 209 | 353 |
| APB (cfu/mL) | ≥10⁶ | 10⁴-10⁵ |
| SRB (cfu/mL) | 10³-10⁴ | 10³-10⁴ |
| Fungus (cfu/mL) | ≥10⁶ | 10⁴-10⁵ |

The first water source contained motile rod-shaped bacteria, spiral bacteria and filamentous bacteria morphologies as identified in microscope analysis of live samples. Fungus was present in fibril and round yeast cell forms. The second water source contained motile rod-shaped bacteria, filamentous and coccus bacteria as identified in microscope analysis of live samples. Fungus was present in fibril and round yeast cell forms. This water also contained filamentous green algae and motile single cell algae, which contributed turbidity (reported as total suspended solids, TSS) to the second water source.

Each water source was treated with the peracetate-ROS solution by adding 0.35 mL of a freshly prepared 2.0% peracetate solution to 500 mL of each water source at room temperature while mixing at 300 rpm for 2 minutes with an overhead mixer. At 60 minutes contact time the pH and ORP of the treated waters were measured and residual oxidant was quenched during microbial test sample preparation by removal (filtration for ATP) or dilution and consumption (culture media).

Test results are listed in Table 3. Following treatment, the pH of the water samples was stable. The increased ORP values suggests microbial control conditions were achieved in the samples. ATP measurements showed a rapid reduction of total microbial activity in the first 60 minutes and continued reduction over time for the treated waters stored at room temperature at 24 hours and 90 hours after treatment. Serial dilution culture vials showed the absence of culturable bacteria or fungus after the 60 minute contact time.

TABLE 3
Results of treatments with 14 mg/L peracetate treatment concentration
at 60 minutes contact time followed by 24 h and 90 h ATP tests
of the treated waters stored at room temperature.

| Parameter | Water Source 1 | Water Source 2 |
|---|---|---|
| pH | 8.36 | 8.42 |
| ORP (mV vs SHE) | 709 | 720 |
| 60 min ATP (pg/mL) | 8.54 | 10.1 |
| 60 min APB (cfu/mL) | non-detect | non-detect |
| 60 min SRB (cfu/mL) | non-detect | non-detect |
| 24 h ATP (pg/mL) | 1.52 | 1.74 |
| 90 h ATP (pg/mL) | 0.42 | 0.97 |

### Example 3: Sanitizing Solution, Example Point of Use Sanitizing Solutions Made with Acidulant

A microbial challenge solution was made with an environmental water sample that was fortified to increase its natural bacteria population to about 10⁷-108 cfu/mL. The challenge solution was made by filtering a 20 mL freshwater sample from a storage pond through a 5 micron filter to remove the majority of fungus. This was added to 980 mL of EPA AOAC hard water (US EPA SOP number MB-30-02) at 400 ppm hardness, which was fortified with 0.2 g dextrose, 0.2 g nutrient blend (5% total nitrogen, 4% phosphate, 6% potash) and adjusted to pH 7.5 with hydrochloric acid. The challenge solution was left to propagate at room temperature in aerobic conditions for 4 days before use.

The microbial challenge solution was examined by microscope analysis. Live samples showed a high density of motile bacteria, filamentous bacteria, and a very low density of fungus fibrils. Gram-stained microscope samples showed high populations of gram positive rod-shaped, round, spiral and filamentous bacteria types as well as a high density of gram negative rod-shaped bacteria. Terminal endospores were also observed.

The prepared microbial challenge solution was tested for microbial activity by adding 1 mL of challenge solution to 99 mL of AOAC hard water at pH 7.5 at room temperature and mixed briefly. Thirty seconds after mixing, culturable aerobic and heterotrophic bacteria were enumerated using dip slides with agar selective for aerobic bacteria growth (Sani-Check B, Biosan Laboratories) according to product instructions. Results, summarized in Table 4, showed a bacteria density of 106 cfu/mL.

A first point of use sanitizing solution containing 500 mg/L peracetate was prepared by adding 1.11 mL of a freshly prepared 4.5% peracetate solution, made by the method described in Example 1, to 97.89 mL of AOAC hard water and the mixture adjusted to pH 7.5 with hydrochloric acid. To the sanitizing solution was added 1.0 mL of the microbial challenge solution and this was briefly mixed. At 30 seconds contact time the peracetate was quenched with 1.3 mL of IN thiosulfate solution. The culturable bacteria survivors were measured using dip slide agar for aerobic and heterotrophic bacteria. Results, summarized in Table 4, showed culturable bacteria to be below the detection limit (less than or equal to 10 cfu/mL) demonstrating that about a 5-log reduction in culturable bacteria was achieved.

A second point of use sanitizing solution containing 500 mg/L peracetate was prepared by adding 1.11 mL of a freshly prepared 4.5% peracetate solution, made by the method described in Example 1, to 97.89 mL of AOAC hard water and the mixture adjusted to pH 7.5 with glacial acetic acid. To the sanitizing solution was added 1.0 mL of the microbial challenge solution and this was briefly mixed. At 30 seconds contact time the peracetate was quenched with 1.31 mL of 1.00 N thiosulfate solution. The culturable bacteria survivors were measured using dip slide agar for aerobic and heterotrophic bacteria. Results, summarized in Table 4, showed culturable bacteria to be below the detection limit (less than or equal to 10 cfu/mL) demonstrating that about a 5-log reduction in culturable bacteria was achieved.

TABLE 4
Sanitization test results in AOAC
hard water, 30 second contact time.

| | Control | Solution 1 | Solution 2 |
|---|---|---|---|
| Peracetate Conc. (mg/L) | 0 | 500 | 500 |
| Acidulant | Hydrochloric | Hydrochloric | Acetic |
| | acid | acid | acid |
| pH | 7.5 | 7.5 | 7.5 |
| Culturable bacteria | 10⁶ | ≤10 | ≤10 |
| (cfu/mL) | | | |

### Example 4: Formulation Testing of Near-Stoichiometric Formulation Method Targeting 4.5% Peracetate Solution

An extensive number of measurements and tests were conducted to examine the properties of a peracetate solution of mid-range concentration (4.5% w/v target concentration of peracetate) when produced by controlling the sodium hydroxide to acetyl donor groups molar ratio (NaOH:acetyl) and the hydrogen peroxide to acetyl donor molar ratio (HP:acetyl). The peracetate solution properties compared in this testing program include: the percent conversion of hydrogen peroxide to peracetate; the percent conversion of acyl donor to peracetate; concentration of peracetate in solution when first made (t=0), and at t=10 and t=30 minutes after that as an indication of short-term stability prior to use; the pH of the peracetate solution over time at t=0, t=10 and t=30 minutes; and the residual hydrogen peroxide concentration in the peracetate solution when first made. The stability index for the prepared nonequilibrium peracetate compositions (SI) was calculated at 10 and 30 minutes (SI₁₀ and SI₃₀). The weight ratio of total organic carbon to peracetate ratio was also calculated for the resulting peracetate compositions. The molar ratio range of NaOH:acetyl donor groups was varied between 0.80:1 (or simply 0.80 expressed as the quotient value of the ratio) to 1.30:1 and within each of those ranges, the molar ratio range of HP:acetyl donor groups was varied between 0.75:1 and 1.10:1, with some testing also done at ratios of 0.70:1 and 0.65:1. Results of this testing program is summarized in Tables 5-9, which are discussed below.

In the formulation tests, the NaOH:acetyl donor groups molar ratio (moles NaOH/moles acetyl donor groups) was varied over the range of 0.80, 0.90, 0.95, 1.00, 1.05, 1.10, 1.15, 1.20 and 1.30. For each of these ratios the HP:acetyl donor groups molar ratio was varied over the range of 0.75, 0.80, 0.85, 0.90, 0.95, 1.00, 1.05 and 1.10, and also for 0.65 and 0.70 for some NaOH:acetyl donor groups molar ratios. HP:acetyl

The formulations for analysis were made in 100 mL “batches” by the shake bottle method described below. The target concentration of 4.5% w/v peracetate (measured as peracetic acid) was made using 0.0630 moles of H₂O₂ feed, which is 6% higher than a theoretically required amount of hydrogen peroxide to prepare a targeted amount of peracetate (0.0592 moles) to make a 4.5% w/v peracetate solution, to anticipate and compensate for a typical amount of production efficiency loss, based on prior experience. Additional tests were conducted with target concentrations of 1% (0.0140 moles of feed H₂O₂), 2% (0.0280 moles of feed H₂O₂) and 8% (0.112 moles of feed H₂O₂) with the same 6% efficiency compensation above the target amount of peracetate and are discussed in Examples 5-7.

To achieve the target concentrations, the molar amount of acetyl donor groups was next adjusted relative to hydrogen peroxide to set the initial HP:acetyl donor groups molar ratio. Finally, the molar amount of sodium hydroxide was adjusted relative to acetyl donor groups to set the NaOH:acetyl donor groups molar ratio. By this procedure, the same amount of total peroxide was maintained to compare the efficiencies of converting hydrogen peroxide to peracetate. Thus, stoichiometric test conditions (molar ratio NaOH:acetyl donor groups, molar ratio of HP:acetyl donor groups and molar ratio of NaOH:HP each equal to 1.00), reagent feed was 0.0630 mole of hydrogen peroxide, 0.0210 mole of triacetin (providing 0.0630 moles of acetyl donor groups) and 0.0630 mole of NaOH. For non-stoichiometric test conditions, the feed amounts of acetyl donor groups and sodium hydroxide were adjusted to provide the desired molar ratios relative to hydrogen peroxide.

A 1:1 HP:acetyl donor groups molar ratio is the stoichiometric reaction ratio between these two reagents. Below the 1:1 HP:acetyl donor groups molar ratio hydrogen peroxide is the limiting reagent and above the 1:1 HP:acetyl donor groups molar ratio the acetyl donor groups is the is the limiting reagent. Similarly, at a 1:1 molar ratio of NaOH:acetyl donor groups and a 1:1 molar ratio of NaOH:HP, the sodium hydroxide is at a stoichiometric ratio with these reagents. However, the reaction rates between these three reagents in the presence of the peracetate being formed vary with their ratios and change over time as they are consumed making it not obvious how these chemical ratios control the properties of the peracetate solutions made and how an excess of one or more reagents will influence efficiency and solution properties after being made.

The shake bottle method for making a nominal 4.5% w/v solution concentration as peracetic acid having a 1:1 NaOH:acetyl donor groups molar ratio, a 1:1 HP:acetyl donor groups molar ratio and a 1:1 NaOH:HP molar ratio is as follows. Three 125 mL polyethylene bottles were labeled “A”, “B” and “C”. To bottle “A” 76.61 g of deionized water was placed into the polyethylene bottle, 7.95 mL of 25.0% NaOH was added, the composition was mixed by shaking and allowed to stand for at least 1 minute. To bottle “B” 11.51 mL of 17.5% w/w H₂O₂ was added. To bottle “C” 3.95 mL (4.58 g) of triacetin was added. The amounts of compounds added to each bottle assume 94% conversion of H₂O₂ to peracetic acid such that 4.787% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

Peracetate concentration was measured as peracetic acid using a standard iodometric titration method. In this method a 0.50 to 1.00 ml sample of the concentrated peracetate solution was diluted into about 50 mL of distilled water. To this solution was added 1 mL of an ammonium molybdate reagent (HACH part no. 193332 containing 3-7% hexaammonium heptamolybdate in dilute sulfuric acid) followed by addition of one packet of Sulfite 1 reagent (HACH part no 220399 containing potassium iodide and starch indicator). This solution was covered and mixed gently on a magnetic stir plate for 5 minutes. The mixture was titrated to a colorless endpoint with 0.100 N sodium thiosulfate solution and the volume of titrant measured to the nearest 0.05 mL. The calculation used to determine the concentration of peracetic acid are as follows:

Peracetic acid % wt/vol=[(mL thiosulfate)×(Normality of thiosulfate)×3.80]/titrated volume of peracetate solution.

Residual hydrogen peroxide in the concentrated peracetate solutions was measured by selectively forming the molybdate-hydrogen peroxide complex and measuring its concentration by UV-Vis absorption spectroscopy. The absorbance value measured at 330 nm was used to determine the hydrogen peroxide concentration relative to a calibration curve of absorbance vs concentration for a series of hydrogen peroxide standard solutions. Standard solutions were made by serial dilution of a 2500 mg/L hydrogen peroxide solution in deionized water to 1250, 625, 312.5, and 156.25 mg/L and a deionized water blank. The indicator molybdate solution was prepared by diluting 1.0 mL of ammonium molybdate reagent (HACH part no. 193332 containing 3-7% hexaammonium heptamolybdate in dilute sulfuric acid) to 100 mL in distilled water. The indicator molybdate solution was calibrated by measuring the 330 nm absorbance for the series of hydrogen peroxide standard solutions. Test sample preparation was designed to fill a 3.5 to 4 mL volume cuvette with 1 cm pathlength for absorbance measurement in a standard UV-Vis spectrophotometer. To prepare a sample for measurement, a 0.200 mL volume of the concentrated peracetate solution, or hydrogen peroxide standard solution, was added to 2.80 mL of the prepared molybdate indicator solution. The absorbance spectrum was measured within 2 minutes of sample preparation. The spectrum of a blank sample (distilled water added to the molybdate indicator) was subtracted from the spectra of standard solutions and unknown samples prior to obtaining the background-corrected absorbance value. The unknown hydrogen peroxide concentration was calculated from the curve fit equation for the calibration standards and the measured absorbance value. The detection limit of this procedure is approximately 10 mg/L hydrogen peroxide in 45,000 mg/L peracetate.

The solution pH was measured using a high sodium pH electrode (Oakton model no. WD-35805-05).

In general, increasing NaOH:acetyl donor groups molar ratio from upward from 1:1 (up to 1.3:1) provided an increasing trend in the percent conversion of hydrogen peroxide to peracetate, an increasing peracetate solution pH when first made, and declining percent loss of peracetate concentration 10 minutes after being made. These trends are enhanced by reducing the HP:acetyl donor groups molar ratio from about 1:1 lower ratios with a small molar excess of acetyl donor groups. Combinations of these parameters provide a preferable peracetate solution pH of about pH 12.5 and greater. The residual hydrogen peroxide concentration in the peracetate solution when first made (t=0) decreased with increasing NaOH:acetyl donor groups ratio and decreasing HP:acetyl donor groups ratio. A preferred hydrogen peroxide residual level in the peracetate formulations is less than 1400 mg/L and more preferably less than 1000 mg/L. It is important to note that when scaling up these tests towards commercial scale these trends continue and the numbers stabilize, with performance increased at the larger scale.

For a HP:acetyl donor groups molar ratio of greater than 1:1 (up to 1.10:1 tested) the hydrogen peroxide concentration exceeded that of the acetyl donor groups resulting in reduced hydrogen peroxide conversion efficiency, a significant concentration of residual hydrogen peroxide, and significant loss of peracetate concentration 10 minutes after production (greater than 10%) when the peracetate solution pH was less than pH 12.5 when first made.

Based on these findings, a preferred method of producing a peracetate solution capable of efficiently producing singlet oxygen in this invention uses a molar ratio of sodium hydroxide to acetyl donor groups of 1:1 to 1.3:1 combined with a molar ratio of hydrogen peroxide to acetyl donor groups of 0.8:1 to 1:1 and more preferably from 0.85:1 to 1:1. The preferred peracetate solution pH range is 12.5 to 13.5 when first made, contains less than 0.15% hydrogen peroxide residual, and exhibits a loss of 5% or less of the initial peracetate concentration at ten minutes after being made as a 4.5% peracetate solution.

Considering more specifically the results summarized in Tables 5-9, in those tables column A includes a reference number for the test conditions, column B shows the molar ratio of sodium hydroxide (alkali) to acyl donor groups (acetyl donor reactive groups of triacetin) for the different test conditions, column C shows molar ratio of hydrogen peroxide to acyl donor groups for the different test conditions, column D shows molar ratio of sodium hydroxide to hydrogen peroxide for the different test conditions, column E shows the concentration in milligrams per liter of peracetate (measured is peracetic acid) in the nonequilibrium peracetate composition as sampled from the composition as initially prepared (identified as time zero, t=0), column F shows the concentration in milligrams per liter of dissolved hydrogen peroxide in the nonequilibrium peracetate composition sampled at time zero, column G shows the calculated molar ratio of peracetate to dissolved hydrogen peroxide in the nonequilibrium peracetate composition sampled at time zero, column H shows the pH of the nonequilibrium peracetate composition sampled at time zero, column I shows the concentration in milligrams per liter of peracetate (measured as peracetic acid) in the nonequilibrium peracetate composition as sampled 10 minutes following time zero (identified as t=10), column J shows the pH of the nonequilibrium peracetate composition as sampled 10 minutes following time zero, column K shows the concentration in milligrams per liter of peracetate (measured as peracetic acid) in the nonequilibrium peracetate composition as sampled 30 minutes following time zero (identified as t=30), column L shows the pH of the nonequilibrium peracetate composition as sampled 30 minutes following time zero, column M shows the 10-minute stability index (SI₁₀) calculated as the ratio of the peracetate concentration at t=10 to the peracetate concentration at t=0 (value in column I divided by the value in column E), column N shows the 30-minute stability index (SI₃₀) calculated as the ratio of the peracetate concentration at t=30 to the peracetate concentration at t=0 (value in column K divided by value in column E), column O shows the calculated yield of peracetate in the nonequilibrium peracetate solution at t=0 relative to the feed quantity of acyl donor groups used to prepare the nonequilibrium peracetate solution, column N shows the calculated yield of peracetate in the nonequilibrium peracetate solution at t=0 relative to the feed quantity of hydrogen peroxide used to prepare the nonequilibrium peracetate solution, and column Q shows the calculated weight ratio of total organic carbon to peracetate in the nonequilibrium peracetate solution at t=0. Tables 10-12 summarized the same information for results of Examples 5-7, discussed below. The 10-minute stability index and the 30-minute stability index were measured on samples taken and quickly analyzed for peracetate concentration (determined as peracetic acid) after sitting in a quiescent state (without mixing) at laboratory room temperature (about 22° C.) for the noted time following taking of a time zero sample.

The results summarized in Tables 5-9 are grouped by molar ratio of sodium hydroxide to acyl donor groups (acetyl donor groups in these examples). Key measures of performance illustrated in Tables 5-9 include dissolved hydrogen peroxide levels (column F), yield of peracetate relative to acyl donor groups and hydrogen peroxide feedstocks (columns P and Q), short-term stability of the peracetate solution with respect to peracetate concentration over 10 and 30 minutes following initial preparation (columns M and N), initial pH of the prepared peracetate solution (column H), changes in pH that occur over 10 and 30 minutes following initial preparation (columns J and L) and total organic carbon levels in prepared peracetate solutions relative to peracetate product in the solutions. As seen in Tables 5-9, results generally improve and the range of advantageous operating conditions among different molar ratios of hydrogen peroxide to acyl donor groups increases as the molar ratio of sodium hydroxide to acyl donor groups increases from 0.80 to 1.30, although there are indications of declining performance with the molar ratio of sodium hydroxide to acyl donor groups at a level of 1.3 for test conditions using lower molar ratios of hydrogen peroxide to acyl donor groups.

It is noted that for some tests, calculated yield of peracetate relative to hydrogen peroxide or acetyl donor groups somewhat exceed 100%, which indicates some inaccuracy in test performance or solution analysis, as the yield of greater than 100% is not possible.

For the test conditions with a molar ratio of sodium hydroxide to acyl donor groups of 0.80, results are generally the worst of all molar ratios of sodium hydroxide to acyl donor tested, with best performance in that group at a molar ratio of hydrogen peroxide to acyl donor groups of 0.80, and even then including relatively low yield of peracetate relative to acyl donor, relatively poor short-term stability at ten and 30 minutes, and a high ratio of total organic carbon to initially-prepared peracetate.

Results for test conditions with a molar ratio of sodium hydroxide to acyl donor groups of 0.90 are somewhat improved. Best performance appears to be for test conditions including a molar ratio hydrogen peroxide to acyl donor groups of 0.90, at which the yield of peracetate relative to acyl donor is improved and total organic carbon content is reduced, but with higher hydrogen peroxide concentration and lower short-term stability over 10 and 30 minutes.

Results for test conditions with the molar ratio of sodium hydroxide to acyl donor groups of 0.95 show further general improvement of results, with best performance appearing to be for the test conditions with a molar ratio of hydrogen peroxide to acyl donor groups of 0.85, showing some improvement in the short-term stability over 10 and 30 minutes and relatively low hydrogen peroxide concentration.

Results for test conditions with the molar ratio of sodium hydroxide to acyl donor groups of 1.00 show further general improvement,

Results and with a band of enhanced performance for test conditions with molar ratios of hydrogen peroxide to acyl donor groups at 0.87 to 0.95 for test conditions with the molar ratio of sodium hydroxide to acyl donor groups of 1.05 show further general improvement, with a band of enhanced performance for test conditions with molar ratios of hydrogen peroxide to acyl donor groups from 0.85 to 0.95.

Results for test conditions with the molar ratio of sodium hydroxide to acyl donor groups of 1.10 and 1.15 and 1.20 further show general improvement, with a band of enhanced performance for test conditions with molar ratios of hydrogen peroxide to acyl donor groups from 0.85 to 0.95

Results for test conditions with the molar ratio of sodium hydroxide to acyl donor groups of 1.20 also show generally improved results, and over relatively wide band of molar ratios of hydrogen peroxide to acyl donor groups from 0.85 to 1.00.

Results for test conditions with the molar ratio of sodium hydroxide to acyl donor groups of 1.30 also so generally show good results, and with some improved performance at test conditions with molar ratios of hydrogen peroxide to acyl donor groups at 1.05 and 1.10. It is noted however, that at the lower molar ratios of hydrogen peroxide to acyl donor groups of 0.80 and 0.75, results show reduced solution stability over 10 and 30 minute periods relative to similar ratios for test conditions including a molar ratio of sodium hydroxide acyl donor groups at 1.20. Those indications of reduced stability at those lower ratios of hydrogen peroxide acyl donor groups could possibly be attributable in part to reaction of excess acyl donor groups with sodium hydroxide through Reaction 5, noted above.

### Example 5: Determination of Near-Stoichiometric Formulation Method Targeting 1% Peracetate Solution

The production of a 1% w/v peracetate solution was targeted to demonstrate a lower production concentration in comparison to 4.5% w/v peracetate solution.

A number of measurements and tests were conducted to examine the properties of a peracetate solution (1.0% w/v target concentration) when produced by controlling the sodium hydroxide to acetyl donor groups molar ratio (NaOH:acetyl) and the hydrogen peroxide to acetyl donor groups molar ratio (HP:acetyl). The peracetate solution properties compared in this test matrix include: the percent conversion of hydrogen peroxide to peracetate; the percent conversion of acyl donor groups to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor groups was 0.80:1 to 1.3:1 and the molar ratio range of HP:acetyl donor groups was 0.65:1 to 1.10:1. At each of the NaOH:acetyl donor groups molar ratios the range of HP:acetyl donor groups ratios was produced and analyzed. This data is captured in table 10.

In the formulation tests, the NaOH:acetyl donor groups molar ratio (moles NaOH/moles acetyl donor groups) used was 1.10. For these tests the HP:acetyl donor groups molar ratio was varied over the range of 0.75, 0.80, 0.85, 0.90, 0.95, 1.00, 1.05 and 1.10. This represents a test matrix of 1×8 formulations for preparation and analysis. Two individual tests were also run at 1.2 and 1.3 NaOH:acetyl donor groups molar ratio to 0.9 HP:acetyl donor groups. The ratio of NaOH:H2O2 was determined by experimentally following the establishment of the NaOH:acetyl and the HP:acetyl donor groups molar ratios for all combinations in the test matrix.

The formulations for analysis were made in 100 mL “batches” by the shake bottle method described in Example 4 except where noted. The target concentration of 1.0% w/v peracetate (measured as peracetic acid) was made using 0.0140 moles of H2O2, which is 6% higher than the expected amount of peracetate (0.131 moles) to compensate for a typical amount of production efficiency loss.

The shake bottle method for making a nominal 1.0% w/v solution concentration as peracetic acid having a 1:1 NaOH:acetyl donor groups molar ratio, a 1:1 H2O2:acetyl donor groups molar ratio and a 1:1 NaOH:H2O2 molar ratio is as follows. Three 125 mL polyethylene bottles were labeled “A”, “B” and “C”. To bottle “A” 55.21 g of deionized water was placed into the polyethylene bottle, 1.76 mL of 25.0% NaOH was added, the composition was mixed by shaking and allowed to stand for at least 1 minute. To bottle “B” 2.55 mL of 17.5% w/w H₂O₂ was added. To bottle “C” 39.30 g of deionized water was placed into the polyethylene bottle, 0.875 mL (1.015 g) of a triacetin was added, and the composition was mixed by shaking for at least 1 minute. The amounts of compounds added to each bottle assume 94% conversion of H2O2 to peracetic acid such that 1.065% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

The residual hydrogen peroxide concentration was near the upper desirable limit and this decreased conversion of the hydrogen peroxide to peracetate.

As seen in the results summarized in Table 10, preparing nonequilibrium peracetate solutions targeted at a concentration of about 1% peracetate experienced low product yield, with best results at test conditions including a molar ratio of sodium hydroxide to acyl donor groups of 1.1 and a molar ratio of hydrogen peroxide to acyl donor groups of 0.75, providing significant molar excess of acyl donor groups relative to hydrogen peroxide and leading to a high level of total organic carbon in the resulting peracetate product. However, based on experience, it is anticipated that better results would be obtained when operating at larger scale due to better control over mixing and product preparation conditions than in the laboratory tests with the small, 100 mL test batches.

### Example 6: Determination of Near-Stoichiometric Formulation Targeting 2% Peracetate Solution

The production of a 2% w/v peracetate solution was targeted to demonstrate a lower practical production concentration that is enabled by the above formulation approach that produces a peracetate solution at pH 12.5 or greater with at least a 90% conversion of hydrogen peroxide to peracetate and less than 1000 mg/L hydrogen peroxide residual.

A number of measurements and tests were conducted to examine the properties of a peracetate solution (2.0% w/v target concentration) when produced by controlling the sodium hydroxide to acetyl donor groups molar ratio (NaOH:acetyl) and the hydrogen peroxide to acetyl donor groups molar ratio (HP:acetyl). The peracetate solution properties compared in this test matrix include: the percent conversion of hydrogen peroxide to peracetate; the percent conversion of acyl donor groups to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor groups was 0.80:1 to 1.3:1 and the molar ratio range of HP:acetyl donor groups was 0.65:1 to 1.10:1. At each of the NaOH:acetyl donor groups ratios the range of HP:acetyl donor groups ratios was produced and analyzed. This data is captured in Table 11.

In the formulation tests, the NaOH:acetyl donor groups molar ratio (moles NaOH/moles acetyl donor groups) used was 1.10. For these tests the HP:acetyl donor groups molar ratio was varied over the range of 0.75, 0.80, 0.85, 0.90, 0.95, 1.00, 1.05 and 1.10. This represents a test matrix of 1×8 formulations for preparation and analysis. Two individual tests were also run at 1.2 and 1.3 NaOH:acetyl donor groups molar ratio to 0.9 HP:acetyl donor groups. The ratio of NaOH:H₂O₂ was determined by experimentally following the establishment of the NaOH:acetyl and the HP:acetyl donor groups molar ratios for all combinations in the test matrix.

The formulations for analysis were made in 100 mL “batches” by the shake bottle method described in Example 4 except where noted. The target concentration of 2.0% w/v peracetate (measured as peracetic acid) was made using 0.0280 moles of H2O2, which is 6% higher than the expected amount of peracetate (0.0263 moles) to compensate for a typical amount of production efficiency loss.

The shake bottle method for making a nominal 2.0% w/v solution concentration as peracetic acid having a 1:1 NaOH:acetyl donor groups molar ratio, a 1:1 H2O2:acetyl donor groups molar ratio and a 1:1 NaOH:H₂O₂ molar ratio is as follows. Three 125 mL polyethylene bottles were labeled “A”, “B” and “C”. To bottle “A” 89.63 g of deionized water was placed into the polyethylene bottle, 3.53 mL of 25.0% NaOH was added, the composition was mixed by shaking and allowed to stand for at least 1 minute. To bottle “B” 5.11 mL of 17.5% w/w H2O2 was added. To bottle “C” 1.75 mL (2.03 g) of triacetin was added. The amounts of compounds added to each bottle assume 94% conversion of H₂O₂ to peracetic acid such that 2.129% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

At 2% w/v peracetate solution an increase in yield in both the conversion of hydrogen peroxide to peracetate and acyl donor groups to peracetate was seen as compared to the 1.0% w/v peracetate solution.

As seen in the results summarized in Table 11, test performance is significantly improved in the small-batch, laboratory test procedure for preparing nonequilibrium peracetate compositions targeted at 2% peracetate relative to the results in Example 5 targeted to prepare 1% peracetate compositions.

### Example 7: Determination of Near-Stoichiometric Formulation Method Targeting 8% Peracetate Solution

The production of an 8% w/v peracetate solution was targeted to demonstrate a higher practical production concentration that is enabled by the above formulation approach that produces a peracetate solution at pH 12.5 or greater with at least a 90% conversion of hydrogen peroxide to peracetate and less than 1000 mg/L hydrogen peroxide residual.

A number of tests were conducted to examine the properties of a peracetate solution (8.0% w/v target concentration) when produced by controlling the sodium hydroxide to acetyl donor groups molar ratio (NaOH:acetyl) and the hydrogen peroxide to acetyl donor groups molar ratio (HP:acetyl). The peracetate solution properties compared in this test matrix include: the percent conversion of hydrogen peroxide to peracetate; the percent conversion of acyl donor to peracetate; concentration of peracetate in solution when first made t=0, and at t=10 and t=30 minutes; the pH of the peracetate solution over time t=0, t=10 and t=30 minutes; and the residual hydrogen peroxide concentration in the peracetate solution when first made. The stability index (SI) was calculated at 10 and 30 minutes. The weight ratio of total organic carbon to peracetate ratio was also calculated. The molar ratio range of NaOH:acetyl donor groups was 0.80:1 to 1.3:1 and the molar ratio range of HP:acetyl donor groups was 0.65:1 to 1.10:1. At each of the NaOH:acetyl donor groups ratios the range of HP:acetyl donor groups ratios was produced and analyzed. This data is captured in Table 12.

In the formulation tests, the NaOH:acetyl donor groups molar ratio (moles NaOH/moles acetyl donor groups) used was 1.10. For these tests the HP:acetyl donor groups molar ratio was varied over the range of 0.75, 0.80, 0.85, 0.90, 0.95, 1.00, 1.05 and 1.10. This represents a test matrix of 1×8 formulations for preparation and analysis. The ratio of NaOH:H₂O₂ was determined by experimentally following the establishment of the NaOH:acetyl and the HP:acetyl donor groups molar ratios for all combinations in the test matrix.

The formulations for analysis were made in 100 mL “batches” by the shake bottle method described in Example 4 except where noted. The target concentration of 8.0% w/v peracetate (measured as peracetic acid) was made using 0.112 moles of H2O2, which is 6% higher than the expected amount of peracetate (0.105 moles) to compensate for a typical amount of production efficiency loss.

The shake bottle method for making a nominal 8.0% w/v solution concentration as peracetic acid having a 1:1 NaOH:acetyl donor groups molar ratio, a 1:1 H2O2:acetyl donor groups molar ratio and a 1:1 NaOH:H₂O₂ molar ratio is as follows. Three 125 mL polyethylene bottles were labeled “A”, “B” and “C”. To bottle “A” 58.47 g of deionized water was placed into the polyethylene bottle, 14.10 mL of 25.0% NaOH was added, the composition was mixed by shaking and allowed to stand for at least 1 minute. To bottle “B” 20.45 mL of 17.5% w/w H₂O₂ was added. To bottle “C” 7.00 mL (8.12 g) of triacetin was added. The amounts of compounds added to each bottle assume 94% conversion of H₂O₂ to peracetic acid such that 4.787% peracetic acid is 100% conversion. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing as outlined above. This sample collected is time=0.

The rest of the testing parameters including peracetate concentration, residual hydrogen peroxide measurements were performed as in Example 4.

At 8% solution concentration, the concentration of peracetate initially made is expected to decrease at a higher rate than at 4.5% due to either singlet oxygen production (reaction 2 as described in the specification) or other bi-molecular side reactions that naturally increase in rate with increasing concentration. A 10% loss of peracetate concentration at 10 minutes after making an 8% peracetate solution was observed in a similar optimum range as for the 4.5% formulations. However, as the HP:acetyl donor groups molar ratio decreased to below 0.8:1 the product stability decreased indicating excess acetyl donor groups is detrimental to high concentrations of peracetate. This result suggests that a 5 minute working time or less is best for concentrations significantly higher than 4.5% peracetate.

TABLE 5

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 25 | 0.80 | 1.10 | 0.73 | 41828 | 2148 | 8.7 | 11.4 | 21795 | 10.4 | 19559 | 10.0 | 0.52 | 0.47 | 87% | 96% | 0.50 |
| 26 | 0.80 | 1.05 | 0.76 | 44913 | 2020 | 9.9 | 11.5 | 22851 | 10.5 | 19018 | 10.0 | 0.51 | 0.42 | 94% | 99% | 0.49 |
| 27 | 0.80 | 1.00 | 0.80 | 38124 | 1978 | 8.6 | 11.4 | 24590 | 10.4 | 20655 | 10.0 | 0.64 | 0.54 | 80% | 80% | 0.60 |
| 28 | 0.80 | 0.95 | 0.84 | 43441 | 1881 | 10.3 | 11.5 | 26405 | 10.5 | 24623 | 10.1 | 0.61 | 0.57 | 91% | 86% | 0.56 |
| 29 | 0.80 | 0.90 | 0.89 | 44436 | 1619 | 12.3 | 11.6 | 30245 | 10.2 | 28853 | 9.9 | 0.68 | 0.65 | 93% | 84% | 0.57 |
| 30 | 0.80 | 0.85 | 0.94 | 45433 | 800 | 25.4 | 11.5 | 32692 | 10.4 | 31671 | 10.0 | 0.72 | 0.70 | 95% | 81% | 0.60 |
| 31 | 0.80 | 0.80 | 1.00 | 45898 | 1076 | 19.1 | 11.9 | 38073 | 10.6 | 32786 | 10.2 | 0.83 | 0.71 | 96% | 77% | 0.63 |
| 32 | 0.80 | 0.75 | 1.06 | 46344 | 871 | 23.8 | 11.8 | 35913 | 10.4 | 34077 | 10.0 | 0.77 | 0.74 | 97% | 73% | 0.66 |
| 17 | 0.90 | 1.10 | 0.82 | 37693 | 1872 | 9.0 | 12.0 | 28644 | 11.9 | 18123 | 11.8 | 0.76 | 0.48 | 79% | 87% | 0.55 |
| 18 | 0.90 | 1.05 | 0.85 | 41501 | 1958 | 9.5 | 11.8 | 27482 | 11.3 | 23382 | 10.5 | 0.66 | 0.56 | 87% | 91% | 0.53 |
| 19 | 0.90 | 1.00 | 0.90 | 43321 | 1890 | 10.2 | 11.8 | 28418 | 11.3 | 26953 | 10.5 | 0.66 | 0.62 | 90% | 90% | 0.53 |
| 20 | 0.90 | 0.95 | 0.94 | 42835 | 1590 | 12.0 | 11.8 | 31163 | 11.2 | 29118 | 10.5 | 0.73 | 0.68 | 89% | 85% | 0.56 |
| 21 | 0.90 | 0.90 | 1.01 | 44124 | 1423 | 13.9 | 11.9 | 35280 | 10.9 | 29447 | 10.4 | 0.80 | 0.67 | 92% | 83% | 0.58 |
| 22 | 0.90 | 0.85 | 1.06 | 45684 | 1044 | 19.6 | 11.9 | 35518 | 10.9 | 32398 | 10.6 | 0.78 | 0.71 | 95% | 81% | 0.59 |
| 23 | 0.90 | 0.80 | 1.12 | 41251 | 254 | 72.6 | 12.3 | 39343 | 11.1 | 36483 | 10.6 | 0.95 | 0.88 | 86% | 69% | 0.70 |
| 24 | 0.90 | 0.75 | 1.20 | 45750 | 0 | | 12.3 | 40893 | 10.8 | 39189 | 10.6 | 0.89 | 0.86 | 96% | 72% | 0.67 |

TABLE 6

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 9 | 0.95 | 1.10 | 0.87 | 42502 | 1987 | 9.6 | 11.8 | 28102 | 11.7 | 22582 | 11.2 | 0.66 | 0.53 | 89% | 98% | 0.49 |
| 10 | 0.95 | 1.05 | 0.90 | 43361 | 2082 | 9.3 | 12.1 | 38202 | 12.2 | 29968 | 12.4 | 0.88 | 0.69 | 91% | 95% | 0.50 |
| 11 | 0.95 | 1.00 | 0.96 | 41379 | 1777 | 10.4 | 11.7 | 30375 | 11.8 | 28102 | 11.2 | 0.73 | 0.68 | 86% | 86% | 0.56 |
| 12 | 0.95 | 0.95 | 1.00 | 44178 | 1568 | 12.6 | 12.1 | 35128 | 11.9 | 28980 | 11.5 | 0.80 | 0.66 | 92% | 88% | 0.55 |
| 13 | 0.95 | 0.90 | 1.06 | 44787 | 1261 | 15.9 | 12.1 | 35437 | 11.7 | 32508 | 11.2 | 0.79 | 0.73 | 94% | 84% | 0.57 |
| 14 | 0.95 | 0.85 | 1.12 | 45952 | 597 | 34.4 | 12.0 | 40397 | 11.5 | 35754 | 11.0 | 0.88 | 0.78 | 96% | 82% | 0.59 |
| 15 | 0.95 | 0.80 | 1.18 | 46330 | 550 | 37.7 | 12.1 | 42060 | 11.4 | 36884 | 11.0 | 0.91 | 0.80 | 97% | 77% | 0.62 |
| 16 | 0.95 | 0.75 | 1.27 | 45563 | 0 | | 12.7 | 40364 | 11.8 | 36884 | 11.4 | 0.89 | 0.81 | 95% | 71% | 0.67 |
| 1 | 1.00 | 1.10 | 0.91 | 35916 | 1466 | 11.0 | 12.0 | 26005 | 12.0 | 23703 | 11.5 | 0.72 | 0.66 | 75% | 83% | 0.58 |
| 2 | 1.00 | 1.05 | 0.95 | 38861 | 1755 | 9.9 | 12.0 | 26604 | 11.9 | 25081 | 11.6 | 0.68 | 0.65 | 81% | 85% | 0.56 |
| 3 | 1.00 | 1.00 | 1.00 | 39971 | 1577 | 11.3 | 12.0 | 29172 | 11.7 | 28921 | 10.9 | 0.73 | 0.72 | 83% | 83% | 0.57 |
| 4 | 1.00 | 0.95 | 1.05 | 44969 | 1107 | 18.2 | 12.1 | 39976 | 12.0 | 29154 | 12.0 | 0.89 | 0.65 | 94% | 89% | 0.54 |
| 78 | 1.00 | 0.92 | 1.09 | 45672 | 1179 | 17.3 | 12.1 | 39289 | 12.0 | 37830 | 11.9 | 0.86 | 0.83 | 95% | 88% | 0.55 |
| 5 | 1.00 | 0.90 | 1.12 | 45563 | | | 12.2 | 39028 | 12.0 | 32835 | 12.0 | 0.86 | 0.72 | 95% | 86% | 0.56 |
| 79 | 1.00 | 0.87 | 1.15 | 46112 | 951 | 21.7 | 12.4 | 43162 | 12.1 | 39722 | 12.1 | 0.94 | 0.86 | 96% | 84% | 0.57 |
| 6 | 1.00 | 0.85 | 1.18 | 44263 | 849 | 23.3 | 12.3 | 37969 | 11.6 | 37854 | 11.3 | 0.86 | 0.86 | 92% | 79% | 0.61 |
| 7 | 1.00 | 0.80 | 1.24 | 46905 | 612 | 34.3 | 12.9 | 43755 | 12.7 | 36884 | 12.3 | 0.93 | 0.79 | 98% | 78% | 0.61 |
| 8 | 1.00 | 0.75 | 1.33 | 44839 | 0 | | 12.7 | 43317 | 12.2 | 30485 | 12.0 | 0.97 | 0.68 | 94% | 70% | 0.68 |
| 67 | 1.00 | 0.70 | 1.43 | 46627 | 0 | | 12.8 | 45516 | 12.3 | 36884 | 12.1 | 0.98 | 0.79 | 97% | 68% | 0.70 |
| 68 | 1.00 | 0.65 | 1.55 | 44839 | 0 | | 12.8 | 43162 | 12.4 | 34756 | 12.2 | 0.96 | 0.78 | 94% | 61% | 0.79 |

TABLE 7

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 33 | 1.05 | 1.10 | 0.96 | 45248 | 1866 | 10.8 | 12.0 | 33426 | 12.1 | 26894 | 12.2 | 0.74 | 0.59 | 95% | 104% | 0.46 |
| 34 | 1.05 | 1.05 | 1.00 | 46297 | 1611 | 12.8 | 12.2 | 38805 | 12.0 | 35293 | 12.3 | 0.84 | 0.76 | 97% | 102% | 0.47 |
| 35 | 1.05 | 1.00 | 1.05 | 46011 | 1573 | 13.1 | 12.2 | 39858 | 12.2 | 36082 | 12.2 | 0.87 | 0.78 | 96% | 96% | 0.50 |
| 36 | 1.05 | 0.95 | 1.10 | 44021 | 1118 | 17.6 | 12.4 | 42647 | 12.3 | 32273 | 12.3 | 0.97 | 0.73 | 92% | 87% | 0.55 |
| 37 | 1.05 | 0.90 | 1.18 | 46063 | 806 | 25.5 | 12.5 | 47308 | 12.4 | 44788 | 12.3 | 1.03 | 0.97 | 96% | 87% | 0.55 |
| 80 | 1.05 | 0.87 | 1.21 | 47726 | 554 | 38.5 | 12.6 | 45337 | 12.4 | 38524 | 12.2 | 0.95 | 0.81 | 100% | 87% | 0.55 |
| 38 | 1.05 | 0.85 | 1.24 | 46222 | 507 | 40.8 | 12.2 | 42308 | 11.9 | 35347 | 11.7 | 0.92 | 0.76 | 97% | 82% | 0.58 |
| 39 | 1.05 | 0.80 | 1.31 | 48911 | 341 | 64.1 | 12.9 | 42607 | 12.7 | 41076 | 12.4 | 0.87 | 0.84 | 102% | 82% | 0.59 |
| 40 | 1.05 | 0.75 | 1.40 | 49651 | 0 | | 13.0 | 46842 | 12.5 | 37226 | 12.3 | 0.94 | 0.75 | 104% | 78% | 0.62 |
| 41 | 1.05 | 0.70 | 1.49 | 47523 | 0 | | 13.0 | 45396 | 12.7 | 40983 | 12.4 | 0.96 | 0.86 | 99% | 69% | 0.69 |
| 42 | 1.05 | 0.65 | 1.63 | 47949 | 0 | | 12.9 | 46105 | 12.6 | 35008 | 12.3 | 0.96 | 0.73 | 100% | 65% | 0.74 |
| 43 | 1.10 | 1.10 | 1.01 | 44729 | 1484 | 13.5 | 12.3 | 41294 | 12.3 | 35207 | 12.4 | 0.92 | 0.79 | 93% | 103% | 0.47 |
| 44 | 1.10 | 1.05 | 1.05 | 45846 | 1649 | 12.4 | 12.3 | 45303 | 12.3 | 34090 | 12.3 | 0.99 | 0.74 | 96% | 101% | 0.48 |
| 45 | 1.10 | 1.00 | 1.10 | 44846 | 1234 | 16.2 | 12.5 | 42416 | 12.4 | 40492 | 12.3 | 0.95 | 0.90 | 94% | 94% | 0.51 |
| 46 | 1.10 | 0.95 | 1.16 | 43775 | 824 | 23.7 | 12.3 | 41336 | 12.2 | 36884 | 12.2 | 0.94 | 0.84 | 91% | 87% | 0.55 |
| 47 | 1.10 | 0.90 | 1.23 | 44198 | 552 | 35.8 | 12.5 | 43162 | 12.2 | 39289 | 12.1 | 0.98 | 0.89 | 92% | 83% | 0.58 |
| 48 | 1.10 | 0.85 | 1.29 | 49810 | 502 | 44.4 | 12.7 | 46842 | 12.6 | 39097 | 12.3 | 0.94 | 0.78 | 104% | 88% | 0.54 |
| 49 | 1.10 | 0.80 | 1.37 | 46788 | 0 | | 13.1 | 45422 | 12.9 | 37285 | 12.6 | 0.97 | 0.80 | 98% | 78% | 0.61 |
| 50 | 1.10 | 0.75 | 1.46 | 47129 | 0 | | 13.1 | 46873 | 12.9 | 34194 | 12.5 | 0.99 | 0.73 | 98% | 74% | 0.65 |

TABLE 8

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 69 | 1.15 | 1.10 | 1.05 | 43932 | 1418 | 13.8 | 12.3 | 42906 | 12.4 | 35314 | 12.4 | 0.98 | 0.80 | 92% | 101% | 0.48 |
| 70 | 1.15 | 1.05 | 1.09 | 44613 | 1271 | 15.7 | 12.5 | 43622 | 12.5 | 36065 | 12.4 | 0.98 | 0.81 | 93% | 98% | 0.49 |
| 71 | 1.15 | 1.00 | 1.15 | 45089 | 1217 | 16.6 | 12.3 | 44116 | 12.2 | 36884 | 12.3 | 0.98 | 0.82 | 94% | 94% | 0.51 |
| 72 | 1.15 | 0.95 | 1.21 | 46472 | 1081 | 19.2 | 12.4 | 42647 | 12.3 | 40983 | 12.2 | 0.92 | 0.88 | 97% | 92% | 0.52 |
| 73 | 1.15 | 0.90 | 1.28 | 46834 | 645 | 32.5 | 12.7 | 47046 | 12.6 | 43031 | 12.4 | 1.00 | 0.92 | 98% | 88% | 0.55 |
| 74 | 1.15 | 0.87 | 1.32 | 46056 | 606 | 34.0 | 13.3 | 45917 | 13.2 | 35409 | 12.9 | 1.00 | 0.77 | 96% | 84% | 0.57 |
| 75 | 1.15 | 0.85 | 1.36 | 46974 | 349 | 60.2 | 13.0 | 45736 | 12.9 | 35518 | 12.7 | 0.97 | 0.76 | 98% | 83% | 0.58 |
| 76 | 1.15 | 0.80 | 1.43 | 45924 | 0 | | 12.8 | 43393 | 12.8 | 38331 | 12.5 | 0.94 | 0.83 | 96% | 77% | 0.63 |
| 77 | 1.15 | 0.75 | 1.52 | 44596 | 0 | | 13.2 | 42308 | 12.9 | 33629 | 12.6 | 0.95 | 0.75 | 93% | 70% | 0.69 |
| 51 | 1.20 | 1.10 | 1.10 | 45578 | 1326 | 15.4 | 12.4 | 43689 | 12.4 | 33578 | 12.4 | 0.96 | 0.74 | 95% | 105% | 0.46 |
| 52 | 1.20 | 1.05 | 1.14 | 45715 | 1263 | 16.2 | 12.4 | 35799 | 12.3 | 33286 | 12.3 | 0.78 | 0.73 | 95% | 100% | 0.48 |
| 53 | 1.20 | 1.00 | 1.20 | 46465 | 1135 | 18.3 | 12.4 | 41689 | 12.4 | 35550 | 12.3 | 0.90 | 0.77 | 97% | 97% | 0.49 |
| 54 | 1.20 | 0.95 | 1.27 | 45261 | 775 | 26.1 | 12.9 | 46814 | 12.8 | 41694 | 12.6 | 1.03 | 0.92 | 95% | 90% | 0.53 |
| 55 | 1.20 | 0.90 | 1.34 | 48334 | 496 | 43.6 | 13.2 | 47732 | 12.9 | 41694 | 12.7 | 0.99 | 0.86 | 101% | 91% | 0.53 |
| 56 | 1.20 | 0.85 | 1.42 | 47752 | 280 | 76.2 | 12.9 | 43590 | 12.9 | 36005 | 12.4 | 0.91 | 0.75 | 100% | 85% | 0.57 |
| 57 | 1.20 | 0.80 | 1.49 | 44925 | 143 | 140.4 | 13.2 | 44998 | 13.1 | 37580 | 12.7 | 1.00 | 0.84 | 94% | 75% | 0.64 |
| 58 | 1.20 | 0.75 | 1.60 | 48410 | 0 | | 13.1 | 43746 | 12.9 | 37742 | 12.6 | 0.90 | 0.78 | 101% | 76% | 0.63 |

TABLE 9

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 51 | 1.20 | 1.10 | 1.10 | 45578 | 1326 | 15.4 | 12.4 | 43689 | 12.4 | 33578 | 12.4 | 0.96 | 0.74 | 95% | 105% | 0.46 |
| 52 | 1.20 | 1.05 | 1.14 | 45715 | 1263 | 16.2 | 12.4 | 35799 | 12.3 | 33286 | 12.3 | 0.78 | 0.73 | 95% | 100% | 0.48 |
| 53 | 1.20 | 1.00 | 1.20 | 46465 | 1135 | 18.3 | 12.4 | 41689 | 12.4 | 35550 | 12.3 | 0.90 | 0.77 | 97% | 97% | 0.49 |
| 54 | 1.20 | 0.95 | 1.27 | 45261 | 775 | 26.1 | 12.9 | 46814 | 12.8 | 41694 | 12.6 | 1.03 | 0.92 | 95% | 90% | 0.53 |
| 55 | 1.20 | 0.90 | 1.34 | 48334 | 496 | 43.6 | 13.2 | 47732 | 12.9 | 41694 | 12.7 | 0.99 | 0.86 | 101% | 91% | 0.53 |
| 56 | 1.20 | 0.85 | 1.42 | 47752 | 280 | 76.2 | 12.9 | 43590 | 12.9 | 36005 | 12.4 | 0.91 | 0.75 | 100% | 85% | 0.57 |
| 57 | 1.20 | 0.80 | 1.49 | 44925 | 143 | 140.4 | 13.2 | 44998 | 13.1 | 37580 | 12.7 | 1.00 | 0.84 | 94% | 75% | 0.64 |
| 58 | 1.20 | 0.75 | 1.60 | 48410 | 0 | | 13.1 | 43746 | 12.9 | 37742 | 12.6 | 0.90 | 0.78 | 101% | 76% | 0.63 |
| 59 | 1.30 | 1.10 | 1.19 | 45987 | 1054 | 19.5 | 12.8 | 46058 | 12.8 | 43818 | 12.6 | 1.00 | 0.95 | 96% | 106% | 0.45 |
| 60 | 1.30 | 1.05 | 1.24 | 45078 | 1127 | 17.9 | 12.7 | 42635 | 12.6 | 37245 | 12.5 | 0.95 | 0.83 | 94% | 99% | 0.49 |
| 61 | 1.30 | 1.00 | 1.31 | 45237 | 699 | 28.9 | 13.2 | 44471 | 13.1 | 40573 | 12.7 | 0.98 | 0.90 | 94% | 94% | 0.51 |
| 62 | 1.30 | 0.95 | 1.37 | 45684 | 454 | 45.0 | 13.1 | 44411 | 13.0 | 36594 | 12.8 | 0.97 | 0.80 | 95% | 91% | 0.53 |
| 63 | 1.30 | 0.90 | 1.45 | 45911 | 298 | 68.9 | 13.1 | 46058 | 13.1 | 35810 | 12.8 | 1.00 | 0.78 | 96% | 86% | 0.56 |
| 64 | 1.30 | 0.85 | 1.54 | 46932 | 129 | 162.6 | 13.1 | 44902 | 13.1 | 38093 | 12.7 | 0.96 | 0.81 | 98% | 83% | 0.58 |
| 65 | 1.30 | 0.80 | 1.62 | 47641 | 0 | | 13.3 | 42725 | 13.2 | 34041 | 12.8 | 0.90 | 0.71 | 100% | 80% | 0.60 |
| 66 | 1.30 | 0.75 | 1.73 | 47892 | 0 | | 13.4 | 42478 | 13.0 | 29786 | 12.8 | 0.89 | 0.62 | 100% | 75% | 0.64 |

TABLE 10

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 81 | 1.10 | 1.10 | 0.91 | 6208 | 1805 | 1.5 | 11.9 | 5869 | 11.6 | 3314 | 11.5 | 0.95 | 0.53 | 58% | 64% | 0.75 |
| 84 | 1.10 | 0.95 | 1.05 | 7323 | 1583 | 2.1 | 12.1 | 6767 | 11.6 | 6554 | 11.5 | 0.92 | 0.90 | 68% | 65% | |
| 85 | 1.10 | 0.90 | 1.12 | 6955 | 1461 | 2.1 | 12.1 | 5682 | 11.9 | 3469 | 11.9 | 0.82 | 0.50 | 65% | 58% | 0.82 |
| 86 | 1.10 | 0.85 | 1.18 | 7955 | 1333 | 2.7 | 12.1 | 6697 | 11.8 | 5387 | 11.8 | 0.84 | 0.68 | 74% | 63% | 0.76 |
| 87 | 1.10 | 0.80 | 1.24 | 7125 | 1293 | 2.5 | 12.0 | 6416 | 11.6 | 4878 | 11.5 | 0.90 | 0.68 | 66% | 53% | 0.90 |
| 88 | 1.10 | 0.75 | 1.33 | 8282 | 1040 | 3.6 | 12.3 | 7529 | 11.8 | 5591 | 11.7 | 0.91 | 0.68 | 77% | 58% | 0.83 |
| 89 | 1.20 | 0.90 | 1.33 | 7085 | 1401 | 2.3 | 12.3 | 6890 | 12.0 | 5413 | 12.0 | 0.97 | 0.76 | 66% | 59% | 0.81 |
| 90 | 1.30 | 0.90 | 1.44 | 7011 | 1345 | 2.3 | 12.4 | 6824 | 12.3 | 5933 | 12.1 | 0.97 | 0.85 | 65% | 59% | 0.82 |

TABLE 11

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 91 | 1.10 | 1.10 | 0.91 | 18944 | 2247 | 3.8 | 12.2 | 13565 | 11.9 | 9957 | 12.0 | 0.72 | 0.53 | 89% | 98% | 0.49 |
| 92 | 1.10 | 1.05 | 0.95 | 17780 | 2005 | 4.0 | 12.2 | 15220 | 12.0 | 10883 | 12.1 | 0.86 | 0.61 | 84% | 88% | 0.55 |
| 93 | 1.10 | 1.00 | 1.00 | 17726 | 1891 | 4.2 | 12.2 | 15141 | 12.0 | 13052 | 12.1 | 0.85 | 0.74 | 83% | 83% | 0.58 |
| 94 | 1.10 | 0.95 | 1.05 | 18270 | 1779 | 4.6 | 12.2 | 17450 | 12.0 | 13264 | 12.2 | 0.96 | 0.73 | 86% | 82% | 0.59 |
| 95 | 1.10 | 0.90 | 1.12 | 18851 | 1258 | 6.7 | 12.4 | 18161 | 12.1 | 14509 | 12.1 | 0.96 | 0.77 | 89% | 80% | 0.60 |
| 96 | 1.10 | 0.85 | 1.18 | 19133 | 1041 | 8.2 | 12.5 | 18396 | 12.1 | 16951 | 12.1 | 0.96 | 0.89 | 90% | 77% | 0.63 |
| 97 | 1.10 | 0.80 | 1.24 | 20175 | 762 | 11.8 | 12.6 | 19370 | 12.4 | 18293 | 12.3 | 0.96 | 0.91 | 95% | 76% | 0.63 |
| 100 | 1.10 | 0.75 | 1.33 | 19730 | 573 | 15.4 | 12.6 | 19368 | 12.6 | 19042 | 12.4 | 0.98 | 0.97 | 93% | 70% | 0.69 |
| 101 | 1.20 | 0.90 | 1.34 | 18576 | 1128 | 7.4 | 12.6 | 18477 | 12.5 | 16763 | 12.3 | 0.99 | 0.90 | 87% | 79% | 0.61 |
| 102 | 1.30 | 0.90 | 1.44 | 19853 | 657 | 13.5 | 12.8 | 18824 | 12.8 | 17739 | 12.6 | 0.95 | 0.89 | 93% | 84% | 0.57 |

TABLE 12

| | | | | | | G | | | | | | | | O | P | |
|---|---|---|---|---|---|---|---|---|---|---|---|---|---|---|---|---|
| | B | | D | | | Molar | | | | | | | | Yield | Yield | Q |
| | Molar | C | Molar | E | F | Ratio | | I | | K | | | | PAA | PAA | Wt. |
| A | Ratio | Molar | Ratio | PAA | HP | PAA: | H | PAA | J | PAA | L | | | from | from | Ratio |
| Ref. | NaOH: | Ratio | NaOH: | t = 0 | t = 0 | HP | pH | t = 10 | pH | t = 30 | pH | M | N | HP | AD | TOC: |
| No. | AD | HP:AD | HP | mg/L | mg/L | t = 0 | t = 0 | mg/L | t = 10 | mg/L | t = 30 | SI10 | SI30 | % | % | PAA |
| 103 | 1.10 | 1.10 | 0.91 | 64969 | 1547 | 18.8 | 12.0 | 60427 | 12.1 | 48655 | 12.1 | 0.93 | 0.75 | 76% | 84% | 0.57 |
| 104 | 1.10 | 1.05 | 0.95 | 74132 | 1436 | 23.1 | 12.0 | 60790 | 12.1 | 37607 | 12.1 | 0.82 | 0.51 | 87% | 92% | 0.52 |
| 105 | 1.10 | 1.00 | 1.00 | 75903 | 977 | 34.7 | 12.3 | 67259 | 12.2 | 46836 | 12.2 | 0.89 | 0.62 | 89% | 89% | 0.54 |
| 106 | 1.10 | 0.95 | 1.05 | 73195 | 579 | 56.5 | 12.5 | 65417 | 12.2 | 50545 | 12.2 | 0.89 | 0.69 | 86% | 82% | 0.59 |
| 107 | 1.10 | 0.90 | 1.12 | 75426 | 472 | 71.4 | 12.7 | 68957 | 12.3 | 46273 | 12.2 | 0.91 | 0.61 | 89% | 80% | 0.60 |
| 108 | 1.10 | 0.85 | 1.18 | 76091 | 166 | 204.9 | 12.8 | 64888 | 12.2 | 38113 | 12.1 | 0.85 | 0.50 | 90% | 76% | 0.63 |
| 109 | 1.10 | 0.80 | 1.24 | 74642 | 194 | 172.0 | 12.8 | 62420 | 12.2 | 33337 | 12.1 | 0.84 | 0.45 | 88% | 70% | 0.68 |
| 110 | 1.10 | 0.75 | 1.33 | 74758 | 185 | 180.6 | 12.8 | 61890 | 12.3 | 33230 | 12.2 | 0.83 | 0.44 | 88% | 66% | 0.73 |

### Example 8: Improved Peracetate Oxidant Formulations Over Prior Art

Three formulations were produced by the standard procedure as follows: Peracetate-ROS formulations of the present invention and prior art were made in 500 mL “batches” with their recipes summarized for comparison in Table 13. The formulations were made with a target peracetate concentration of 4.5% wt/vol measured as peracetic acid (PAA). Formulation 1 and 2 were in a commonly-practiced range in prior art while formulation 3 is in a preferred range of the present invention.

TABLE 13
Calculated total organic carbon content of three
formulations. Relative to active PAA eq.

| | water | 25% NaOH | 17.5% H2O2 | triacetin | TOC:PAA |
|---|---|---|---|---|---|
| Formulation | (mL) | (mL) | (mL) | (mL) | mass ratio |
| 1 | 475.5 | 43.35 | 58.35 | 60.0 | 1.44 |
| 2 | 475.5 | 43.35 | 58.35 | 40.0 | 0.96 |
| 3 | 475.5 | 45.00 | 57.70 | 21.0 | 0.51 |

For each formulation the following procedure was followed to produce a nominal 4.5% w/v solution concentration as peracetic acid equivalents. Three 1 L polyethylene bottles with screw-cap lids were labeled “A”, “B” and “C”. To bottle “A” was added the respective amount of deionized water and 25.0% NaOH. The composition was mixed by shaking and allowed to stand for at least 1 minute. To bottle “B” was added the respective amount of 17.5% w/w H2O2. To bottle “C” the respective amount of triacetin was added. The contents of bottle “A” were poured into bottle “B”, the lid closed and the bottle shaken for 1 minute. The combined contents of bottle “B” were poured into bottle “C”, the lid closed and the bottle shaken for 1 minute. At which time the sample is collected or used for testing.

For each of the three formulations, bottle “C” remained sealed and were held for 7 days at room temperature while periodically venting evolved oxygen over the first 24-48 hours. After 7 days the product solutions were verified to have no remaining active peracid. Each of these degraded product solutions were then diluted into distilled water to simulate 20 mg/L and 40 mg/L of active PAA equivalent concentrations. For the 20 mg/L active PAA equivalent concentration solution, 0.222 mL of each degraded product solution was diluted to 500 mL volume in distilled water. For the 40 mg/L active PAA equivalent concentration solution, 0.444 mL of each degraded product solution was diluted to 500 mL volume in distilled water. Each of these diluted solutions was evaluated for 5-day biological oxygen demand (BOD5, standard method 52110B) and chemical oxygen demand (COD, standard method 5220D) by a third party laboratory. Results are shown in Table 14.

TABLE 14
Measured biological oxygen demand and chemical oxygen
demand of three formulations after decomposition of the
active peracid. Measured relative to active PAA eq.

| | PAA | | | BOD5:PAA | COD:PAA |
|---|---|---|---|---|---|
| | equiv. | BOD5 | COD | mass | mass |
| Formulation | (mg/L) | (mg/L) | (mg/L) | ratio | ratio |
| 1 | 20 | 25 | 47 | 1.25 | 2.35 |
| 1 | 40 | 39 | 107 | 0.98 | 2.68 |
| 2 | 20 | 22 | 33 | 1.10 | 1.65 |
| 2 | 40 | 40 | 71 | 1.00 | 1.78 |
| 3 | 20 | 18 | 23 | 0.90 | 1.15 |
| 3 | 40 | 37 | 51 | 0.93 | 1.28 |

### Example 9: Measurement of VOC in Improved Formulation

Three individual 500 mL batches of formulation 3 were made and allowed to degrade for 7 days following the above procedures. The three batches were sent to a third party laboratory for analysis of volatile organic compound (VOC) content by EPA method 24. The analysis results for each individual batch were −0.26±0.56 lb VOC/gal, −0.18±0.39 lb VOC/gal and 0.18±0.42 lb VOC/gal for an average of −0.26 lb VOC/gal, which is zero within the error of analysis.

The lack of excess acetyl donor groups in the near-stoichiometric formulation 3 prevents the formation of acetic acid by the reaction that converts an amount of the acetyl donor groups in stoichiometric excess to hydrogen peroxide to acetic acid by reaction 4 disclosed in the PCT application. The prior art formulations 1 and 2 (described above) with significant stoichiometric excess of acetyl donor groups do not contain alkalinity in equivalence to or in excess of the acetyl donor groups in stoichiometric excess to hydrogen peroxide to prevent some acetic acid formation. Acetic acid is a VOC with ground-level ozone formation potential therefore it is preferred to generate a peracid formulation that does not inherently contain or produce acetic acid. Other peracid products such as equilibrium peracetic acid inherently contain significant quantities of acetic acid while the decomposition of peracetic acid results in acetic acid formation.

### Example 10 Acidified PMAX for Pulp Brightening

Some kraft bleach plants use large quantities of chlorine dioxide, e.g., D-Eop-D, and have a low final pH that would be well-suited for electrophilic peracid brightening of pulp in a high density (HD) storage chest after the bleach plant. There is a unique benefit to converting a significant portion of peracetate in its nucleophilic anion form (Pac) to electrophilic peracetic acid (PAA) on demand and at a product solution pH that closely matches that of pulp in an acidic pH environment by the use of mineral acids instead of organic acids. This is a method of adding an additional bleaching stage to a bleach sequence that can reduce the use of chlorine dioxide without adding excess material transport cost and mill effluent COD and the resulting BOD treatment cost associated with previous non-stoichiometric production of sodium peracetate and equilibrium peracetic acid products.

This example compares the brightening of a low pH pulp after the bleaching process (post-bleached pulp) with sodium peracetate (NaPAc) and acidified sodium peracetate to substantially form PAA.

In this example the acidulant is sulfuric acid, which provides benefits over acetic acid as the acidulant used in stabilized equilibrium peracetic acid products. Advantages include 3× less mass of sulfuric acid (100% basis) used to reach the desired pH compared to acetic acid (100% basis) and no additional TOC, COD or BOD added to the sodium peracetate product when using sulfuric acid.

Bag bleaching tests on bleached southern hardwood kraft pulp treated in a D-Eop-D sequence were conducted at 12% pulp consistency, 60° C., and 2 hours to simulate a bleached pulp HD storage chest. The bleached pulp stock had an initial brightness of 84.70% ISO and had a pH of 5.0. During tests the pH of the pulp was changed only according to the type and amount of oxidant added. Samples were heated in a heated water bath and kneaded every 10-15 minutes. Treated samples were washed twice with distilled water and filtered with a Buchner funnel. The washed fiber was divided into two equal portions (by weight) to make two brightness pads (about 6 g dry fiber per pad).

Brightness pads were prepared by the method described in Section 8 of TAPPI method T218 (Buchner funnel procedure). Brightness pads were dried in drying rings overnight with air flow from a fan. Air temperature 21-23° C., relative humidity 26-34%. ISO Brightness and L*a*b* color value measurements were made using a Technidyne ColorTouchX ISO brightness meter. Twelve measurements were averaged for each pulp sample (6 measurements on each of the two brightness pads per sample).

The sodium peracetate product was made in laboratory batches (2% w/v as PAA) from diluted sodium hydroxide, hydrogen peroxide and triacetin as the acetyl donor. This product was either used immediately as-made with a pH near 12.4 or immediately acidified with 4 N sulfuric acid to pH 4.5 prior to use.

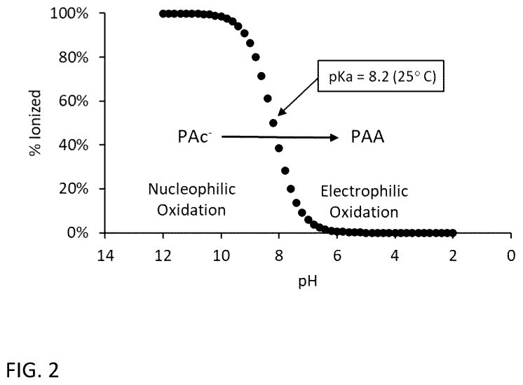

The amount of oxidant used in each test case was 1, 2, 3, and 5 pounds of oxidant on a 100% PAA equivalent weight basis per ton of oven dried pulp. The brightening results are shown graphically in FIG. 2.

The as-made alkaline sodium peracetate product increased brightness to 85.80 and 85.75% ISO at 1 and 2 lb/ton doses, respectively. The brightness then decreased to 84.45 and 83.91% ISO at 3 and 5 lb/ton doses, respectively. The acidified sodium peracetate product increased brightness to 84.70 and 85.58% ISO at 1 and 2 lb/ton doses, respectively, and continued to brighten to 86.05 and 86.26% ISO at 3 and 5 lb/ton doses, respectively. While the as-made alkaline sodium peracetate, which produces singlet oxygen, provided the largest brightness gain at 1 lb/ton, the acidified peracetate provided increasing brightness at doses greater than 2 lb/ton. Singlet oxygen is generally electrophilic in its reactivity behavior and provides oxidative bleaching performance that can counteract effects of nucleophilic alkalinity that promotes “alkaline darkening” of pulp.

The starting treatment pH of the pulp samples illustrate the impact of the type and amount of oxidant added. The sodium peracetate product acidified to pH 4.5 prior to use had minimal impact on the pulp pH with increases of 0.2, 0.2, 0.1 and 0.3 pH units relative to the initial pH of 5.0 for the 1, 2, 3 and 5 lb/ton doses, respectively. The as-made alkaline sodium peracetate product increased the pulp pH by 2.0, 2.0, 3.2 and 3.3 pH units relative to the initial pH of 5.0 for the 1, 2, 3 and 5 lb/ton doses, respectively. Increasing the alkalinity of this pulp sample above a threshold near a pulp pH of 7 using a singlet oxygen producing sodium peracetate solution resulted in reduced brightness.

The impacts of pH and alkalinity are also observed in the b* value (increasing is yellower, decreasing is bluer). The starting b* value of the pulp was 5.96. Treatment with the sodium peracetate product acidified to pH 4.5 prior to use decreased the b* value by 0.27, 0.24, 0.33 and 0.61 units for the 1,2,3, and 5 lb/ton doses, respectively. Treatment with the as-made alkaline sodium peracetate product decreased the b* value by 0.32, 0.31, 0.01 and −0.06 units for the 1,2,3, and 5 lb/ton doses, respectively. Increasing the alkalinity retained more yellow color in the pulp.

The total organic carbon (TOC) added to the wash water effluent by either the as-made sodium peracetate or acidified sodium peracetate oxidant products (made by the “near-stoichiometric” method) in this example is 0.51 lb TOC per lb of PAA equivalent. This is substantially lower than the TOC added by the previous “non-stoichiometric” method which is greater than 0.60 lb TOC per lb of PAA equivalent and more typically 0.96 to 1.4 lb TOC per lb of PAA equivalent. (see Table 13, Example 8)

### Example 11: Improved Formulations with Lower Contribution to Bleach Plant Effluent

A kraft hardwood brownstock from the upper mid-west region of the United States was obtained from the last pulp washer prior to a D₀-Ep-D1 bleach sequence. The pulp was treated with the sodium peracetate chemistry of this invention and evaluated for brightness gains and kappa number reduction after the D₀ and Ep stages. The carry through of the brightness gain after the Ep stage was also evaluated after a D₁ stage for the final brightness of the pulp. The reduction of chlorine dioxide use to achieve the target brightness was the final metric for determining the value of the savings in bleach chemical costs provided by the treatment with the sodium peracetate chemistry. Finally, the contributions of the sodium peracetate chemistry of this invention to the COD and BOD of the bleach plant effluent were evaluated relative to two prior preferred formulations of the peracetate chemistry.

Bag bleaching tests were conducted at temperatures, pulp consistencies, pH ranges and chemical doses that simulated mill process conditions to achieve comparable kappa numbers and brightness.

Samples were heated in a heated water bath and kneaded every 10-15 minutes. Treated samples were washed twice with tap water and filtered with a Buchner funnel. The washed fiber was divided into two equal portions (by weight) to make two brightness pads (about 6 g dry fiber per pad).

Brightness pads were prepared by the method described in Section 8 of TAPPI method T218 (Buchner funnel procedure). Brightness pads were dried in drying rings overnight with air flow from a fan. Air temperature 21-23° C., relative humidity 26-34%. ISO Brightness and L*a*b* color value measurements were made using a Technidyne ColorTouchX ISO brightness meter. Twelve measurements were averaged for each pulp sample (6 measurements on each of the two brightness pads per sample). Kappa number measurements were conducted using a micro-kappa procedure that used about 0.5 g of oven dried pulp fiber mass (¼-scale of the standard TAPPI T236 om-99 method).

The sodium peracetate product was made in laboratory batches (2% w/v as PAA) from diluted sodium hydroxide, hydrogen peroxide and triacetin as the acetyl donor. This product was used immediately as-made with a pH near 12.4.

The amount of sodium peracetate, hydrogen peroxide and sodium hydroxide used in each stage tested was added on a 100% weight basis per oven dried ton (odt) of pulp. Sulfuric acid was used to adjust the pH in the first chlorine dioxide stage. The control test series was just the D₀-Ep-D₁ stages. The D₀ chlorine dioxide dose was varied from 45 lb/odt, the standard amount used in the bleach plant, to 35 and 25 lb/odt to generate a response curve. This series of tests was repeated with a sodium peracetate pre-treatment stage before D₀ to estimate the reduction in ClO₂ use that sodium peracetate pre-treatment could provide to achieve the same brightness as the control test series. Treatment conditions for each of the four stages tested were as follows:
1. Sodium peracetate: 2 lb/odt, 8% consistency, initial pH 10.1, 60° C., 30 minutes
2. D₀: 25, 35, 45 lb/odt chlorine dioxide, 8% consistency, final pH 2.8, 60° C., 45 minutes
3. Ep: 20 lb/odt hydrogen peroxide, 25 lb/odt sodium hydroxide, initial pH 11.6, 60° C., 45 minutes
4. D₁: 22 lb/odt chlorine dioxide, 8% consistency, final pH 3.2, 74° C., 45 minutes

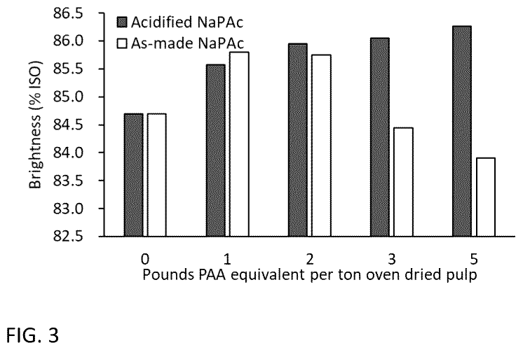

The brightness and kappa number of the pulp after the Ep stage were measured to compare the combined D₀Ep stages with and without pre-treatment with sodium peracetate. The untreated pulp had a starting brightness of 27.5% ISO and kappa number of 13.9. The control tests with D₀Ep using the standard 45 lb/odt ClO₂ in D₀ gave a brightness of 63.1% ISO and kappa number of 2.9. Adding a pre-treatment stage with sodium peracetate prior to D₀ increased brightness by 12 brightness points and decreased kappa number by 1.4 using the standard 45 lb/odt ClO₂ in D₀. Similar differences were observed using 35 and 25 lb/odt ClO₂ as shown in FIG. 3. Pretreatment of the brownstock with 2 lb/odt sodium peracetate increased brightness significantly over the standard DoEp conditions and reduced the kappa number.

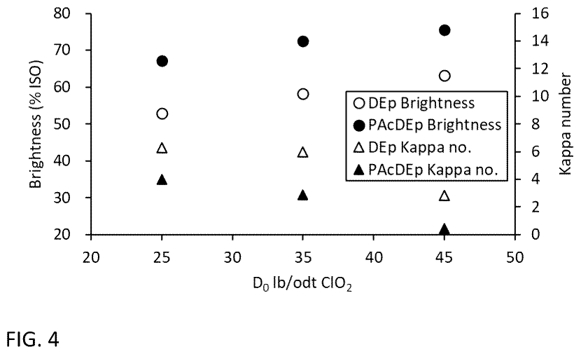

The impact of this brightness gain after Ep was tested for its carry through to the final brightness after the D₁ stage. The control tests with D₀Ep using the standard 45 lb/odt ClO₂ in D₀ gave a final D₁ brightness of 83.2% ISO. Using a pre-treatment with sodium peracetate prior to D₀ increased final D₁ brightness to 86.7% ISO, a gain of 3.5 brightness points. Larger gains were observed at the lower D₀ ClO₂ doses as shown in FIG. 4 with final brightness versus total ClO₂ used. Extrapolating back to the maximum control final brightness of 83.1% ISO (dotted line in FIG. 4) indicates that the ClO₂ use could potentially be reduced by 20 lb/odt or more by pre-treatment with 2 lb/odt sodium peracetate.

The use of 2 lb/odt would have a minimal Impact on bleach plant effluent load of COD and BOD relative to the lignin and other materials removed from the pulp. For example, approximate benchmarks for COD and BOD in bleach plant effluent from the bleaching of kraft pulp after an extended cook and oxygen delignification with kappa number near 14 are 80 lb/odt COD and 18 lb/odt BOD. Minimizing contributions to effluent BOD is important for water treatment cost and discharge compliance. In this example, treatment with the 2 lb/odt sodium peracetate made by the near-stoichiometric method of this invention contributes about 1.9 lb/odt COD and 1.4 lb/odt BOD as measured by standard methods 5220D and 52110B, respectively. Prior non-stoichiometric production of sodium peracetate contributed considerably greater amounts with examples in practice ranging from 2.7 lb/odt COD and 1.6 lb/odt BOD up to 3.9 lb/odt COD and 1.9 lb/odt BOD.

### Example 12: Production of Acidified Peracetate Products for Bleaching

A pulp bleaching stage is conducted with acidified peracetate provided in a single chemical stream added to a pulp after an alkaline hydrogen peroxide extraction or brightening stage. Acidification of the peracetate formulation and acidification of the pulp are provided by a single peracetate product stream dispensed from a sodium peracetate generation system.

The use of an acidic bleaching stage with acidified peracetate was found to provide better brightening for a non-wood fiber in this example. After an alkaline peroxide stage and a pulp washing stage the pulp has a pH of 10.2 and a brightness of 62% ISO. The pulp is adjusted to a consistency of 10% with dilution water and heated to 70° C. The pulp is conveyed through a medium consistency pump into a peracetate bleaching stock chest where it has at least a 30 minute residence time. The acidified peracetate stream (near pH 1.2) is injected into the pulp just prior to the medium consistency pump so that it is thoroughly mixed into the pulp such that it will bleach the pulp while in the stock chest. In the peracetate bleaching stock chest the initial pH of the pulp is pH 4.5-4.8. After the stock chest, the pulp is conveyed to a washing stage. After the pulp washing stage the pulp has a pH of about 5.5 and a brightness of 72% ISO.

The acidified peracetate and pulp acidification stream is produced by a peracetate generation system that produces a 5.8% sodium peracetate (4.5% as PAA) product stream on-demand. A peracetic acid dose rate (100% active basis) of 24 pounds per oven dry ton (lb/odt) of pulp fiber uses 15.6 lb/odt dose rate of sulfuric acid (100% active basis) to make a pH 5.0 peracetate solution. An additional 28 lb/odt of sulfuric acid is used to adjust the initial pH of the pulp to pH 4.5-4.8. For a pulp production rate of 100 tons per day a 5.8% sodium peracetate stream at a rate of 16.8 Lpm using a first peracetate dispensing pump is combined with a 48% sulfuric acid solution stream at a rate of 2.08 Lpm using an acid dispensing pump. This combined stream is injected into the pulp just prior to the medium consistency pump so that it is thoroughly mixed into the pulp such that it will bleach the pulp while in the stock chest as described above.

The peracetate generation system used to make the acidified product stream may also be simultaneously feeding a second, alkaline pulp treatment location in the bleaching process, such as a pre-treatment before a lignin extraction stage, with the alkaline peracetate product as-made using a second peracetate dispensing pump. A single production system can provide both the alkaline and acidified peracetate product streams as needed.

### Example 13: Potato Chip Processing Facility Water Treatment for Reuse

A water sample was collected from a potato chip manufacturing facility from the outlet of the starch recovery stage. The water contained settleable starch solids, had a characteristic odor and generated a stable foam when shaken or mixed rapidly in a container. Several suspected constituents were evaluated including the presence of starch, sugars, phytochemicals, microbes, enzymes, and other plant materials. A significant variety of microorganisms were identified by microscope analysis at high population densities in the water sample as received. Bacteria morphologies were diverse and included coccus, bacillus, spirillum, spirochete, and filamentous forms. The most dominant bacteria types expected in this water source include Staphylococcus thermophilus, Lactobacillus Sp., and Aquaspirillum Sp. At least two types of fungus (budding yeast and fibril forms) were identified, Saccharomyces Sp. and Candida (e.g., humilius and albicans). Starch grains were also readily visible in the water.

A summary of general water quality parameters is shown in Table 15.

TABLE 15
Water quality parameters for a blended
water sample at room temperature.

| Parameter | Untreated Water |
|---|---|
| pH | 6.52 |
| ORP (mV vs SHE) | 472 |
| Conductivity (mS/cm) | 1.7 |
| Total suspended solids (mg/L) | 627 |
| Total Solids (mg/L) | 4040 |
| Total Fe (mg/L) | <0.01 |
| Mg (mg/L CaCO₃) | 190 |
| Ca (mg/L CaCO₃) | 610 |
| SO₄²⁻ (mg/L) | <0.1 |
| ATP (pg/mL) | 27,250 |
| Aerobic/Heterotrophic Bact. (cfu/mL) | >10⁷ |
| Anaerobic Acid Producing Bact. | ≥10⁸ |
| (cfu/mL) | |
| Anaerobic Sulfate Reducing Bact. | ≥10⁸ |
| (cfu/mL) | |
| Fungus (cfu/mL) | ≥10⁸ |

General aerobic/heterotrophic bacteria were enumerated with dip slides (agar coated paddle) while anaerobic acid producing and sulfate reducing bacteria were cultured in serial dilution culture bottles with phenol red dextrose and API-RP30 media, respectively. Fungus was estimated by microscope analysis for its presence in the phenol red dextrose culture broth in serial dilution media bottles.

The water was expected to contain several constituents (i.e., phytochemicals) extracted from potato skins, potato flesh and other plant materials including:
phenolic acids (gallates, cinnamic acid derivatives)
anthocyanins (phenolic pigments)
carotenoids
glucose and higher sugars, glucosides
fatty acids (linolenic, eleostearic)
phospholipids
starch
proteins
catalase (enzymes)

Several of these materials have the potential to consume oxidizing biocides resulting in poor microbial control and high treatment cost. The most dominant constituents identified were starch, fatty acids, phenolic acids, proteins and catalase enzyme, which had the highest oxidant demand. Starch and fatty acids were the likely cause of significant, stable foam formation in agitated samples.

Adding oxidants directly to the water as received resulted in rapid consumption of the oxidants. A qualitative comparison was made to test for the impact of catalase enzyme on hydrogen peroxide (3% solution), peracetate (2% solution) and peracetate (2% solution) pre-acidified to pH 4.0 to convert it into the peracetic acid form. A 4 mL volume of each oxidant solution was added to 40 mL of untreated water at room temperature in separate 150 mL beakers. Upon addition of hydrogen peroxide, the water immediately became effervescent and formed a thick head of stable foam approximately 1 inch thick after 4 minutes. Upon addition of peracetate, the water remained calm initially and slowly began to release some gas without foam formation after 4 minutes. Upon addition of the pre-acidified peracetate in the peracetic acid form the water became moderately effervescent and formed a thin head of foam approximately 0.25 inches thick over 4 minutes. (Note that thermal denaturing of the catalase at 70° C. for 60 minutes prevented the vigorous degradation of hydrogen peroxide.) Based on these results, the catalase enzyme was most reactive with hydrogen peroxide, moderately reactive with peracetic acid and least reactive with peracetate. This trend illustrates greater ability for oxidative treatment of contaminants and microbes with peracetate as it will persist longer in water containing catalase enzyme before degradation by the catalase enzyme.

### Example 14: Water Treatment Demonstration

An oxidative treatment process was conducted on this water to remove suspended solids and contaminants listed above, eliminate odors and control microbes to a level that allows for reuse of the water in potato wash flumes before ultimately being discharged to sewer or a treatment facility prior to environmental discharge.

A 800 mL volume of the untreated water sample was mixed at 290 rpm and charged with a polyaluminum chloride coagulant solution adding 30 mg/L as aluminum. After mixing for 1 minute a 5 mg/L charge of anionic floc polymer was added. The water was mixed for 1 minute at 290 rpm and then 1 minute at 50 rpm and then mixing was stopped. The flocculated solids settled from the water column in about 1.5 minutes. 500 mL of the clarified water was decanted and then treated with a 75 mg/L charge of peracetate which increased the water's ORP to 610 mV (vs SHE). The peracetate was consumed within 15 minutes. After 60 minutes a second, 75 mg/L charge of peracetate was added to see the effect of a repeated cycle of treatment in a recycle loop. The ORP initially increased to 630 mV (vs SHE) and decreased as the peracetate was consumed within 20 minutes. Analysis of the treated water showed pH 6.8, ORP 430 mV (vs SHE), total suspended solids less than 20 mg/L, ATP reduction of 98% (a 5-8 log reduction of culturable microbes depending on type), amylose was below detection with iodine, foaming potential was nearly eliminated and odors from sulfide, volatile fatty acids, the peracetate chemistry or its byproducts were not perceptible.

The settled solids were drained of water on a filter paper and weighed before and after air drying. There was at least 98% water recovery from treatment. The solids recovered was the equivalent of about 16 pounds of air dried solids per 1000 gallons of water, representing a significant reduction in organic material that could be used for land application or biogas generation instead of being treated as biological oxygen demand in effluent.

This same water sample was tested again for odor and microbial control without clarification and removal of solids and reduction of catalase load. To enable this treatment process the peracetate product was acidified with enough excess acid to reduce the pH of the water to a point of inhibiting or denaturing the catalase enzyme.

### EXEMPLARY IMPLEMENTATION COMBINATIONS

Some other contemplated example combinations related to implementation of various aspects of this disclosure, with or without additional features as disclosed above or elsewhere herein, are summarized in the numbered paragraphs presented below, and in the appended

### Methods of Preparation

1. A method for preparing a nonequilibrium peracid salt composition prior to use for oxidative treatment, and optionally with generation of singlet oxygen during an oxidative treatment, the method comprising:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor groups in a range of from 0.95 to 1.40; and
   a second molar ratio of hydrogen peroxide to the acyl donor groups in a range of from 0.80 to 1.10; and
continuing the reacting at least until the nonequilibrium peracid salt composition is prepared including the composition properties.

2. The method of paragraph 1, wherein the first molar ratio is at least 1.00.

3. The method of paragraph 1, wherein the first molar ratio is at least 1.02.

4. The method of paragraph 1, wherein the first molar ratio is at least 1.05.

5. The method of paragraph 1, wherein the first molar ratio is at least 1.07.

5.1 The method of paragraph 1, wherein the first molar ratio is at least 1.10.

6. The method of any one of paragraphs 1-5.1, wherein the first molar ratio is no larger than 1.30.

6.1. The method of any one of paragraphs 1-5.1, wherein the first molar ratio is no larger than 1.25.

7. The method of any one of paragraphs 1-5.1, wherein the first molar ratio is no larger than 1.20.

8. The method of any one of paragraphs 1-5.1, wherein the first molar ratio is no larger than 1.15.

9. The method of any one of paragraphs 1-5.1, wherein the first molar ratio is no larger than 1.12.

10. The method of any one of paragraphs 1-9, wherein the pH is at least 12.1.

11. The method of any one of paragraphs 1-9, wherein the pH is at least 12.2.

12. The method of any one of paragraphs 1-9, wherein the pH is at least 12.3.

13. The method of any one of paragraphs 1-9, wherein the pH is at least 12.4.

14. The method of any one of paragraphs 1-9, wherein the pH is at least 12.5.

14.1 The method of any one of paragraphs 1-9, wherein the pH is at least 12.6.

14.2 The method of any one of paragraphs 1-9, wherein the pH is at least 12.7.

15. The method of any one of paragraphs 1-14.2, wherein the pH is no larger than 13.3.

16. The method of any one of paragraphs 1-14.2, wherein the pH is no larger than 13.2.

17. The method of any one of paragraphs 1-14.2, wherein the pH is no larger than 13.1.

18. The method of any one of paragraphs 1-14.2, wherein the pH is no larger than 13.0.

19. The method of any one of paragraphs 1-14.2, wherein the pH is no larger than 12.9.

20. The method of any one of paragraphs 1-19, wherein the composition properties comprise a concentration of dissolved hydrogen peroxide of no larger than 1600 mg/L.

21. The method of any one of paragraphs 1-19, wherein the composition properties comprise a concentration of dissolved hydrogen peroxide of no larger than 1400 mg/L.

22. The method of any one of paragraphs 1-19, wherein the composition properties comprise a concentration of dissolved hydrogen peroxide of no larger than 1200 mg/L.

23. The method of any one of paragraphs 1-19, wherein the composition properties comprise a concentration of dissolved hydrogen peroxide of no larger than 1000 mg/L.

24. The method of any one of paragraphs 1-19, wherein the composition properties comprise a concentration of dissolved hydrogen peroxide of no larger than 800 mg/L.

25. The method of any one of paragraphs 1-19, wherein the composition properties comprise a concentration of dissolved hydrogen peroxide of no larger than 600 mg/L.

26. The method of any one of paragraphs 1-25, wherein the composition properties comprise a molar ratio of dissolved hydrogen peroxide to the peracid anion of no larger than ⅙.

27. The method of any one of paragraphs 1-25, wherein the composition properties comprise a molar ratio of dissolved hydrogen peroxide to the peracid anion of no larger than 1/10.

28. The method of any one of paragraphs 1-25, wherein the composition properties comprise a molar ratio dissolved hydrogen peroxide to the peracid anion of no larger than 1/16.

29. The method of any one of paragraphs 1-25, wherein the composition properties comprise a molar ratio of dissolved hydrogen peroxide to the peracid anion of no larger than 1/20.

30. The method of any one of paragraphs 1-25, wherein the composition properties comprise a molar ratio of dissolved hydrogen peroxide to the peracid anion of no larger than 1/25.

30.1 The method of any one of paragraphs 1-30, wherein the composition as prepared is in a relatively stable form for short-term storage and handling prior to use.

31. The method of any one of paragraphs 1-30.1, wherein the composition properties comprise a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

32. The method of paragraph 31, wherein the 10-minute stability index is at least 0.83.

33 The method of paragraph 31, wherein the 10-minute stability index is at least 0.85.

34. The method of paragraph 31, wherein the 10-minute stability index is at least 0.88.

35. The method of paragraph 31, wherein the 10-minute stability index is at least 0.90.

36. The method of paragraph 31, wherein the 10-minute stability index is at least 0.92.

37. The method of paragraph 31, wherein the 10-minute stability index is at least 0.94.

38. The method of any one of paragraphs 31-37, wherein the 10-minute stability index is no larger than 1.00.

39. The method of any one of paragraphs 31-37, wherein the 10-minute stability index is no larger than 0.99.

40. The method of any one of paragraphs 31-37, wherein the 10-minute stability index is no larger than 0.98.

41. The method of any one of paragraphs 31-37, wherein the 10-minute stability index is no larger than 0.96.

42. The method of any one of paragraphs 1-41, wherein the composition properties comprise a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

43. The method of paragraph 42, wherein the 30-minute stability index is at least 0.70.

44. The method of paragraph 42, wherein the 30-minute stability index is at least 0.73.

45. The method of paragraph 42, wherein the 30-minute stability index is at least 0.76.

46. The method of paragraph 42, wherein the 30-minute stability index is at least 0.78.

47. The method of paragraph 42, wherein the 30-minute stability index is at least 0.80.

48. The method of paragraph 42, wherein the 30-minute stability index is at least 0.82.

49. The method of any one of paragraphs 42-48, wherein the 30-minute stability index is no larger than 0.95.

50. The method of any one of paragraphs 42-48, wherein the 30-minute stability index is no larger than 0.92.

51. The method of any one of paragraphs 42-48, wherein the 30-minute stability index is no larger than 0.90.

52. The method of any one of paragraphs 42-48, wherein the 30-minute stability index is no larger than 0.88.

53. The method of any one of paragraphs 42-48, wherein the 30-minute stability index is no larger than 0.85.

54. The method of any one of paragraphs 1-53, wherein the composition properties comprise:
the 10-minute stability index recited in any of the preceding numbered paragraphs; and
the 30-minute stability index recited in any of the preceding numbered paragraphs;
and wherein the 30-minute stability index is smaller than the 10-minute stability index.

55. The method of paragraph 54, wherein the 30-minute stability index is smaller than the 10-minute stability index by at least 0.05.

56. The method of paragraph 54, wherein the 30-minute stability index is smaller than the 10-minute stability index by at least 0.10.

57. The method of any one of paragraphs 54-56, wherein the 30-minute stability index is smaller than the 10-minute stability index by an amount no larger than 0.20.

58. The method of any one of paragraphs 54-56, wherein the 30-minute stability index is smaller than the 10-minute stability index by an amount no larger than 0.15.

59. The method of any one of paragraphs 1-58, wherein the second molar ratio is at least 0.83.

60. The method of any one of paragraphs 1-58, wherein the second molar ratio is at least 0.85.

61. The method of any one of paragraphs 1-58, wherein the second molar ratio is at least 0.87.

62 The method of any one of paragraphs 1-58, wherein the second molar ratio is at least 0.90.

63. The method of any one of paragraphs 1-58, wherein the second molar ratio is at least 0.92.

64. The method of any one of paragraphs 1-58, wherein the second molar ratio is at least 0.95.

65. The method of any one of paragraphs 1-64, wherein the second molar ratio is no larger than 1.05.

66. The method of any one of paragraphs 1-64, wherein the second molar ratio is no larger than 1.02.

67. The method of any one of paragraphs 1-64, wherein the second molar ratio is no larger than 1.00.

68. The method of any one of paragraphs 1-64, wherein the second molar ratio is no larger than 0.99.

69. The method of any one of paragraphs 1-64, wherein the second molar ratio is no larger than 0.97.

70. The method of any one of paragraphs 1-64, wherein the second molar ratio is no larger than 0.95.

71. The method of any one of paragraphs 1-63, wherein the second molar ratio is no larger than 0.92.

72. The method of any one of paragraphs 1-62, wherein the second molar ratio is no larger than 0.90.

73. The method of any one of paragraphs 1-72, wherein the composition properties comprise a weight ratio of total organic carbon to the peracid anion of no larger than 0.60. The weight ratio is determined as the weight, or mass, of the total amount of organic carbon in the composition (including in the peracid anion, in unreacted reactant and in byproducts) divided by the total weight, or mass, of the peracid anions in the composition. As will be appreciated, the total weight, or mass, of a peracid anion includes atomic components other than carbon, such as oxygen and hydrogen components.

74. The method of any one of paragraphs 1-72, wherein the composition properties comprise a weight ratio of total organic carbon to the peracid anion of no larger than 0.59.

75. The method of any one of paragraphs 1-72, wherein the composition properties comprise a weight ratio of total organic carbon to the peracid anion of no larger than 0.58.

76. The method of any one of paragraphs 1-72, wherein the composition properties comprise a weight ratio of total organic carbon to the peracid anion of no larger than 0.57.

77. The method of any one of paragraphs 1-72, wherein the composition properties comprise a weight ratio of total organic carbon to the peracid anion of no larger than 0.55.

78. The method of any one of paragraphs 1-72, wherein the composition properties comprise a weight ratio of total organic carbon to the peracid anion of no larger than 0.53 79. The method of any one of paragraphs 1-78, wherein the composition properties comprise a weight ratio of total organic carbon to the peracid anion of at least 0.48.

80. The method of any one of paragraphs 1-78, wherein the composition properties comprise a weight ratio of total organic carbon to the peracid anion of at least 0.50.

81. The method of any one of paragraphs 1-78, wherein the composition properties comprise a weight ratio of total organic carbon to the peracid anion of at least 0.52.

82. The method of any one of paragraphs 1-77 wherein the composition properties comprise a weight ratio of total organic carbon to the peracid anion of at least 0.54.

83. The method of any one of paragraphs 1-82, wherein the composition properties comprise a molar ratio of the peracid anion to the peracid of at least 10,000.

84. The method of any one of paragraphs 1-82, wherein the composition properties comprise a molar ratio of the peracid anion to the peracid of at least 15,000.

85. The method of any one of paragraphs 1-82, wherein the composition properties comprise a molar ratio of the peracid anion to the peracid of at least 18,000.

86. The method of any one of paragraphs 1-85, wherein the composition properties comprise a molar ratio of the peracid anion to the peracid of no larger than 40,000.

87. The method of any one of paragraphs 1-85, wherein the composition properties comprise a molar ratio of the peracid anion to the peracid of no larger than 38,000.

88. The method of any one of paragraphs 1-87, wherein the chemical feedstocks for the aqueous reaction mixture are in amounts and proportions to prepare the nonequilibrium peracid salt composition with the composition properties at a first yield of the peracid anion relative to the acyl donor groups of at least 75%.

89. The method of paragraph 88, wherein the first yield is at least 78%.

90. The method of paragraph 88, wherein the first yield is at least 80%.

91. The method of paragraph 88, wherein the first yield is at least 83%.

92 The method of paragraph 88, wherein the first yield is at least 85%.

93. The method of paragraph 88, wherein the first yield is at least 87%.

94. The method of paragraph 88, wherein the first yield is at least 89%.

95. The method of any one of paragraphs 88-94, wherein the first yield is no larger than 97%.

96. The method of any one of paragraphs 88-94, wherein the first yield is no larger than 95%.

97. The method of any one of paragraphs 88-94, wherein the first yield is no larger than 93%.

98. The method of any one of paragraphs 88-94, wherein the first yield is no larger than 90%.

99. The method of any one of paragraphs 1-98, wherein the chemical feedstocks for the aqueous reaction mixture or in amounts and proportions to prepare the nonequilibrium peracid salt composition with the composition properties at a second yield of the peracid anion relative to the hydrogen peroxide of at least 85%.

100. The method of paragraph 99, wherein the second yield is at least 88%.

101. The method of paragraph 99, wherein the second yield is the least 90%.

102. The method of paragraph 99, wherein the second yield is at least 92%.

103. The method of paragraph 99, wherein the second yield is at least 94%.

104. The method of paragraph 99, wherein the second yield is at least 96%.

105. The method of paragraph 99, wherein the second yield is at least 97%.

106. The method of any one of paragraphs 1-105, comprising the first yield of any one of paragraphs 88-98 and the second yield of any one of paragraphs 99-105, and wherein the first yield and the second yield are equal or differ by no more than 15 percentage points.

107. The method of paragraph 106, wherein the first yield and the second yield are equal or differ by no more than 12 percentage points.

108. The method of paragraph 106, wherein the first yield and the second yield are equal or differ by no more than 10 percentage points.

109. The method of paragraph 106, wherein the first yield and the second yield are equal or differ by no more than eight percentage points.

110. The method of paragraph 106, wherein the first yield and the second yield are equal or differ by no more than six percentage points.

111. The method of any one of paragraphs 106-110, wherein the first yield is larger than the second yield.

112. The method of any one of paragraphs 106-110, wherein the second yield is larger than the first yield.

113. The method of any one of paragraphs 1-112, wherein the nonequilibrium peracid salt composition is a nonequilibrium peracetic acid salt composition and the peracid anion is peracetate.

114. The method of any one of paragraphs 1-113, wherein the composition properties comprise the peracid anion at a concentration of at least 1.5% (weight/volume).

115. The method of any one of paragraphs 1-113, wherein the composition properties comprise the peracid anion at a concentration of at least 2.0% (weight/volume).

116. The method of any one of paragraphs 1-113, wherein the composition properties comprise the peracid anion at a concentration of at least 2.5% (weight/volume).

117. The method of any one of paragraphs 1-113, wherein the composition properties comprise the peracid anion at a concentration of at least 3.0% (weight/volume).

118. The method of any one of paragraphs 1-113, wherein the composition properties comprise the peracid anion at a concentration of at least 3.5% (weight/volume).

119. The method of any one of paragraphs 1-113, wherein the composition properties comprise the peracid anion at a concentration of at least 4.0% (weight/volume).

120. The method of any one of paragraphs 1-113, wherein the composition properties comprise the peracid anion at a concentration of at least 4.5% (weight/volume).

121. The method of any one of paragraphs 1-113, wherein the composition properties comprise the peracid anion at a concentration of at least 5.0% (weight/volume).

122. The method of any one of paragraphs 1-113, wherein the composition properties comprise the peracid anion at a concentration of at least 5.5% (weight/volume).

123. The method of any one of paragraphs 1-113, wherein the composition properties comprise the peracid anion at a concentration of at least 6.0% (weight/volume).

124. The method of any one of paragraphs 1-113, wherein the composition properties comprise the peracid anion at a concentration of at least 6.5% (weight/volume).

125. The method of any one of paragraphs 1-113, wherein the composition properties comprise the peracid anion at a concentration of at least 7.0% (weight/volume).

126. The method of any one of paragraphs 1-125, wherein the composition properties comprise the peracid anion at a concentration of no larger than 8.0% (weight/volume).

127. The method of any one of paragraphs 1-125, wherein the composition properties comprise the peracid anion at a concentration of no larger than 7.5% (weight/volume).

128. The method of any one of paragraphs 1-125, wherein the composition properties comprise the peracid anion at a concentration of no larger than 7.0% (weight/volume).

129. The method of any one of paragraphs 1-124, wherein the composition properties comprise the peracid anion at a concentration of no larger than 6.5% (weight/volume).

130. The method of any one of paragraphs 1-123, wherein the composition properties comprise the peracid anion at a concentration of no larger than 6.0% (weight/volume).

131. The method of any one of paragraphs 1-122, wherein the composition properties comprise the peracid anion at a concentration of no larger than 5.5% (weight/volume).

132. The method of any one of paragraphs 1-121, wherein the composition properties comprise the peracid anion at a concentration of no larger than 5.0% (weight/volume).

133. The method of any one of paragraphs 1-120, wherein the composition properties comprise the peracid anion at a concentration of no larger than 4.5% (weight/volume).

134. The method of any one of paragraphs 1-119, wherein the composition properties comprise the peracid anion at a concentration of no larger than 4.0% (weight/volume).

135. The method of any one of paragraphs 1-118, wherein the composition properties comprise the peracid anion at a concentration of no larger than 3.5% (weight/volume).

136. The method of any one of paragraphs 1-117, wherein the composition properties comprise the peracid anion at a concentration of no larger than 3.0% (weight/volume).

137. The method of any one of paragraphs 1-116, wherein the composition properties comprise the peracid anion at a concentration of no larger than 2.5% (weight/volume).

138. The method of any one of paragraphs 1-115, wherein the composition properties comprise the peracid anion at a concentration of no larger than 2.0% (weight/volume).

139. The method of any one of paragraphs 1-113, 117-124 and 130-136, wherein:
the first molar ratio is in a range of from 1.00 to 1.30;
the second molar ratio is in a range of from 0.83 to 1.00;
the composition properties comprise;
   the peracid anion at a concentration in a range of from 3.0% (weight/volume) to 6.5% (weight/volume);
   a 10-minute stability index (SI₁₀) of at least 0.85 calculated according to Equation I;
   a concentration of hydrogen peroxide of no larger than 1200 mg/L; and
   a pH of at least 12.1; and
the chemical feedstocks for the aqueous reaction mixture are in amounts and proportions to prepare the nonequilibrium peracid salt composition with the composition properties at a first yield of the peracid anion relative to the acyl donor groups of at least 80% and a second yield of the peracid anion relative to hydrogen peroxide of at least 90%.

140. The method of paragraph 139, wherein:
the first molar ratio being at least 1.02;
the second molar ratio being at least 0.85; and
the composition properties comprise a pH of at least 12.3.

141. The method of either one of paragraph 139 or paragraph 140, wherein the composition properties comprise a weight ratio of total organic carbon to the peracid anion of no larger than 0.58.

142. The method of any one of paragraphs 139-141, wherein:
the first molar ratio is at least 1.05;
the second molar ratio is at least 0.87; and
the composition properties comprise a pH of at least 12.4.

143. The method of any one of paragraphs 139-142, wherein the first molar ratio is no larger than 1.20.

144. The method of any one of paragraphs 139-143, wherein the second molar ratio is no larger than 0.97.

145. The method of any one of paragraphs 1-117 and 136-138, wherein:
the first molar ratio is in a range of from 1.05 to 1.30;
the second molar ratio is in a range of from 0.80 to 0.95;
the composition properties comprise;
   the peracid anion at a concentration in a range of from 1.5% (weight/volume) to 3.0% (weight/volume);
   a 10-minute stability index (SI₁₀) of at least 0.90 calculated according to Equation I;
   a concentration of hydrogen peroxide of no larger than 1200 mg/L; and
   a pH of at least 12.3; and
the chemical feedstocks for the aqueous reaction mixture are in amounts and proportions to prepare the nonequilibrium peracid salt composition with the composition properties at a first yield of the peracid anion relative to the acyl donor groups of at least 75% and a second yield of the peracid anion relative to hydrogen peroxide of at least 88%.

146. The method of any one of paragraphs 1-130, wherein:
the first molar ratio is in a range of from 1.00 to 1.30;
the second molar ratio is in a range of from 0.85 to 1.00;
the composition properties comprise;
   the peracid anion at a concentration in a range of from 6.0% (weight/volume) to 8.0% (weight/volume);
   a 10-minute stability index (SI₁₀) of at least 0.88 calculated according to Equation I;
   a concentration of hydrogen peroxide of no larger than 1200 mg/L; and
   a pH of at least 12.2; and
the chemical feedstocks for the aqueous reaction mixture are in amounts and proportions to prepare the nonequilibrium peracid salt composition with the composition properties at a first yield of the peracid anion relative to the acyl donor groups of at least 80% and a second yield of the peracid anion relative to hydrogen peroxide of at least 86%.

147. The method of any one of paragraphs 1-146, comprising mixing the reaction mixture during the reacting.

148. The method of any one of paragraphs 1-147, comprising preparing the reaction mixture, the preparing the reaction mixture comprising combining a first feedstock preparation comprising an alkaline hydrogen peroxide solution with a second feedstock preparation comprising the acyl donor;
optionally, the method comprises preparing the first feedstock preparation; and
optionally, the method comprises preparing the second feedstock preparation.

149. The method of any one of paragraphs 1-148, wherein the combination of reaction feedstocks comprises a third molar ratio of the alkali metal hydroxide to hydrogen peroxide in a range of from 1.00 to 1.63, and optionally the alkaline hydrogen peroxide solution of the first feedstock preparation of paragraph 148 is a preparation with the alkali metal hydroxide and hydrogen peroxide in the third molar ratio.

150. The method of paragraph 149, wherein the third molar ratio is at least 1.05.

151. The method of paragraph 149, wherein the third molar ratio is at least 1.10.

152. The method of paragraph 149, wherein the third molar ratio is at least 1.15.

153. The method of paragraph 149, wherein the third molar ratio is at least 1.20.

154. The method of paragraph 149, wherein the third molar ratio is at least 1.25.

155. The method of paragraph 149, wherein the third molar ratio is at least 1.30.

156. The method of paragraph 149, wherein the third molar ratio is at least 1.35.

157. The method of paragraph 149, wherein the third molar ratio is at least 1.40.

158. The method of paragraph 149, wherein the third molar ratio is at least 1.45.

159. The method of paragraph 149, wherein the third molar ratio is at least 1.50.

160. The method of paragraph 149, wherein the third molar ratio is at least 1.55.

161. The method of any one of paragraphs 149-160, wherein the third molar ratio is no larger than 1.60.

162. The method of any one of paragraphs 149-160, wherein the third molar ratio is no larger than 1.55.

163. The method of any one of paragraphs 149-159, wherein the third molar ratio is no larger than 1.50.

164. The method of any one of paragraphs 149-158, wherein the third molar ratio is no larger than 1.45.

165. The method of any one of paragraphs 149-157, wherein the third molar ratio is no larger than 1.40.

166. The method of any one of paragraphs 149-156, wherein the third molar ratio is no larger than 1.35.

167. The method of any one of paragraphs 149-155, wherein the third molar ratio is no larger than 1.30.

168. The method of any one of paragraphs 149-154, wherein the third molar ratio is no larger than 1.25.

169. The method of any one of paragraphs 149-153, wherein the third molar ratio is no larger than 1.20.

170. The method of any one of paragraphs 1-169, wherein the acyl donor is an acetyl donor and the acyl donor groups are acetyl donor groups.

171. The method of paragraph 170, wherein the acetyl donor comprises triacetin.

172. The method of either one of paragraph 170 or paragraph 171, wherein the acetyl donor comprises acetylsalicylic acid.

172.1. The method of any one of paragraphs 1-172, wherein the nonequilibrium peracid salt composition is for oxidative treatment of a substrate.

172.2 The method of paragraph 172.1, wherein the substrate comprises a slurry, optionally in a slurry with aqueous liquid.

172.3 The method of paragraph 172.1, wherein the substrate comprises microbes. 172.4 The method of paragraph 172.1, wherein the substrate comprises an aqueous liquid, optionally water to be treated.

172.5 The method of paragraph 172.1, wherein the substrate comprises a surface of a solid object.

172.6 The method of paragraph 172.1, wherein the substrate comprises a food product to be sanitized, optionally prior to consumption of the food product or a prepared food prepared (e.g., cooked) from the food product.

172.7 The method of paragraphs 172.6, wherein the method is for sanitizing the food product for food safety and/or preservation.

172.8 The method of either one of paragraphs 172.6 or 172.7, wherein the food product comprises a vegetable.

172.9 The method of either one of paragraphs 172.6 or 172.7, wherein the food product comprises a meat.

173. The method of any one of paragraphs 170-172.9, wherein the acetyl donor comprises tetraacetylethylenediamine.

173.1 The method of any one of paragraphs 1-173, wherein the prepared nonequilibrium peracid salt solution is the nonequilibrium peracid salt composition of any one of paragraphs 203-296.

### Methods of Treatment

174. A method of oxidative treatment of a substrate, comprising:
preparing a nonequilibrium peracid salt composition according to the method of any one of paragraphs 1-173.1; and
contacting the substrate with a nonequilibrium treatment composition, wherein the nonequilibrium treatment composition comprises:
   the nonequilibrium peracid salt composition without an additive to adjust composition properties prior to the contacting; or
   a nonequilibrium adjusted composition prepared by adding one or more additives to the nonequilibrium peracid-based composition (the nonequilibrium peracid salt composition) prior to the contacting.

175. A method of oxidative treatment of a substrate, comprising:
contacting the substrate with a nonequilibrium treatment composition comprising:
   the nonequilibrium peracid salt composition prepared according to the method of any one of paragraphs 1-173.1 and without an additive to adjust composition properties prior to the contacting; or
   a nonequilibrium adjusted composition prepared by adding one or more additives to the nonequilibrium peracid-based composition (the nonequilibrium peracid salt composition) prior to the contacting.

175.1. A method of oxidative treatment of a substrate, comprising:
contacting the substrate with a nonequilibrium treatment composition, wherein the nonequilibrium treatment composition comprises:
   the nonequilibrium peracid salt composition of any one of paragraphs 203-297 and without an additive to adjust composition properties prior to the contacting; or
   a nonequilibrium adjusted composition prepared by adding one or more additives to the nonequilibrium peracid-based composition (the nonequilibrium peracid salt composition) prior to the contacting.

176. Use of nonequilibrium peracid salt composition prepared according to the method of any one of paragraphs 1-173.1 for oxidative treatment of a substrate.

176.1. The use of paragraph 176, comprising contacting the substrate with a nonequilibrium treatment composition comprising:
the nonequilibrium peracid salt composition without an additive to adjust composition properties prior to the contacting; or
a nonequilibrium adjusted composition prepared by adding one or more additives to the nonequilibrium peracid salt composition prior to the contacting.

177. The method or use of any one of paragraphs 174-176.1, wherein the contacting is at a pH that is lower than a pH of the nonequilibrium peracid salt composition immediately prior to the contacting.

178. The method or use of paragraph 177, wherein the contacting is at a pH at least one-half pH unit smaller than the pH of the nonequilibrium treatment composition immediately prior to the contacting.

179. The method or use of paragraph 177, wherein the contacting is at a pH at least one pH unit smaller than the pH of the nonequilibrium treatment composition immediately prior to the contacting.

180. The method or use of paragraph 177, wherein the contacting is at a pH at least two pH units smaller than the pH of the nonequilibrium treatment composition immediately prior to the contacting.

181. The method or use of paragraph 177, wherein the contacting is at a pH at least three pH units smaller than the pH of the nonequilibrium treatment composition immediately prior to the contacting.

182. The method or use of paragraph 177, wherein the contacting is at a pH at least four pH units smaller than the pH of the nonequilibrium treatment composition immediately prior to the contacting.

183. The method or use of any one of paragraphs 174-182, wherein the substrate comprises an aqueous liquid at a pH at least one pH unit smaller than the pH of the nonequilibrium treatment composition immediately prior to the contacting.

184. The method or use of any one of paragraphs 174-182, wherein the substrate comprises an aqueous liquid at a pH at least two pH units smaller than the pH of the nonequilibrium treatment composition immediately prior to the contacting.

185. The method or use of any one of paragraphs 174-182, wherein the substrate comprises an aqueous liquid at a pH at least three pH units smaller than the pH of the nonequilibrium treatment composition immediately prior to the contacting.

186. The method or use of any one of paragraphs 174-182, wherein the substrate comprises an aqueous liquid at a pH at least four pH units smaller than the pH of the nonequilibrium treatment composition immediately prior to the contacting.

186.1. The method or use of any one of paragraphs 174-186, wherein the substrate comprises a water to be treated.

186.2. The method or use of any one of paragraphs 174-182, wherein the substrate comprises a surface of a solid object, and optionally to clean and/or sanitize the surface.

186.3. The method or use of paragraph 186.2, wherein the surface of the solid object is dry immediately prior to the contacting.

186.4 The method or use of paragraph 186.2, wherein the surface of the solid object is wet, optionally wet with an aqueous liquid, prior to the contacting.

186.5 The method or use of any one of paragraphs 174-186.4, wherein the nonequilibrium treatment composition comprises the nonequilibrium peracid salt composition without an additive to adjust composition properties prior to the contacting.

186.6 the method or use of any one of paragraphs 174-186.4, wherein the nonequilibrium treatment composition comprises the nonequilibrium adjusted composition and the method or use comprises preparing the nonequilibrium adjusted composition.

### Pulp Processing

187. The method or use of any one of paragraphs 174-186.1, wherein the substrate comprises pulp, optionally in a slurry comprising an aqueous liquid and the pulp to be oxidatively treated, and optionally to delignify and/or bleach and/or brighten the pulp.

187.1. The method of paragraph 187, wherein the pulp is at a pH of no greater than pH 12.9 immediately preceding the contacting.

187.2. The method or use of either one of paragraph 187 or paragraph 187.1, wherein the pulp is at a pH of at least 6.0 immediately preceding the contacting.

187.3. The method or use of any one of paragraphs 187-187.2, wherein the pulp is at a pH of at least 9.0 immediately preceding the contacting.

187.4. The method or use of any one of paragraphs 187-187.3, wherein the pulp is at a pH of no greater than pH 12.5 immediately preceding the contacting.

187.5. The method or use of any one of paragraphs 187-187.4, wherein the pulp is at a pH of no greater than pH 12.0 immediately preceding the contacting.

187.6. The method or use of any one of paragraphs 187-187.5, wherein the pulp is at a pH of no greater than pH 11.5 immediately preceding the contacting.

187.7. The method or use of any one of paragraphs 187-187.6, wherein the pulp is at a pH of no greater than pH 11.0 immediately preceding the contacting.

187.8. The method or use of any one of paragraphs 187-187.7, wherein the pulp is at a pH of at least pH 9.5 immediately preceding the contacting.

187.9. The method or use of any one of paragraphs 187-187.8, comprising mixing a mixture with the pulp after addition of the of the nonequilibrium treatment composition, wherein the mixture is at a pH of no greater than 12.9.

187.10. The method or use of paragraph 187.9, wherein the mixture is at a pH of at least 6.0.

187.11. The method or use of either one of paragraph 187.9 or 187.10, wherein the mixture is at a pH of at least 9.0.

187.12. The method or use of any one of paragraphs 187.9-187.11, wherein the mixture is at a pH of no greater than 12.5.

187.13. The method or use of any one of paragraphs 187.9-187.12, wherein the mixture is at a pH of no greater than 12.0.

187.14. The method or use of any one of paragraphs 187.9-187.13, wherein the mixture is at a pH of no greater than 11.5.

187.15. The method or use of any one of paragraphs 187.9-187.14, wherein the mixture is at a pH of no greater than 11.0.

187.16. The method or use of any one of paragraphs 187.9-187.15, wherein the mixture is at a pH of at least 9.5.

187.17. The method or use of any one of any one of paragraphs 187.9-187.16, wherein the mixture is at a temperature in a range of from 38° C. to 95° C.

187.18. The method or use of paragraph 187.17, wherein the mixture is at a temperature of at least 50° C.

187.19. The method or use of either one of paragraph 187.17 or paragraph 187.18, wherein the mixture is at a temperature of at least 60° C.

187.20. The method or use of any one of paragraphs 187.17-187.19, wherein the mixture is at a temperature of no larger than 80° C.

187.21. The method or use of any one of paragraphs 187.17-187.20, wherein the mixture is at a temperature of no larger than 70° C.

187.22. The method or use of any one of paragraphs 187.17-187.21, wherein the mixture is at a temperature in a range of from 50° to 80° C.

187.23. The method or use of any one of paragraphs 187-187.22, wherein the pulp is at a temperature in a range of from 38° C. to 95° C. immediately prior to the contacting.

187.24. The method or use of paragraph 187.23, wherein the pulp is at a temperature of at least 50° C. immediately prior to the contacting.

187.25. The method or use of either one of paragraph 187.23 or paragraph 187.24, wherein the pulp is at a temperature of at least 60° C. immediately prior to the contacting.

187.26. The method or use of any one of paragraphs 187.23-187.25, wherein the pulp is at a temperature of no larger than 80° C. immediately prior to the contacting.

187.27. The method or use of any one of paragraphs 187.23-187.26, wherein the pulp is at a temperature of no larger than 70° C. immediately prior to the contacting.

187.28. The method or use of any one of paragraphs 187.23-187.27, wherein the pulp is at a temperature in a range of from 50° to 80° C. immediately prior to the contacting.

187.29. The method or use of any one of paragraphs 187-187.28, wherein the nonequilibrium treatment composition is at a temperature of no greater than 40° C. immediately prior to the contacting.

187.30. The method or use of any one of paragraphs 187-187.29, wherein the nonequilibrium treatment composition is at a temperature of no greater than 35° C. immediately prior to the contacting.

187.31. The method or use of any one of paragraphs 187-187.30, wherein the nonequilibrium treatment composition is at a temperature of no greater than 30° C. immediately prior to the contacting.

187.32. The method or use of any one of paragraphs 187-187.31, wherein the nonequilibrium treatment composition is at a temperature of at least 0° C. immediately prior to the contacting.

187.33. The method or use of any one of paragraphs 187-187.32, wherein the nonequilibrium treatment composition is at a temperature of at least 10° C. immediately prior to the contacting.

187.34. The method or use of any one of paragraphs 187-187.33, comprising applying the nonequilibrium treatment composition to the pulp for the contacting not more than 60 minutes after preparation of the nonequilibrium treatment composition.

187.35. The method or use of any one of paragraphs 187-187.34, comprising applying the nonequilibrium treatment composition to the pulp for the contacting not more than 45 minutes after preparation of the nonequilibrium treatment composition.

187.36. The method or use of any one of paragraphs 187-187.35, comprising applying the nonequilibrium treatment composition to the pulp for the contacting not more than 30 minutes after preparation of the nonequilibrium treatment composition.

187.37. The method or use of any one of paragraphs 187-187.36, comprising applying the nonequilibrium treatment composition to the pulp for the contacting not more than 20 minutes after preparation of the nonequilibrium treatment composition.

187.38. The method or use of any one of paragraphs 187-187.37, comprising applying the nonequilibrium treatment composition to the pulp for the contacting not sooner than 1 minute after preparation of the nonequilibrium treatment composition.

187.39. The method or use of any one of paragraphs 187-187.38, comprising applying the nonequilibrium treatment composition to the pulp for the contacting not sooner than three minutes after preparation of the nonequilibrium treatment composition.

187.40. The method or use of any one of paragraphs 187-187.39, comprising delignifying the pulp, the delignifying comprising the contacting the pulp with the nonequilibrium treatment composition.

187.41. The method or use of any one of paragraphs 187-187.40, wherein the delignifying comprises, after the contacting, extracting the pulp with a peroxide-containing extraction composition to extract lignin from the pulp.

187.42. The method of paragraph 187-187.41, comprising, after the delignifying, bleaching the pulp.

187.43. The method of paragraph 187.42, wherein the bleaching comprises treating the pulp with carbon dioxide.

187.44. The method or use of paragraph 187.43, comprising after treating the pulp with carbon dioxide, treating the pulp with a nonequilibrium peracid composition, the treating the pulp with a nonequilibrium peracid composition comprising:
acidifying a nonequilibrium peracid salt composition to prepare an acidified nonequilibrium peracid composition; and
contacting the pulp with the acidified nonequilibrium peracid composition.

187.45. The method or use of paragraph 187.44, wherein the nonequilibrium peracid salt composition subjected to the acidifying comprises:
a nonequilibrium peracid salt composition prepared by the method or use of any one of paragraphs 1-173.1; or
a nonequilibrium peracid salt composition of any one of paragraphs 203-297.

187.46. The method or use of either one of paragraph 187.44 or 187.45, wherein the acidifying comprises adding an acidulant to the nonequilibrium peracid salt composition subjected to the acidifying.

187.47. The method or use of paragraph 187.46, wherein the acidulant comprises an inorganic acid, optionally a mineral acid.

187.48. The method or use of either one of paragraph 187.46 or paragraph 187.47, wherein the acidulant is substantially in the absence of an organic acid.

187.49. The method or use of any one of paragraphs 187.44-187.48, wherein the acidifying comprises reducing the pH of the nonequilibrium peracid salt composition to prepare the acidified nonequilibrium peracid composition at a pH of not larger than pH 7.0.

187.50. The method or use of paragraph 187.49, wherein the pH of the acidified nonequilibrium peracid composition is not larger than pH 6.0.

187.51. The method or use of either one of paragraph 187.49 or 187.50, wherein the pH of the acidified nonequilibrium peracid composition is not larger than pH 5.5.

187.52. The method or use of any one of paragraphs 187.49-187.51, wherein the pH of the acidified nonequilibrium peracid composition is not smaller than pH 2.0.

187.53. The method or use of any one of paragraphs 187.49-187.52, wherein the pH of the acidified nonequilibrium peracid composition is not smaller than pH 3.0.

187.54. The method or use of any one of paragraphs 187.44-187.53, wherein a temperature of the pulp immediately prior to the contacting with the acidified nonequilibrium peracid composition is at a temperature according to any of the temperature features recited in any of paragraphs 187.23-187.28.

187.55. The method or use of any one of paragraphs 187.44-187.54, wherein a temperature of the acidified nonequilibrium peracid composition immediately prior to the contacting the pulp is at a temperature according to any of the temperature features recited in any 187.29-187.33.

187.56. The method or use of any one of paragraphs 187.44-187.55, wherein the pulp is at a pH of not larger than pH 6.0 immediately prior to application of the acidified nonequilibrium peracid composition to the pulp for the contacting with the acidified nonequilibrium peracid composition.

187.57. The method or use of any one of paragraphs 187.44-187.56, wherein the pulp is at a pH of not larger than pH 5.0 immediately prior to the application of the acidified nonequilibrium peracid composition to the pulp for the contacting with the acidified nonequilibrium peracid composition pulp.

187.58. The method or use of any one of paragraphs 187.44-187.57, wherein the pulp is at a pH of at least pH 2.0 immediately prior to the application of the acidified nonequilibrium peracid composition to the pulp for the contacting with the acidified nonequilibrium peracid composition pulp.

187.59. The method or use of any one of paragraphs 187.44-187.58, wherein the pulp is at a pH of at least pH 3.0 immediately prior to the application of the acidified nonequilibrium peracid composition to the pulp for the contacting with the acidified nonequilibrium peracid composition pulp.

187.60. The method or use of any one of paragraphs 187-187.59, wherein the nonequilibrium treatment composition comprises the nonequilibrium peracid salt composition without addition of a said additive to the nonequilibrium treatment composition prior to the contacting.

187.61. The method or use of any one of paragraphs 187-187.59, wherein the nonequilibrium treatment composition comprises the nonequilibrium adjusted composition and the method or use comprises preparing the nonequilibrium adjusted composition.

### Food Processing

188. The method or use of any one of paragraphs 174-186.6, wherein the substrate comprises a food processing substrate.

### Food Product

188.1. The method or use of paragraph 188, wherein the food processing substrate comprises a food product for example to be cleaned and/or sanitized.

188.1.2. The method or use of paragraph 188.1, wherein the food product comprises a vegetable, optionally cut pieces of the vegetable.

188.1.3. The method or use of paragraph 188.1.2, wherein the vegetable comprises potato, beans, beets, carrots, corn, cucumber, onion, pepper, artichoke, cabbage, celery, kale, lettuce, broccoli, asparagus, peas, radishes, rice, spinach, cauliflower, eggplant, mushrooms, truffles or turnips, or combinations thereof.

188.1.3.1 The method or use of paragraph 188.1, wherein the food product comprises a fruit.

188.1.3.2 The method of use of paragraph 188.1.3.1, where in the fruit comprises pome, apple, berries, cherries, citrus, peach, plum, olive, banana, dates, melon, persimmon, papaya, pineapple, or tomato, or combinations thereof.

188.1.4 The method or use of paragraph 188.1, wherein the food product comprises a meat, and optionally cut pieces of the meat.

188.1.5. The method or use of paragraph 188.1.4, wherein the meat comprises beef, lamb, veal, turkey, ham, pork, chicken, fish or seafood.

188.1.6. The method or use of any one of paragraphs 188.1-188.1.5, wherein the food product, immediately prior to the contacting, has a pH in a range of from pH 3.0 to pH 7.6.

188.1.7. The method or use of any one of paragraphs 188.1-188.1.6, wherein immediately prior to the contacting the nonequilibrium treatment composition has a pH no more than 2.0 pH units larger than the pH of the food product.

188.1.8. The method or use of any one of paragraphs 188.1-188.1.7, wherein immediately prior to the contacting the nonequilibrium treatment composition has a pH no more than 1.5 pH units larger than the pH of the food product.

188.1.9. The method or use of any one of paragraphs 188.1-188.1.8, wherein immediately prior to the contacting the nonequilibrium treatment composition has a pH no more than 1.0 pH units larger than the pH of the food product.

188.1.10. The method or use of any one of paragraphs 188.1-188.1.9, wherein immediately prior to the contacting the nonequilibrium treatment composition has a pH not less than 2.0 pH units smaller than the pH of the food product.

188.1.11. The method or use of any one of paragraphs 188.1-188.1.10, wherein immediately prior to the contacting the nonequilibrium treatment composition as a pH of not less than 1.5 pH units smaller than the pH of the food product.

188.1.12. The method or use of any one of paragraphs 188.1-188.1.11, wherein immediately prior to the contacting the nonequilibrium treatment composition has a pH of not less than 1.0 pH units smaller than the pH of the food product.

188.1.13. The method or use of any one of paragraphs 188.1-188.1.12, wherein immediately prior to the contacting the nonequilibrium treatment composition has a pH in a range of from pH 2.0 to pH 8.0.

188.1.14. The method or use of any one of paragraphs 188.1-188.1.13, wherein immediately prior to the contacting the nonequilibrium treatment composition has a pH of not larger than pH 7.0.

188.1.15. The method or use of any one of paragraphs 188.1-188.1.14, wherein immediately prior to the contacting the nonequilibrium treatment composition has a pH of not larger than pH 6.0.

188.1.16. The method or use of any one of paragraphs 188.1-188.1.15, wherein immediately prior to the contacting the nonequilibrium treatment composition has a pH of not larger than pH 5.5.

188.1.17. The method or use of any one of paragraphs 188.1-188.1.16, wherein immediately prior to the contacting the nonequilibrium treatment composition has a pH of not smaller than pH 3.0.

188.1.18. The method or use of any one of paragraphs 188.1-188.1.17, wherein immediately prior to the contacting the nonequilibrium treatment composition has a pH of not smaller than the pH 3.5.

188.1.19. The method or use of any one of paragraphs 188.1-188.1.18, wherein immediately prior to the contacting the nonequilibrium treatment composition has a pH of not smaller than pH 4.0.

188.1.20. The method or use of any one of paragraphs 188.1-188.1.19, wherein immediately prior to the contacting the nonequilibrium treatment composition has a combined concentration of peracid anion and peracid, determined as equivalent concentration of the peracid, in a range of from 1 part per million to 8000 parts per million, or in some implementations 1 part per million to 2600 parts per million. As used herein, parts per million refers to parts on a weight basis, unless otherwise stated.

188.1.20.1 The method or use of paragraph 188.1.20, wherein the combined concentration is at least 3 parts per million.

188.1.20.2 The method or use of paragraph 188.1.20, wherein the combined concentration is at least 5 parts per million.

188.1.20.3 The method or use of paragraph 188.1.20, wherein the combined concentration is at least 10 parts per million.

188.1.21. The method or use of paragraph 188.1.20, wherein the combined concentration is at least 20 parts per million.

188.1.22. The method or use of paragraph 188.1.20, wherein the combined concentration is at least 30 parts per million.

188.1.23. The method or use of paragraph 188.1.20, wherein the combined concentration is at least 40 parts per million.

188.1.24. The method or use of paragraph 188.1.20, wherein the combined concentration is at least 50 parts per million.

188.1.25. The method or use of any one of paragraphs 188.1.20-188.1.24, wherein the combined concentration is not larger than 2660 parts per million, or in some implementations not larger than 2340 parts per million.

188.1.25.1 The method or use of any one of paragraphs 188.1.20-188.1.24, wherein the combined concentration is not larger than 2000 parts per million.

188.1.26. The method or use of any one of paragraphs 188.1.20-188.1.24, wherein the combined concentration is not larger than 1300 parts per million.

188.1.27. The method or use of any one of paragraphs 188.1.20-188.1.24, wherein the combined concentration is not larger than 1100 parts per million.

188.1.27.1 The method or use of any one of paragraphs 188.1.20-188.1.24, wherein the combined concentration is not larger than 300 parts per million.

188.1.28. The method or use of any one of paragraphs 188.1.20-188.1.24, wherein the combined concentration of peracetate and peracid is not larger than 200 parts per million.

188.1.28.1 The method or use of any one of paragraphs 188.1.20-188.1.24, wherein the combined concentration is not larger than 110 parts per million.

188.1.29. The method or use of any one of paragraphs 188.1.20-188.1.24, wherein the combined concentration of peracetate and peracid is not larger than 100 parts per million.

188.1.30. The method or use of any one of paragraphs 188.1-188.1.29, wherein the contacting is at a treatment temperature in a range of from 2° C. to 95° C.

188.1.31. The method or use of paragraph 188.1.30, wherein the treatment temperature is at least 10° C.

188.1.32. The method or use of paragraph 188.1.30, wherein the treatment temperature is at least 15° C.

188.1.33. The method or use of paragraph 188.1.30, wherein the treatment temperature is at least 20° C.

188.1.34. The method or use of paragraph 188.1.30, wherein the treatment temperature is at least 38° C.

188.1.35. The method or use of paragraph 188.1.30, wherein the treatment temperature is at least 50° C.

188.1.36. The method or use of paragraph 188.1.30, wherein the treatment temperature is at least 60° C.

188.1.37. The method or use of paragraph 188.1.30, wherein the treatment temperature is at least 65° C.

188.1.38. The method or use of any one of paragraphs 188.130, wherein the treatment temperature is at least 70° C.

188.1.39. The method or use of any one of paragraphs 188.1.30-188.1.34, wherein the treatment temperature is not larger than 40° C.

188.1.40. The method any one of paragraphs 188.1.30-188.1.33, wherein the treatment temperature is not larger than 35° C.

188.1.41. The method or use of any one of paragraphs 188.130-188.1.33, wherein the treatment temperature is not larger than 30° C.

188.1.42. The method or use of any one of paragraphs 188.1.30-188.1.33, wherein the treatment temperature is not larger than 25° C.

188.1.43. The method or use of any one of paragraphs 188.1.39-188.1.1.42, wherein the contacting comprises a cold wash of the food product.

188.1.44. The method or use of any one of paragraphs 188.1.34-188.1.38, wherein treatment temperature is not larger than 85° C.

188.1.45. The method or use of any one of paragraphs 188.1.34-188.1.38, wherein the treatment temperature is not larger than 80° C.

188.1.46. The method or use of any one of paragraphs 188.1.34-188.1.38, wherein the treatment temperature is not larger than 75° C.

188.1.47. The method or use of any one of paragraphs 188.1.34-188.1.38, wherein the treatment temperature is not larger than 70° C.

188.1.48. The method or use of any one of paragraphs 188.1.34-188.1.38 and 188.1.44-188.1-47, wherein the contacting comprises a hot wash of the food product.

188.1.49. The method or use of any one of paragraphs 188.1.34-188.1.38 and 188.1.44-188.1.48, wherein the contacting comprises blanching the food product.

188.1.50. The method or use of any one of paragraphs 188.1.30-188.1.48, comprising blanching the food product, and wherein the contacting is performed prior to the blanching.

188.1.51. The method or use of any one of paragraphs 188.1.30-188.1.48, comprising blanching the food product, and wherein the contacting is performed after the blanching.

188.1.52. The method or use of any one of paragraphs 188.1.6-188.1.51, wherein the food product comprises a vegetable.

188.1.53. The method or use of paragraph 188.1.52, wherein the food product comprises a peeled vegetable.

188.1.54. The method or use of either one of paragraphs 188.1.52 or paragraph 1881.53, wherein the vegetable comprises starch and the method or use comprises a treatment stage to remove starch from the vegetable, optionally the treatment stage comprises blanching and/or a cold wash.

188.1.55. The method or use of paragraph 188.1.54, wherein the contacting is during the treatment stage, optionally during blanching and/or during a cold wash.

188.1.56. The method or use of paragraph 188.1.54, wherein the contacting is prior to the treatment stage.

188.1.57. The method or use of paragraph 188.1.54, wherein the contacting is after the treatment stage.

188.1.58. The method or use of any one of paragraphs 188.1.6-188.1.57, wherein the food product comprises potato.

188.1.59. The method or use of any one of paragraphs 188.1-188.1.58, wherein the contacting comprises contacting the food product with the nonequilibrium treatment composition for a treatment time of at least 1 minute, or even at least 5 minutes.

188.1.60. The method or use of paragraph 188.1.59, wherein the treatment time is no longer than 120 minutes, or even no longer than 60 minutes.

188.1.61 The method or use of any one of paragraphs 188.1-188.1.60, wherein the nonequilibrium treatment composition comprises the nonequilibrium adjusted composition and the method or use comprises preparing the nonequilibrium adjusted composition.

### Food Contact Surface

188.2. The method or use of paragraph 188, wherein the food processing substrate comprises a food contact surface comprising food soil, for example to clean and/or sanitize the food contact surface, and optionally the food contact surface comprises the surface of the solid object of any one of paragraphs 186.2-186.4.

188.2.1. The method or use of paragraph 188.2, wherein the food contact surface comprises a surface of food processing or preparation equipment.

188.2.2. The method or use of paragraph 188.2.1, wherein the food processing or preparation equipment surface comprises an interior surface of a food processing vessel; a food conveyance surface (such as for example a conveyance surface of a belt conveyor, vibratory conveyor, pump or conduit); a food cutting surface; a food cutting blade surface; food blender surface; a food mincer surface; a food grinder surface; a food masher surface; a food cooking surface; a food preparation utensil surface; or combinations thereof.

188.2.3. The method or use of either one of paragraph 188.2.1 or paragraph 188.2.2, wherein the contacting comprises clean-in-place treatment of the food contact surface, and optionally with an automated procedure to provide the nonequilibrium treatment composition to the food contact surface and to drain away the nonequilibrium treatment composition after the contacting.

188.2.4. The method or use of any one of paragraphs 188.2-188.2.3, wherein the contacting comprises contacting the food contact surface with the nonequilibrium treatment composition for a treatment time of at least 1 minute, or even at least 5 minutes.

188.2.5. The method or use of paragraph 188.2.4, wherein the treatment time is no longer than 120 minutes, or even no longer than 60 minutes.

188.2.6. The method or use of either one of paragraph 188.2.4 or paragraph 188.2.5, comprising draining the nonequilibrium treatment composition from the food contact surface following the treatment time.

188.2.7. The method or use of any one of paragraphs 188.2-188.2.6, wherein the contacting comprises soaking the food contact surface with the nonequilibrium treatment composition.

188.2.8. The method or use of any one of paragraphs 188.2-188.2.7, wherein the contacting comprises spraying the nonequilibrium treatment composition on to the food contact surface.

188.2.9. The method or use of any one of paragraphs 188.2-188.2.8, wherein immediately prior to the contacting the nonequilibrium treatment composition has a pH of at least pH 9.0.

188.2.10. The method or use of any one of paragraphs 188.2-188.2.9, wherein immediately prior to the contacting the nonequilibrium treatment composition has a pH of at least pH 9.5.

188.2.11. The method or use of any one of paragraphs 188.2-188.2.10, wherein immediately prior to the contacting the nonequilibrium treatment composition has a pH of at least pH 10.0.

188.2.12. The method or use of any one of paragraphs 188.2-188.2.11, wherein immediately prior to the contacting the nonequilibrium treatment composition has a pH of at least pH 10.5.

188.2.13. The method or use of any one of paragraphs 188.2-188.2.12, wherein immediately prior to the contacting the nonequilibrium treatment composition has a pH of at least pH 11.0.

188.2.14. The method or use of any one of paragraphs 188.2-188.2.13, wherein immediately prior to the contacting the nonequilibrium treatment composition has a pH of at least pH 11.5.

188.2.15. The method or use of any one of paragraphs 188.2-188.2.14, wherein immediately prior to the contacting the nonequilibrium treatment composition has a pH of at least 12.0.

188.2.16. The method or use of any one of paragraphs 188.2-188.2.15, wherein immediately prior to the contacting the nonequilibrium treatment composition has a pH as recited for the nonequilibrium peracid salt composition in any one of paragraphs 10-19.

188.2.17. The method or use of any one of paragraphs 188.2-188.2.16, wherein immediately prior to the contacting, the nonequilibrium treatment composition has composition properties of the nonequilibrium peracid salt composition of any one of paragraphs 1-173.1 and 203-297.

188.2.18. The method or use of any one of paragraphs 188.2-188.2.8, wherein immediately prior to the contacting the nonequilibrium treatment composition has a pH of not larger than pH 9.0, and optionally in a range from pH 2.0 to pH 9.0.

188.2.19. The method or use of paragraph 188.2.18, wherein immediately prior to the contacting the nonequilibrium treatment composition has a pH as recited in any one of paragraphs 188.1.13-188.1.19.

188.2.20. The method or use of any one of paragraphs 188.2-88.2.8, 188.2.18 and 188.2.19, wherein immediately prior to the contacting, the nonequilibrium treatment composition has a combined concentration of peracid anion and peracid, determined as equivalent concentration of the peracid, as recited in any one of paragraphs 188.1.20-188.1.29.

188.2.21. The method or use of any one of paragraphs 188.2-188.2.20, wherein immediately prior to the contacting the nonequilibrium treatment composition is at a temperature in a range of from 38° C. to 95° C.

188.2.22. The method or use of paragraph 188.2.21, wherein immediately prior to the contacting the nonequilibrium treatment composition is at a temperature of at least 50° C.

188.2.23. The method or use of paragraph 188.2.21, wherein immediately prior to the contacting the nonequilibrium treatment composition is at a temperature of at least 60° C.

188.2.24. The method or use of any one of paragraphs 188.2.21-188.2.23, wherein immediately prior to the contacting the nonequilibrium treatment composition is at a temperature of not larger than 80° C.

188.2.25. The method or use of any one of paragraphs 188.2.21-188.2.24, wherein immediately prior to the contacting the nonequilibrium treatment composition is at a temperature of not larger than 70° C.

188.2.26. The method or use of any one of paragraphs 188.2-188.2.25, wherein the food contact surface comprises food soil from processing of a food product recited in any one of paragraphs 188.1.2-188.1.6.

188.2.27. The method or use of any one of paragraphs 188.2-188.2.26, wherein the nonequilibrium treatment composition comprises the nonequilibrium peracid salt composition without an additive to adjust composition properties prior to the contacting.

188.2.28. The method or use of any one of paragraphs 188.2-188.26, wherein the nonequilibrium treatment composition comprises the nonequilibrium adjusted composition and the method or use comprises preparing the nonequilibrium adjusted composition.

### Food Process Water

188.3. The method or use of paragraph 188, wherein the food processing substrate comprises a food process liquid to be treated, the food process liquid comprising food soil contaminants, optionally the food process liquid is an aqueous liquid and further optionally the aqueous liquid or water of any one of paragraphs 183-186.1.

188.3.1. The method or use of paragraph 188.3, wherein food process liquid comprises drainage of used nonequilibrium treatment composition from the processing of paragraph 188.2.3.

188.3.2. The method or use of either one of paragraph 188.3 or paragraph 188.3.1, wherein the food process liquid comprises effluent liquid from contacting a food product during food processing, effluent liquid from cleaning and/or sanitization of food preparation or processing equipment or food preparation utensils, or combinations thereof, and optionally from any equipment recited in paragraph 188.2.2.

188.3.3. The method or use of any one of paragraphs 188.3-188.3.2, wherein immediately prior to the contacting the nonequilibrium treatment composition has composition properties of the nonequilibrium peracid salt composition of any one of paragraphs 1-173.1 and 203-297.

188.3.4. The method or use of any one of paragraphs 188.3-188.3.3, wherein contacting is at a treatment temperature in a range of from 38° C. to 95° C.

188.3.5. The method or use of paragraph 188.3.4, wherein the treatment temperature is at least 50° C.

188.3.6. The method or use of paragraph 188.3.4, wherein the treatment temperature is at least 60° C.

188.3.7. The method or use of paragraph 188.3.4, wherein the treatment temperature is at least 65° C.

188.3.8. The method or use of paragraph 188.3.4, wherein the treatment temperature is at least 70° C.

188.3.9. The method or use of any one of paragraphs 188.3.4-188.3.8, wherein the treatment temperature is not larger than 85° C.

188.3.10. The method or use of any one of paragraphs 188.3.4-188.3.8, wherein the treatment temperature is not larger than 80° C.

188.3.11. The method or use of any one of paragraphs 188.3.4-188.3.8, wherein the treatment temperature is not larger than 75° C.

188.3.12. The method or use of any one of paragraphs 188.3.4-88.3.8, wherein the treatment temperature is not larger than 70° C.

188.3.13. The method or use of any one of paragraphs 188.3-188.3.12, wherein immediately prior to the contacting the processing liquid has a pH in a range of from pH 2.0 to pH 10.0.

188.3.14. The method or use of paragraph 188.3.13, wherein immediately prior to the contacting the processing liquid has a pH of at least pH 3.0.

188.3.15. The method or use of paragraph 188.3.13, wherein immediately prior to the contacting the processing liquid has a pH of at least pH 4.0.

188.3.16. The method or use of paragraph 188.3.13, wherein immediately prior to the contacting the processing liquid has a pH of at least pH 5.0.

188.3.17. The method or use of paragraph 188.3.13, wherein immediately prior to the contacting the processing liquid has a pH of at least pH 6.0.

188.3.18. The method or use of paragraph 188.3.13, wherein immediately prior to the contacting the processing liquid has a pH of at least pH 6.5.

188.3.19. The method or use of any one of paragraphs 188.3.13-188.3.18, wherein immediately prior to the contacting the processing liquid has a pH of not larger than pH 9.0.

188.3.20. The method or use of any one of paragraphs 188.3.13-188.3.18, wherein immediately prior to the contacting the processing liquid has a pH of not larger than pH 8.5.

188.3.21. The method or use of any one of paragraphs 188.3.13-188.3.18, wherein immediately prior to the contacting the processing liquid has a pH of not larger than pH 8.0.

188.3.22. The method or use of any one of paragraphs 188.3.13-188.3.18, wherein immediately prior to the contacting the processing liquid has a pH of not larger than pH 7.5.

188.3.23. The method or use of any one of paragraphs 188.3-188.3.22, wherein immediately prior to the contacting the nonequilibrium treatment composition has a pH as recited in any of paragraphs 188.2.9-188.2.16 and 188.2.18-188.2.19.

188.3.24. The method or use of any one of paragraphs 188.3-188.3.23, wherein immediately prior to the contacting the nonequilibrium treatment composition has a combined concentration of peracid anion and peracid, determined as equivalent concentration of the peracid, as recited in any one of paragraphs 188.1.20-188.1.29.

188.3.25. The method or use of any one of paragraphs 188.3-188.3.24, wherein immediately prior to the contacting the nonequilibrium treatment composition is at a temperature as recited for the temperature of the contacting in any one of paragraphs 188.1.39-188.1.42.

188.3.26. The method or use of any one of paragraphs 188.3-188.3.24, wherein immediately prior to the contacting the nonequilibrium treatment composition is at a temperature as recited in any of paragraphs 188.2.21-188.2.25.

188.3.27. The method or use of any one of paragraphs 188.3-188.3.26, comprising after the contacting subjecting the processing liquid to liquid-solid separation to remove solids from the processing liquid, optionally including a liquid-solid separation technique of filtration, centrifugation, cycloning, and settling.

188.3.28. The method or use of any one of paragraphs 188.3-188.3.27, wherein the nonequilibrium treatment composition comprises the nonequilibrium peracid salt composition without an additive to adjust composition properties prior to the contacting.

188.3.29. The method or use of any one of paragraphs 188.3-188.3.27, wherein the nonequilibrium treatment composition comprises the nonequilibrium adjusted composition and the method or use comprises preparing the nonequilibrium adjusted composition.

### Preparing Nonequilibrium Adjusted Composition

189. The method or use of any one of the preceding paragraphs that comprise preparing the nonequilibrium adjusted composition, including any one of paragraphs 186.6, 187.61, 188.1.61, 188.2.28 and 188.3.29.

### Diluting

190. The method or use of paragraph 189, wherein the preparing the nonequilibrium adjusted composition comprises:

diluting the nonequilibrium peracid salt composition, and optionally the nonequilibrium adjusted composition is a diluted nonequilibrium peracid salt composition.

191. The method or use of either one of paragraph 189 or paragraph 190, comprising contacting the substrate with the nonequilibrium adjusted composition within 120 minutes after preparation of the nonequilibrium peracid salt composition.

192. The method or use of any one of paragraph 189-191, comprising contacting the substrate with the nonequilibrium adjusted composition at least 10 minutes after preparation of the nonequilibrium peracid salt composition.

193. The method or use of any one of paragraphs 189-192, comprising applying the nonequilibrium adjusted composition to the substrate for the contacting not sooner than 20 minutes after preparation of the nonequilibrium peracid salt composition.

### Acidifying

194. The method or use of any one of paragraphs 189-193, wherein the preparing the nonequilibrium adjusted composition comprises acidifying the nonequilibrium peracid salt composition, the acidifying comprising:

adding an acidulant to reduce the pH of the nonequilibrium peracid salt composition prior to the contacting, and optionally to prepare the nonequilibrium composition as an acidified nonequilibrium peracid composition.

194.1. The method of paragraph 194, wherein the acidulant comprises an inorganic acid, optionally a mineral acid.

194.2. The method of either one of paragraph 194 or paragraph 194.1, wherein the acidulant is substantially in the absence of an organic acid.

194.3. The method of any one of paragraphs 194-194.2, wherein the acidifying comprises reducing the pH of the nonequilibrium peracid salt composition to prepare the nonequilibrium adjusted composition at a pH of not larger than pH 9.0.

194.4. The method of paragraph 194.3, wherein the pH of the nonequilibrium adjusted composition is not larger than pH 8.0.

194.4.1. The method of paragraph 194.3, wherein the pH of the nonequilibrium adjusted composition is not larger than pH 7.0.

194.5. The method of paragraph 194.3, wherein the pH of the nonequilibrium adjusted composition is not larger than pH 6.0.

194.6. The method of paragraph 194.3, wherein the pH of the nonequilibrium adjusted composition is not larger than pH 5.5.

194.7. The method of paragraph 194.3, wherein the pH of the nonequilibrium adjusted composition is not larger than pH 5.0.

194.8. The method of any one of paragraphs 194.3-194.7, wherein the pH of the nonequilibrium adjusted composition is not smaller than pH 2.0.

194.9. The method of any one of paragraphs 194.3-194.8, wherein the pH of the nonequilibrium adjusted composition is not smaller than pH 3.0.

194.10. The method of any one of paragraphs 194.3-194.9, wherein the pH of the nonequilibrium adjusted composition is not smaller than pH 4.0.

### Pulp Acidification

194.11. The method of any one of paragraphs 189-194.10, where in the substrate comprises a pulp, optionally in a slurry comprising an aqueous liquid and the pulp to be oxidatively treated, and optionally the oxidative treatment comprises delignifying and/or bleaching and/or brightening the pulp.

194.12. The method of any one of paragraph 194.11, wherein a temperature of the pulp immediately prior to the contacting with the nonequilibrium adjusted composition is at a temperature according to any of the temperature features recited in any of paragraphs 187.23-187.28.

194.13. The method of any one of either one of paragraph 194.11 or paragraph 194.12, wherein a temperature of the nonequilibrium adjusted composition immediately prior to the contacting the pulp is at a temperature according to any of the temperature features recited for the nonequilibrium peracid salt composition in any of paragraphs 187.29-187.33.

194.14. The method of any one of paragraphs 194.11-194.13, wherein the pulp is at a pH of not larger than pH 6.0 immediately prior to application of the nonequilibrium adjusted composition to the pulp for the contacting.

194.15. The method of any one of paragraphs 194.11-194.14, wherein the pulp is at a pH of not larger than pH 5.0 immediately prior to application of the nonequilibrium adjusted composition to the pulp for the contacting.

194.16. The method of any one of paragraphs 194.11-194.15, wherein the pulp is at a pH of at least pH 2.0 immediately prior to application of the nonequilibrium adjusted composition to the pulp for the contacting.

194.17. The method of any one of paragraphs 194.11-194.16, wherein the pulp is at a pH of at least pH 3.0 immediately prior to application of the nonequilibrium adjusted composition to the pulp for the contacting.

194.18. The method of any one of paragraphs 194-194.17, comprising the features of any one of paragraphs 194-194.10, and further comprising, prior to the contacting the pulp with the acidified nonequilibrium peracid composition:

subjecting the pulp to a bleaching operation.

194.19. The method of paragraph 194.18, wherein the bleaching operation comprises treating the pulp with carbon dioxide.

### Miscellaneous

195. The method or use of any one of paragraphs 174-194.2 and 194.3-194.19, comprising generating singlet oxygen in the presence of the substrate as a consequence of contacting the substrate with the nonequilibrium treatment composition.

196. The method or use of any one of paragraphs 174-195, wherein the use or method does not include (is in the absence of) treatment of a human or animal body by surgery or therapy and does not include (is in the absence of) a diagnostic method practiced on a human or animal body.

197. The method or use of any one of paragraphs 174-196, wherein the substrate is not part of a human or animal body.

### Compositions

203. An aqueous, nonequilibrium peracid salt composition for generation of singlet oxygen for use in oxidative treatments, the composition comprising:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400 mg/L;
a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

204. The composition of paragraph 203, wherein the pH is at least 12.1.

205. The composition of paragraph 203, wherein the pH is at least 12.2.

206. The composition of paragraph 203, wherein the pH is at least 12.3.

207. The composition of paragraph 203, wherein the pH is at least 12.4.

208. The composition of paragraph 203, wherein the pH is at least 12.5.

208.1 The composition of paragraph 203, wherein the pH is at least 12.6.

208.2 The composition of paragraph 203, wherein the pH is at least 12.7.

209. The composition of any one of paragraphs 203-208.2, wherein the pH is no larger than 13.3.

210. The composition of any one of paragraphs 203-208.2, wherein the pH is no larger than 13.2.

211. The composition of any one of paragraphs 203-208.2, wherein the pH is no larger than 13.1.

212. The composition of any one of paragraphs 203-208.2, wherein the pH is no larger than 13.0.

213. The composition of any one of paragraphs 203-208.2, wherein the pH is no larger than 12.9.

214. The composition of any one of paragraphs 203-213, comprising a concentration of dissolved hydrogen peroxide of no larger than 1200 mg/L.

215. The composition of any one of paragraphs 203-213, comprising a concentration of dissolved hydrogen peroxide of no larger than 1000 mg/L.

216. The composition of any one of paragraphs 203-213, comprising a concentration of dissolved hydrogen peroxide of no larger than 800 mg/L.

217. The composition of any one of paragraphs 203-213, comprising a concentration of dissolved hydrogen peroxide of no larger than 600 mg/L.

218. The composition of any one of paragraphs 203-217, comprising a molar ratio of dissolved hydrogen peroxide to the peracid anion of no larger than ⅙.

219. The composition of any one of paragraphs 203-217, comprising a molar ratio of dissolved hydrogen peroxide to the peracid anion of no larger than 1/10.

220. The composition of any one of paragraphs 203-217, comprising a molar ratio dissolved hydrogen peroxide to the peracid anion of no larger than 1/16.

221. The composition of any one of paragraphs 203-217, comprising a molar ratio of dissolved hydrogen peroxide to the peracid anion of no larger than 1/20.

222. The composition of any one of paragraphs 203-217, comprising a molar ratio of dissolved hydrogen peroxide to the peracid anion of no larger than 1/25.

223. The composition of any one of paragraphs 203-222, wherein the 10-minute stability index is at least 0.83.

224. The composition of any one of paragraphs 203-222, wherein the 10-minute stability index is at least 0.85.

225. The composition of any one of paragraphs 203-222, wherein the 10-minute stability index is at least 0.88.

226. The composition of any one of paragraphs 203-222, wherein the 10-minute stability index is at least 0.90.

227. The composition of any one of paragraphs 203-222, wherein the 10-minute stability index is at least 0.92.

228. The composition of any one of paragraphs 203-222, wherein the 10-minute stability index is at least 0.94.

229. The composition of any one of paragraphs 203-228, wherein the 10-minute stability index is no larger than 1.00.

230. The composition of any one of paragraphs 203-228, wherein the 10-minute stability index is no larger than 0.99.

231. The composition of any one of paragraphs 203-228, wherein the 10-minute stability index is no larger than 0.98.

232. The composition of any one of paragraphs 203-228, wherein the 10-minute stability index is no larger than 0.96.

233. The composition of any one of paragraphs 203-232, comprising a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

234. The composition of paragraph 233, wherein the 30-minute stability index is at least 0.70.

235. The composition of paragraph 233, wherein the 30-minute stability index is at least 0.73.

236. The composition of paragraph 233, wherein the 30-minute stability index is at least 0.76.

237. The composition of paragraph 233, wherein the 30-minute stability index is at least 0.78.

238. The composition of paragraph 233, wherein the 30-minute stability index is at least 0.80.

239. The composition of paragraph 233, wherein the 30-minute stability index is at least 0.82.

240. The composition of any one of paragraphs 233-239, wherein the 30-minute stability index is no larger than 0.95.

241. The composition of any one of paragraphs 233-239, wherein the 30-minute stability index is no larger than 0.92.

242. The composition of any one of paragraphs 233-239, wherein the 30-minute stability index is no larger than 0.90.

243. The composition of any one of paragraphs 233-239, wherein the 30-minute stability index is no larger than 0.88.

244. The composition of any one of paragraphs 233-239, wherein the 30-minute stability index is no larger than 0.85.

245. The composition of any one of paragraphs 233-244, wherein the 30-minute stability index is smaller than the 10-minute stability index.

246. The composition of paragraph 245, wherein the 30-minute stability index is smaller than the 10-minute stability index by at least 0.05.

247. The composition of paragraph 245, wherein the 30-minute stability index is smaller than the 10-minute stability index by at least 0.10.

248. The composition of any one of paragraphs 245-247, wherein the 30-minute stability index is smaller than the 10-minute stability index by an amount no larger than 0.20.

249. The composition of any one of paragraphs 245-247, wherein the 30-minute stability index is smaller than the 10-minute stability index by an amount no larger than 0.15.

250. The composition of any one of paragraphs 203-249, comprising a weight ratio of total organic carbon to the peracid anion of no larger than 0.60.

251. The composition of any one of paragraphs 203-249, comprising a weight ratio of total organic carbon to the peracid anion of no larger than 0.59.

252. The composition of any one of paragraphs 203-249, comprising a weight ratio of total organic carbon to the peracid anion of no larger than 0.58.

253. The composition of any one of paragraphs 203-249, comprising a weight ratio of total organic carbon to the peracid anion of no larger than 0.57.

254. The composition of any one of paragraphs 203-249, comprising a weight ratio of total organic carbon to the peracid anion of no larger than 0.55.

255. The composition of any one of paragraphs 203-249, comprising a weight ratio of total organic carbon to the peracid anion of no larger than 0.53 256. The composition of any one of paragraphs 203-255, comprising a weight ratio of total organic carbon to the peracid anion of at least 0.48.

257. The composition of any one of paragraphs 203-255, comprising a weight ratio of total organic carbon to the peracid anion of at least 0.50.

258. The composition of any one of paragraphs 203-255, comprising a weight ratio of total organic carbon to the peracid anion of at least 0.52.

259. The composition of any one of paragraphs 203-254, comprising a weight ratio of total organic carbon to the peracid anion of at least 0.54.

260. The composition of any one of paragraphs 203-259, comprising a molar ratio of the peracid anion to the peracid of at least 10,000.

261. The composition of any one of paragraphs 203-259, comprising a molar ratio of the peracid anion to the peracid of at least 15,000.

262. The composition of any one of paragraphs 203-259, comprising a molar ratio of the peracid anion to the peracid of at least 18,000.

263. The composition of any one of paragraphs 203-262, comprising a molar ratio of the peracid anion to the peracid of no larger than 40,000.

264. The composition of any one of paragraphs 203-262, comprising a molar ratio of the peracid anion to the peracid of no larger than 38,000.

265. The composition of any one of paragraphs 203-264, wherein the nonequilibrium peracid salt composition is a nonequilibrium peracetic acid salt composition and the peracid anion is peracetate.

266. The composition of any one of paragraphs 203-265, comprising the peracid anion at a concentration of at least 1.5% (weight/volume).

267. The composition of any one of paragraphs 203-265, comprising the peracid anion at a concentration of at least 2.0% (weight/volume).

268. The composition of any one of paragraphs 203-265, comprising the peracid anion at a concentration of at least 2.5% (weight/volume).

269. The composition of any one of paragraphs 203-265, comprising the peracid anion at a concentration of at least 3.0% (weight/volume).

270. The composition of any one of paragraphs 203-265, comprising the peracid anion at a concentration of at least 3.5% (weight/volume).

271. The composition of any one of paragraphs 203-265, comprising the peracid anion at a concentration of at least 4.0% (weight/volume).

272. The composition of any one of paragraphs 203-265, comprising the peracid anion at a concentration of at least 4.5% (weight/volume).

273. The composition of any one of paragraphs 203-265, comprising the peracid anion at a concentration of at least 5.0% (weight/volume).

274. The composition of any one of paragraphs 203-265, comprising the peracid anion at a concentration of at least 5.5% (weight/volume).

275. The composition of any one of paragraphs 203-265, comprising the peracid anion at a concentration of at least 6.0% (weight/volume).

276. The composition of any one of paragraphs 203-265, comprising the peracid anion at a concentration of at least 6.5% (weight/volume).

277. The composition of any one of paragraphs 203-265, comprising the peracid anion at a concentration of at least 7.0% (weight/volume).

278. The composition of any one of paragraphs 203-277, comprising the peracid anion at a concentration of no larger than 8.0% (weight/volume).

279. The composition of any one of paragraphs 203-277, comprising the peracid anion at a concentration of no larger than 7.5% (weight/volume).

280. The composition of any one of paragraphs 203-277, comprising the peracid anion at a concentration of no larger than 7.0% (weight/volume).

281. The composition of any one of paragraphs 203-276, comprising the peracid anion at a concentration of no larger than 6.5% (weight/volume).

282. The composition of any one of paragraphs 203-275, comprising the peracid anion at a concentration of no larger than 6.0% (weight/volume).

283. The composition of any one of paragraphs 203-274, comprising the peracid anion at a concentration of no larger than 5.5% (weight/volume).

284. The composition of any one of paragraphs 203-273, comprising the peracid anion at a concentration of no larger than 5.0% (weight/volume).

285. The composition of any one of paragraphs 203-272, comprising the peracid anion at a concentration of no larger than 4.5% (weight/volume).

286. The composition of any one of paragraphs 203-271, comprising the peracid anion at a concentration of no larger than 4.0% (weight/volume).

287. The composition of any one of paragraphs 203-270, comprising the peracid anion at a concentration of no larger than 3.5% (weight/volume).

288. The composition of any one of paragraphs 203-269, comprising the peracid anion at a concentration of no larger than 3.0% (weight/volume).

289. The composition of any one of paragraphs 203-268, comprising the peracid anion at a concentration of no larger than 2.5% (weight/volume).

290. The composition of any one of paragraphs 203-267, comprising the peracid anion at a concentration of no larger than 2.0% (weight/volume).

291. The composition of any one of paragraphs 203-265, 269-274 and 282-288, comprising:
the peracid anion at a concentration in a range of from 3.0% (weight/volume) to 6.0% (weight/volume);
the 10-minute stability index (SI₁₀) being at least 0.85;
the concentration of dissolved hydrogen peroxide being no larger than 1200 mg/L; and
the pH being at least 12.1.

292. The composition of paragraph 291, comprising a pH of at least 12.3.

293. The composition of either one of paragraph 291 or paragraph 292, comprising a weight ratio of total organic carbon to the peracid anion of no larger than 0.58.

294. The composition of any one of paragraphs 291-293, wherein the pH is at least 12.4.

295. The composition of any one of paragraphs 203-269 and 288-290, comprising:
the peracid anion at a concentration in a range of from 1.5% (weight/volume) to 3.0% (weight/volume);
the 10-minute stability index (SI₁₀) being at least 0.90;
the concentration of dissolved hydrogen peroxide being no larger than 1200 mg/L; and
the pH being at least 12.3.

296. The composition of any one of paragraphs 203-281, comprising:
the peracid anion at a concentration in a range of from 6.5% (weight/volume) to 8.0% (weight/volume);
the 10-minute stability index (SI₁₀) being at least 0.88;
the concentration of dissolved hydrogen peroxide being no larger than 1200 mg/L; and
the pH being at least 12.2.

297. The composition of any one of paragraphs 203-296, comprising any of the composition properties recited in any of paragraphs 1-197.

### Other Combinations

401. A peracid salt-reactive oxygen species formulation capable of generating singlet oxygen, the peracid salt-reactive oxygen species formulation comprising a reacted mixture of alkali, hydrogen peroxide and an acyl donor;
wherein the peracid salt-reactive oxygen species formulation has a pH value from about pH 12.2 to about pH 13.5 and a peracid anion to peracid molar ratio from about 10,000:1 to about 40,000:1.

402. The peracid salt-reactive oxygen species formulation of paragraph 401, wherein the molar ratio of hydrogen peroxide to alkali in feed for the mixture is in a range of about 1:1.0 to about 1:1.2.

403. The peracid salt-reactive oxygen species formulation of either one of paragraph 401 or paragraph 402, comprising a molar ratio of hydrogen peroxide to acyl donor groups, preferably to acetyl donor groups, in feed for the mixture in a range of from about 1:1.0 to about 1:1.25, and preferably a narrower range disclosed herein.

404. The peracid salt-reactive oxygen species formulation of any one of paragraphs 401-403, wherein the acyl donor is an acetyl donor and the peracid salt reactive oxygen species formulation is a peracetate-reactive oxygen species formulation.

405. The peracid salt-reactive oxygen species formulation of any one of paragraphs 401-404, wherein the molar ratio of peracid anions, preferably peracetate anions, to hydrogen peroxide is greater than about 16:1.

406. The peracid salt-reactive oxygen species formulation of any one of paragraphs 401-405, comprising a concentration of peracid anion, preferably peracetate anion, of about 1.0% wt/volume or greater, and preferably about 2.0% wt/volume or greater.

407. The peracid salt-reactive oxygen species formulation of paragraph 406, wherein the concentration of peracid anion, and preferably peracetate anion, is up to about 8.0% wt/volume, and preferably in a range of from about 3.0% to about 8.0%.

408. The peracid salt-reactive oxygen species formulation of any one of paragraphs 401-407, comprising reaction byproducts from preparation of the peracid salt-reaction oxygen species of with triacetin as acetyl donor.

409. The peracid salt-reactive oxygen species formulation of any one of paragraphs 401-408, comprising hydrogen peroxide at a concentration of no greater than about 10 mg/L.

410. The peracid salt-reactive oxygen species formulation of any one of paragraphs 401-409, wherein the peracid salt-reactive oxygen species formulation is a peracetate-reactive oxygen species formulation comprising a TOC:peracetate anion mass ratio of less than 0.60.

411. A method for generating a peracid salt-reactive oxygen species formulation, optionally the peracid salt-reactive oxygen species formulation of any one of paragraphs 401-410, the method comprising:
mixing an alkali hydrogen peroxide solution with an acyl donor, preferably an acetyl donor, and reacting the mixture to prepare the peracid salt-reactive species formulation, and preferably a peracetate-reactive oxygen species formulation, at a PH in a range for from about pH 12.2 to about pH 13.5 and preferably at least pH 12.5 and more preferably from pH 12.5 to pH 12.8; and
wherein the alkali hydrogen peroxide solution, immediately prior to the mixing, has a molar ratio of hydrogen peroxide to alkali in a range of from about 1:0.8 to about 1.5, and preferably the molar ratio of hydrogen peroxide to alkali is not greater than 1:1.2 and more preferably not greater than 1.1.18, and with one preferred range for the molar ratio of hydrogen peroxide to alkali being from 1:1.0 to 1:1.2 and one more preferred range being from 1:1.0 to 1:1.18.

412. The method of paragraph 411, wherein the mixing comprises combining the hydrogen peroxide and the acyl donor, preferably acetyl donor, at a molar ratio of hydrogen peroxide to acyl donor groups, preferably acetyl donor groups, in a range of from about 1:1.0 to about 1:1.25, and preferably in an even narrower range as discloses herein.

413. The method of either one of paragraph 411 or paragraph 412, wherein chemical side reactions are reduced during the generating of the peracid salt-reactive oxygen species formulation.

414. The method of any one of paragraphs 411-413, wherein the generated formulations can be produced by batch, semi-continuous or continuous processing.

415. The method of any one of paragraphs 411-414, wherein the acyl donor is an acetyl donor, and preferably the acetyl donor is triacetin.

416. The method of any one of paragraphs 411-415, diluting the formulation to a point of use concentration having an extended oxidative activity time of up to 120 minutes.

417. The method of paragraph 416, wherein the point of use is sanitization.

418. The method of any one of paragraphs 411-417, wherein the formulation is added to media having a pH of about pH 12 or less.

419. The method of any one of paragraphs 411-418, wherein the formulation is added to an acidic media to increase oxidative activity from the formulation.

420. The method of any one of paragraphs 411-419, wherein the formulation is stable at about 20 C for about 10 minutes.

421. The method of any one of paragraphs 411-420, wherein the formulation has a TOC:peracid anion mass ratio in a range of from about 0.48 to about 0.58.

422. The method of any one of paragraphs 411-421, further comprising use of the formulation in water treatment, pulp treatment, microbial control and sanitization.

423. The peracid salt-reactive oxygen species formulation or method of any one of paragraphs 401-422, wherein the peracid salt-reactive oxygen species is an aqueous peracetate-reactive oxygen species formulation comprising:
a peracetate anion concentration of no greater than about 8.0% weight/volume and preferably no greater than about 6.0% weight/volume, with the peracetate anion concentration preferably being at least about 1.0% weight/volume and more preferably at least about 2.0% weight/volume, and even more preferably the peracetate anion concentration is in range of from about 3.0 to about 5.0% weight/volume;
a pH in a range of from about pH 12.2 to about pH 13.5, preferably at least pH 12.5 and more preferably from about pH 12.5 to about 12.8;
a peracetate anion to peracetic acid molar ratio in a range of from about 10,000:1 to about 40,000:1, and preferably at least about 18,000 and more preferably in a range of from about 18,000 to about 38,000;
optionally hydrogen peroxide, wherein a molar ratio of peracetate anions to hydrogen peroxide in the peracetate-reactive oxygen species formulation is greater than about 16:1.

424. The peracid salt-reactive oxygen species formulation or method of paragraph 423, wherein the peracetate-reactive oxygen species formulation comprises total organic carbon (TOC) at a TOC:peracetate anion mass ratio of no greater than 0.60, preferably less than 0.60, more preferably no greater than 0.59 and even more preferably no greater than 0.58.

425. The peracid salt-reactive oxygen species formulation of paragraph 424, wherein the TOC:peracetate anion mass ratio is at least 0.48.

426. The peracid salt-reactive oxygen species formulation or method of any one of paragraphs 423-425, wherein the peracetate-reactive oxygen species formulation comprises a concentration of hydrogen peroxide of no larger than 1500 mg/L, and preferably no larger than 750 mg/L and even more preferably no larger than 400 mg/L, and still more preferably no larger than 10 mg/L.

427. A method of oxidative treatment of a substrate, comprising contacting the substrate with a formulation selected from the group consisting of a peracid salt-reactive oxygen species formulation, preferably a peracetate-reactive oxygen species formulation, according to any one of paragraphs 401-426 and a diluted formulation prepared by diluting a peracid salt-reactive oxygen species formulation, preferably a peracetate-reactive oxygen species formulation, according to any one of paragraphs 401-426.

428. The method of paragraph 427, comprising contacting the substrate with the peracid salt-reactive oxygen species formulation and wherein the contacting occurs within 10 minutes after preparation of the peracid salt-reactive oxygen species formulation.

429. A method of paragraph 427, comprising contacting the substrate with the diluted formulation and wherein the contacting occurs within 120 minutes following preparation of the peracid salt-reactive oxygen species formulation.

430. The method of any one of paragraphs 427-429, wherein the substrate comprises a surface of a solid object, and optionally to sanitize the surface.

431. The method of any one of paragraphs 427-429, wherein the substrate comprises a water to be treated.

432. The method of any one of paragraphs 427-429, wherein the substrate comprises a pulp slurry with pulp to be oxidatively treated to delignify and/or bleach and/or brighten the pulp.

433. The method of paragraph 432, wherein the pulp slurry is at a temperature in a range of from about 38° C. to about 95° C., preferably at least 50° C. and preferably not more than 80° C., with a range of from 50° C. to 80° C. being more preferred.

501. A method of treating pulp, the method comprising:
contacting the pulp with a nonequilibrium peracid salt composition, the contacting comprising adding the peracid salt composition to the pulp; and after the adding, mixing a mixture with the pulp with the nonequilibrium peracid salt composition for generating singlet oxygen in the mixture, wherein the nonequilibrium peracid salt composition as added to the pulp comprises:
a pH in a range of from pH 12.0 to pH 13.5;
a concentration of dissolved hydrogen peroxide of no more than 1400; and
a 10-minute stability index (SI₁₀) at a temperature of 22° C. of at least 0.80.

502. The method of paragraph 501, wherein the pulp comprises an aqueous liquid at a pH at least two pH units smaller than the pH of the nonequilibrium peracid salt composition immediately prior to the contacting.

503. The method of either one of paragraph 501 or paragraph 502, wherein the pH of the nonequilibrium peracid salt composition is in a range of from 12.5 to 13.2.

504. The method of paragraph 501, wherein nonequilibrium peracid salt composition comprises dissolved peracid anion of the peracid salt at a concentration in a range of from 1.0% (weight/volume) to 8.0% (weight/volume).

505. The method of any one of paragraphs 501-504, wherein the composition properties comprise a molar ratio of dissolved hydrogen peroxide to the peracid anion of no larger than 1/10.

506. The method of paragraph 504, wherein the composition properties comprise a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

507. The method of paragraph 506, wherein the 10-minute stability index is at least 0.90.

508. The method of paragraph 506, wherein the composition properties comprise a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

509. The method of paragraph 508, wherein the 30-minute stability index is at least 0.80.

510. The method of paragraph 501, wherein the pulp comprises a slurry comprising aqueous liquid and pulp to be oxidatively treated to delignify and/or bleach the pulp.

511. The method of paragraph 501, wherein the composition properties comprise a molar ratio of the peracid anion to the peracid in a range of from 10,000 to 40,000.

512. The method of paragraph 501, wherein the composition properties comprise a weight ratio of total organic carbon to the peracid anion of no larger than 0.58.

513. The method of any one of paragraphs 501-512, further comprising a combination of reaction feedstocks having a first molar ratio of the alkali metal hydroxide to the acyl donor groups in a range of from 1.00 to 1.40; and

a second molar ratio of hydrogen peroxide to the acyl donor groups in a range of from 0.80 to 1.00.

514. The method of any one of paragraphs 501-514, wherein the composition properties comprise a molar ratio of the peracid anion to the peracid in a range of from 10,000 to 40,000.

515. The method of paragraph 501, wherein during the contacting the pulp has a temperature from between about 50° C. to about 95° C.

516. The method of paragraph 501, wherein the temperature accelerates the generation of reactive oxygen species from the parent oxidant solution in the mixture.

517. The method of any one of paragraphs 501-516, wherein the nonequilibrium peracid salt composition is a nonequilibrium peracetic acid salt composition and the peracid anion is peracetate.

518. The method of paragraph 501, further comprising extracting lignin from the pulp through action of the nonequilibrium peracetic acid salt composition.

519. The method of paragraph 501, further comprising, after the contacting, bleaching the pulp.

520. The method of paragraph 519, wherein the pulp is bleached with chlorine dioxide.

521. The method of paragraph 501, wherein the processing results in lower pollutant content in bleach pulp effluent as measured by at least one of the group consisting of AOX, TOC, BOD, COD and VOC.

522. The method of paragraph 501, wherein the processing results in microbial control reducing bacterial growth.

523. The method of paragraph 501, delignifying the pulp in a delignification stage.

524. The method of paragraph 523, wherein the contacting occurs after the delignification stage.

525. The method of paragraph 501, comprising adding a mineral acidulant to reduce the pH of the nonequilibrium peracid salt composition prior to the contacting.

526. The method of paragraph 525, wherein the adding of the acidulant to the process results in increased brightening.

527. The method of paragraph 525, wherein a preferred acidulant is sulfuric acid.

601. A method of oxidative treating of a substrate in food processing, the method comprising:
contacting the substrate with a nonequilibrium peracid salt composition, the contacting comprising adding the peracid salt composition to the substrate; and after the adding, mixing a mixture with the substrate with the nonequilibrium peracid salt composition for generating singlet oxygen in the mixture; the singlet oxygen providing oxidative treatment to the substrate; wherein the nonequilibrium peracid salt composition as added to the substrate comprises:
a pH in a range of from pH 12.0 to pH 13.5;
a concentration of dissolved hydrogen peroxide of no more than 1400; and
a 10-minute stability index (SI₁₀) at a temperature of 22° C. of at least 0.80.

602. The method of paragraph 601, wherein the substrate comprises an aqueous liquid at a pH at least two pH units smaller than the pH of the nonequilibrium peracid salt composition immediately prior to the contacting.

603. The method of either one of paragraph 601 or paragraph 602, wherein the pH of the nonequilibrium peracid salt composition is in a range of from 12.5 to 13.2.

604. The method of paragraph 601, wherein nonequilibrium peracid salt composition comprises dissolved peracid anion of the peracid salt at a concentration in a range of from 1.0% (weight/volume) to 8.0% (weight/volume).

605. The method of any one of paragraphs 601-604, wherein the composition properties comprise a molar ratio of dissolved hydrogen peroxide to the peracid anion of no larger than 1/10.

606. The method of paragraph 604, wherein the composition properties comprise a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

607. The method of paragraph 606, wherein the 10-minute stability index is at least 0.90.

608. The method of paragraph 606, wherein the composition properties comprise a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

609. The method of paragraph 608, wherein the 30-minute stability index is at least 0.80.

610. The method of paragraph 601, wherein the substrate further comprises solid object surfaces, particulates and liquids amenable to contact with the improved formulation for cleaning and sanitization during food processing.

611. The method of paragraph 601, wherein the composition properties comprise a molar ratio of the peracid anion to the peracid in a range of from 10,000 to 40,000.

612. The method of paragraphs 601, wherein the composition properties comprise a weight ratio of total organic carbon to the peracid anion of no larger than 0.58.

613. The method of any one of paragraphs 601-612, further comprising a combination of reaction feedstocks having a first molar ratio of the alkali metal hydroxide to the acyl donor groups in a range of from 1.00 to 1.40; and

a second molar ratio of hydrogen peroxide to the acyl donor groups in a range of from 0.80 to 1.00.

614. The method of any one of paragraphs 601-613, wherein the composition properties comprise a molar ratio of the peracid anion to the peracid in a range of from 10,000 to 40,000.

615. The method of paragraph 601, wherein during the contacting the substrate has a temperature from between about 2° C. to about 95° C.

616. The method of paragraph 601, wherein the temperature accelerates the generation of reactive oxygen species from the parent oxidant solution in the mixture.

617. The method of any one of paragraphs 601-616, wherein the nonequilibrium peracid salt composition is a nonequilibrium peracetic acid salt composition and the peracid anion is peracetate.

618. The method of paragraph 601, further comprising extracting solids from the substrate through action of the nonequilibrium peracetic acid salt composition.

619. The method of paragraph 601, further comprising, after the contacting, sanitizing the substrate.

620. The method of paragraph 601, wherein the processing results in lower COD, BOD

621. The method of paragraph 601, wherein the processing results in microbial control reducing bacterial growth.

622. The method of paragraph 601, sanitizing the substrate in a sanitization stage.

623. The method of paragraph 622, wherein the contacting occurs before the sanitization stage.

624. The method of paragraph 601, wherein the nonequilibrium peracid salt composition is acidified to a pH between 2 to 8.

625. A method for preparing a nonequilibrium peracid salt composition in relatively stable form for short-term storage and handling prior to use to generate singlet oxygen during oxidative treatments in food processing including cleaning and sanitization, the method comprising:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor groups in a range of from 0.95 to 1.40; and
   a second molar ratio of hydrogen peroxide to the acyl donor groups in a range of from 0.80 to 1.10; and
continuing the reacting at least until the nonequilibrium peracid salt composition is prepared including the composition properties.

701. A method for preparing a nonequilibrium peracid salt composition in relatively stable form for short-term storage and handling prior to use to generate singlet oxygen during oxidative treatments, the method comprising:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
   dissolved peracid anion of the peracid salt at a concentration in a range of from 1.0% (weight/volume) to 8.0% (weight/volume); and
   pH in a range of from pH 12.0 to pH 13.5; and
wherein the combination of reaction feedstocks comprises:
   a first molar ratio of the alkali metal hydroxide to the acyl donor groups in a range of from 1.00 to 1.40; and
   a second molar ratio of hydrogen peroxide to the acyl donor groups in a range of from 0.80 to 1.00; and
continuing the reacting at least until the nonequilibrium peracid salt composition is prepared including the composition properties.

702. The method of paragraph 701, wherein the first molar ratio is in a range of from 1.05 to 1.30.

703. The method of either one of paragraph 701 or paragraph 702, wherein the pH is in a range of from 12.5 to 13.2.

704. The method of any one of paragraphs 701-703, wherein the composition properties comprise a concentration of dissolved hydrogen peroxide of no larger than 1400 mg/L.

705. The method of any one of paragraphs 701-704, wherein the composition properties comprise a molar ratio of dissolved hydrogen peroxide to the peracid anion of no larger than 1/10.

706. The method of any one of paragraphs 701-705, wherein the composition properties comprise a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

707. The method of paragraph 706, wherein the 10-minute stability index is at least 0.90.

708. The method of any one of either one of paragraph 706 or paragraph 707, wherein the composition properties comprise a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

709. The method of paragraph 708, wherein the 30-minute stability index is at least 0.80.

7010. The method of either one of paragraph 708 or paragraph 709, wherein the 30-minute stability index is smaller than the 10-minute stability index by at least 0.05.

711. The method of any one of paragraphs 708-710, wherein the 30-minute stability index is smaller than the 10-minute stability index by an amount no larger than 0.20.

712. The method of any one of paragraphs 701-711, wherein the second molar ratio is in a range of from 0.83 to 0.97.

713. The method of any one of paragraphs 701-712, wherein the composition properties comprise a weight ratio of total organic carbon to the peracid anion of no larger than 0.58.

714. The method of any one of paragraphs 701-713, wherein the composition properties comprise a molar ratio of the peracid anion to the peracid in a range of from 10,000 to 40,000.

715. The method of any one of paragraphs 701-714, wherein the chemical feedstocks for the aqueous reaction mixture are in amounts and proportions to prepare the nonequilibrium peracid salt composition with the composition properties at a first yield of the peracid anion relative to the acyl donor groups of at least 80%.

716. The method of any one of paragraphs 701-715, wherein the chemical feedstocks for the aqueous reaction mixture or in amounts and proportions to prepare the nonequilibrium peracid salt composition with the composition properties at a second yield of the peracid anion relative to the hydrogen peroxide of at least 90%.

717. The method of any one of paragraphs 701-716, wherein the nonequilibrium peracid salt composition is a nonequilibrium peracetic acid salt composition and the peracid anion is peracetate.

718. The method of any one of paragraphs 701-717, wherein the composition properties comprise the peracid anion at a concentration of at least 2.0% (weight/volume).

719. The method of any one of paragraphs 701-717, wherein:
the first molar ratio is in a range of from 1.00 to 1.30;
the second molar ratio is in a range of from 0.83 to 1.00;
the composition properties comprise;
   the peracid anion at a concentration in a range of from 3.0% (weight/volume) to 6.5% (weight/volume);
   a 10-minute stability index (SI₁₀) of at least 0.85 calculated according to Equation I;
   a concentration of hydrogen peroxide of no larger than 1200 mg/L; and
   a pH of at least 12.1; and
the chemical feedstocks for the aqueous reaction mixture are in amounts and proportions to prepare the nonequilibrium peracid salt composition with the composition properties at a first yield of the peracid anion relative to the acyl donor groups of at least 80% and a second yield of the peracid anion relative to hydrogen peroxide of at least 90%.

720. The method of paragraph 719, wherein:
the first molar ratio is at least 1.05;
the second molar ratio is at least 0.87; and
the composition properties comprise a pH of at least 12.4.

721. The method of any one of paragraphs 701-718, wherein:
the first molar ratio is in a range of from 1.05 to 1.30;
the second molar ratio is in a range of from 0.80 to 0.95;
the composition properties comprise;
   the peracid anion at a concentration in a range of from 1.5% (weight/volume) to 3.0% (weight/volume);
   a 10-minute stability index (SI₁₀) of at least 0.90 calculated according to Equation I;
   a concentration of hydrogen peroxide of no larger than 1200 mg/L; and
   a pH of at least 12.3; and
the chemical feedstocks for the aqueous reaction mixture are in amounts and proportions to prepare the nonequilibrium peracid salt composition with the composition properties at a first yield of the peracid anion relative to the acyl donor groups of at least 75% and a second yield of the peracid anion relative to hydrogen peroxide of at least 88%.

722. The method of any one of paragraphs 701-717, wherein:
the first molar ratio is in a range of from 1.00 to 1.30;
the second molar ratio is in a range of from 0.85 to 1.00;
the composition properties comprise;
   the peracid anion at a concentration in a range of from 6.0% (weight/volume) to 8.0% (weight/volume);
   a 10-minute stability index (SI₁₀) of at least 0.88 calculated according to Equation I;
   a concentration of hydrogen peroxide of no larger than 1200 mg/L; and
   a pH of at least 12.2; and
the chemical feedstocks for the aqueous reaction mixture are in amounts and proportions to prepare the nonequilibrium peracid salt composition with the composition properties at a first yield of the peracid anion relative to the acyl donor groups of at least 80% and a second yield of the peracid anion relative to hydrogen peroxide of at least 86%.

723. The method of any one of paragraphs 701-722, wherein the combination of reaction feedstocks comprises a third molar ratio of the alkali metal hydroxide to hydrogen peroxide in a range of from 1.00 to 1.63.

724. The method of any one of paragraphs 701-723, wherein the acyl donor is in acetyl donor.

725. A method of oxidative treatment of a substrate, comprising:

contacting the substrate with a nonequilibrium peracid salt composition prepared according to the method of any one of paragraphs 701-724.

726. The method of any one paragraph 725, wherein the substrate comprises an aqueous liquid at a pH at least two pH units smaller than the pH of the nonequilibrium peracid salt composition immediately prior to the contacting.

727. The method of either one of paragraph 725 or paragraph 726, wherein the substrate comprises a slurry comprising the aqueous liquid and pulp to be oxidatively treated to delignify and/or bleach the pulp.

728. A method of oxidative treatment of a substrate, comprising:
diluting a nonequilibrium peracid salt composition prepared according to any one of paragraphs 701-724 to prepare a diluted nonequilibrium peracid salt composition; and
contacting the substrate with a diluted nonequilibrium peracid salt composition.

729. The method of any one of paragraphs 725-728, wherein the substrate comprises a surface of a solid object to be sanitized.

730. The method of any one of paragraphs 725-729, comprising adding an acidulant to reduce the pH of the nonequilibrium peracid salt composition prior to the contacting.

731. The method of any one of paragraphs 725-730, comprising generating singlet oxygen in the presence of the substrate as a consequence of contacting the substrate with the nonequilibrium peracid salt composition or the diluted nonequilibrium peracid salt composition.

732. An aqueous, nonequilibrium peracid salt composition for generation of singlet oxygen for use in oxidative treatments, the composition comprising:
dissolved peracid anion of an alkali metal salt of a peracid at a concentration in a range of from 1.0% (weight/volume) to 8.0% (weight/volume);
pH in a range of from pH 12.0 to pH 13.5;
a concentration of dissolved hydrogen peroxide of no more than 1400;
a 10-minute stability index (SI₁₀) at a temperature of 22° C. of at least 0.80, wherein the 10-minute stability index is calculated according to Equation I:

SI₁₀=CA₁₀/CA₀ Equation I:
wherein:
   SI₁₀ is the 10-minute stability index;
   CA₀ is the concentration (% weight/volume) of the peracid anion determined for a first time; and
   CA₁₀ is a concentration (% weight/volume) of the peracid anion determined for a second time corresponding to 10 minutes following the first time.

733. The composition of paragraph 732, wherein the pH is at least 12.5.

734. The composition of either one of paragraph 732 or paragraph 733, comprising a concentration of dissolved hydrogen peroxide of no larger than 600 mg/L.

735. The composition of any one of paragraphs 732-734, comprising a molar ratio of dissolved hydrogen peroxide to the peracid anion of no larger than 1/16.

736. The composition of any one of paragraphs 732-735, wherein the 10-minute stability index is at least 0.88.

737. The composition of any one of paragraphs 732-36, comprising a 30-minute stability index (SI₃₀) at a temperature of 22° C. of at least 0.65, wherein the 30-minute stability index is calculated according to Equation II:

SI₃₀=CA₃₀/CA₀ Equation II:
wherein:
   SI₃₀ is the 30-minute stability index;
   CA₀ is the concentration (% weight/volume) of the peracid anion determined for a first time; and
   CA₃₀ is a concentration (% weight/volume) of the peracid anion determined for a third time corresponding to 30 minutes following the first time.

738. The composition of paragraph 737, wherein the 30-minute stability index is smaller than the 10-minute stability index by an amount no larger than 0.20.

739. The composition of any one of paragraphs 732-738, comprising a weight ratio of total organic carbon to the peracid anion of no larger than 0.60.

740. The composition of any one of paragraphs 732-739, comprising a molar ratio of the peracid anion to the peracid in a range of from 10,000 to 40,000.

741. The composition of any one of paragraphs 732-740, comprising:
the peracid anion at a concentration in a range of from 3.0% (weight/volume) to 6.5% (weight/volume);
the 10-minute stability index (SI₁₀) being at least 0.85;
the concentration of dissolved hydrogen peroxide being no larger than 1200 mg/L; and
the pH being at least 12.1.

742. The composition of any one of paragraphs 732-740, comprising:
the peracid anion at a concentration in a range of from 1.5% (weight/volume) to 3.0% (weight/volume);
the 10-minute stability index (SI₁₀) being at least 0.90;
the concentration of dissolved hydrogen peroxide being no larger than 1200 mg/L; and
the pH being at least 12.3.

743. The composition of any one of paragraphs 732-740, comprising:
the peracid anion at a concentration in a range of from 6.0% (weight/volume) to 8.0% (weight/volume);
the 10-minute stability index (SI₁₀) being at least 0.88;
the concentration of dissolved hydrogen peroxide being no larger than 1200 mg/L; and
the pH being at least 12.2.

The foregoing description of the present invention and various aspects thereof has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

The description of a feature or features in a particular combination do not exclude the inclusion of an additional feature or features in a variation of the particular combination. Processing steps and sequencing are for illustration only, and such illustrations do not exclude inclusion of other steps or other sequencing of steps to an extent not necessarily incompatible. Additional steps may be included between any illustrated processing steps or before or after any illustrated processing step to an extent not necessarily incompatible.

The terms “comprising”, “containing”, “including” and “having”, and grammatical variations of those terms, are intended to be inclusive and nonlimiting in that the use of such terms indicates the presence of a stated condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or any appropriate grammatical variation of such narrower terms). For example, a statement that something “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all.

What is claimed is:

1. A method of oxidative treatment of a substrate, comprising:
contacting a food processing substrate with a nonequilibrium treatment composition comprising:
a nonequilibrium peracid salt composition prepared according to a preparation method without an additive to adjust composition properties prior to the contacting; or
a nonequilibrium adjusted composition prepared by adding one or more additives to the nonequilibrium peracid salt composition prior to the contacting;
wherein the preparation method comprises:
reacting components in an aqueous reaction mixture prepared from a combination of chemical feedstocks to form an aqueous nonequilibrium peracid salt composition, the chemical feedstocks comprising acyl donor with acyl donor groups, hydrogen peroxide and alkali metal hydroxide in amounts and proportions, including to account for yield losses, to prepare the nonequilibrium peracid salt composition with composition properties comprising:
dissolved peracid anion of the peracid salt at a concentration in a range of from 1.0% (weight/volume) to 8.0% (weight/volume); and
pH in a range of from pH 12.0 to pH 13.5; and
wherein the combination of reaction feedstocks comprises:
a first molar ratio of the alkali metal hydroxide to the acyl donor groups in a range of from 0.95 to 1.40; and
a second molar ratio of hydrogen peroxide to the acyl donor groups in a range of from 0.80 to 1.10; and
continuing the reacting at least until the nonequilibrium peracid salt composition is prepared including the composition properties.

2. The method of claim 1, wherein the food processing substrate comprises a food product.

3. The method of claim 2, wherein the food product comprises a vegetable.

4. The method of claim 2, wherein the food product comprises a fruit.

5. The method of claim 2, wherein the food product comprises a meat.

6. The method of claim 2, wherein the food product, immediately prior to the contacting, has a pH in a range of from pH 3.0 to pH 7.6.

7. The method of claim 2, wherein immediately prior to the contacting the nonequilibrium treatment composition has a pH no more than 2.0 pH units larger or smaller than the pH of the food product.

8. The method of claim 2, wherein immediately prior to the contacting the nonequilibrium treatment composition has a pH in a range of from pH 2.0 to pH 8.0.

9. The method of claim 2, wherein the contacting is at a treatment temperature in a range of from 2° C. to 95° C.

10. The method of claim 9, wherein the treatment temperature is not larger than 40° C. and the contacting comprises a cold wash of the food product.

11. The method of claim 9, wherein the treatment temperature is at least 38° C. and the contacting comprises blanching the food product.

12. The method of claim 9, comprising blanching the food product, and wherein the contacting is performed prior to the blanching.

13. The method of claim 9, comprising blanching the food product, and wherein the contacting is performed after the blanching.

14. The method of claim 6, wherein:
the food product comprises a peeled vegetable;
the vegetable comprises starch and the method comprises a treatment stage to remove starch from the vegetable; and
the contacting is during the treatment stage.

15. The method of claim 6, wherein:
the food product comprises a peeled vegetable;
the vegetable comprises starch and the method comprises a treatment stage to remove starch from the vegetable; and
the contacting is prior to the treatment stage.

16. The method of claim 6, wherein:
the food product comprises a peeled vegetable;
the vegetable comprises starch and the method comprises a treatment stage to remove starch from the vegetable; and
the contacting is after the treatment stage.

17. The method of claim 6, wherein the food product comprises potato.

18. The method of claim 1, wherein the food processing substrate comprises a food contact surface comprising food soil.

19. The method of claim 18, wherein the food contact surface comprises a surface of food processing or preparation equipment.

20. The method of claim 18, wherein the contacting comprises clean-in-place treatment of the food contact surface.

21. The method of claim 18, wherein immediately prior to the contacting the nonequilibrium treatment composition has a pH of at least pH 9.0.

22. The method of claim 18, wherein immediately prior to the contacting the nonequilibrium treatment composition has a pH in a range from pH 2.0 to pH 9.0.

23. The method of claim 18, wherein immediately prior to the contacting the nonequilibrium treatment composition is at a temperature in a range of from 38° C. to 95° C.

24. The method of claim 1, wherein the food processing substrate comprises a food process liquid to be treated, the food process liquid comprising food soil contaminants.

25. The method of claim 24, wherein the food process liquid comprises drainage of used nonequilibrium treatment composition from the processing of claim 20.

26. The method of claim 24, wherein the food process liquid comprises effluent liquid from contacting a food product during food processing, effluent liquid from cleaning and/or sanitization of food preparation or processing equipment or food preparation utensils, or combinations thereof.

27. The method of claim 24, wherein the contacting is at a treatment temperature in a range of from 38° C. to 95° C.

28. The method of claim 24, wherein immediately prior to the contacting the processing liquid has a pH in a range of from pH 2.0 to pH 10.0.

29. The method of claim 24, comprising after the contacting subjecting the processing liquid to liquid-solid separation to remove solids from the processing liquid.

30. The method claim 1, wherein the composition properties comprise a concentration of dissolved hydrogen peroxide of no larger than 1600 mg/L.

31. The method of claim 2, wherein the contacting comprises contacting the food processing substrate with the nonequilibrium treatment composition for a treatment time of from 1 minute to 120 minutes.

32. The method of claim 18, wherein the nonequilibrium treatment composition comprises the nonequilibrium peracid salt composition without an additive to adjust composition properties prior to the contacting.

33. The method of claim 18, wherein immediately prior to the contacting, the nonequilibrium treatment composition has the composition properties of the nonequilibrium peracid salt composition.

34. The method of claim 1, wherein immediately prior to the contacting the nonequilibrium treatment composition has a combined concentration of peracid anion and peracid, determined as equivalent concentration of the peracid, in a range of from 1 part per million to 8000 parts per million, on a weight basis.

35. The method of claim 1, wherein immediately prior to the contacting the nonequilibrium treatment composition has a combined concentration of peracid anion and peracid, determined as equivalent concentration of the peracid, in a range of from 1 part per million to 2600 parts per million, on a weight basis.

36. The method of claim 1, wherein the nonequilibrium treatment composition comprises the nonequilibrium adjusted composition and the method comprises preparing the nonequilibrium adjusted composition.

37. The method of claim 36, wherein the preparing the nonequilibrium adjusted composition comprises:
diluting the nonequilibrium peracid salt composition.

38. The method of claim 36, comprising contacting the substrate with the nonequilibrium adjusted composition within 120 minutes after preparation of the nonequilibrium peracid salt composition.

39. The method of claim 36, comprising contacting the substrate with the nonequilibrium adjusted composition at least 10 minutes after preparation of the nonequilibrium peracid salt composition.

40. The method of claim 36, wherein the preparing the nonequilibrium adjusted composition comprises acidifying the nonequilibrium peracid salt composition, the acidifying comprising:
adding an acidulant to reduce the pH of the nonequilibrium peracid salt composition prior to the contacting, and optionally to prepare the nonequilibrium composition as an acidified nonequilibrium peracid composition.

41. The method of claim 40, wherein the acidulant comprises an inorganic acid.

42. The method of claim 40, wherein the acidifying comprises reducing the pH of the nonequilibrium peracid salt composition to prepare the nonequilibrium adjusted composition at a pH of not larger than pH 9.0.

43. The method of claim 1, wherein the nonequilibrium peracid salt composition is a nonequilibrium peracetic acid salt composition and the peracid anion is peracetate.

44. The method of claim 1, comprising, prior to the contacting, performing the preparation method to prepare the nonequilibrium peracid salt composition with the composition properties.
